(19) United States
(12) Patent Application Publication
(10) Pub. No.: US 2009/0257751 A1
(43) Pub. Date: Oct. 15, 2009

(54) Aggregating Optical Network Device

(76) Inventors: Santosh Kumar Sadananda, San Jose, CA (US); Christopher M. Look, Pleasanton, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/921,588

(22) PCT Filed: Jun. 6, 2006
(86) PCT No.: PCT/US06/21990

§ 371 Date: Apr. 24, 2009

Related U.S. Application Data
(60) Provisional application No. 60/688,203, filed on Jun. 6, 2005.

(51) Int. Cl. H04J 14/02

(52) U.S. Cl. 398/83

(57) ABSTRACT

A method and apparatus for an electrically switched optically protecting network device is described. One embodiment of the invention established pairs of optical circuits between different electrically switched optically protecting network devices acting as access nodes of an optically switched network. The network device communicates different add/drop traffic flows between externally facing ports of different electrically switched optically protecting network devices by transmitting over the optical circuit. In addition, the network device optically switches optical circuits for which the network device is an intermediate node and electrically switches packets between different ones of the network devices' externally facing ports and those of the optical circuits for which the network device is an end node. Furthermore, the network device protects the communication of traffic flows across the optical network by controlling the packet electrical switching to the pairs of optical circuits.

### CROSS-REFERENCE TO RELATED APPLICATIONS

This application claims the benefit of U.S. Provisional Application No. 60/688,203 filed Jun. 6, 2005, which is hereby incorporated by reference.

### BACKGROUND

1. Field

Embodiments of the invention relate to the field of networking; and more specifically, to optical networks.

2. Background

Optically Switched Networks

An optically switched network is a collection of optically switched network devices interconnected by optical links made up of optical fiber cables. The optically switched network devices that allow traffic to enter and/or exit the optically switched network are referred to as access nodes; in contrast, any optically switched network devices that do not are referred to as pass-thru nodes (an optically switched network need not have any pass-thru nodes). Thus, the pass-thru nodes typically optically switch traffic carried on the optical network. An optical node refers to either an access or pass-thru node. Each optical link interconnects two optically switched network devices and typically includes an optical fiber to carry traffic in both directions. There may be multiple optical links between two optically switched network devices.

A given fiber can carry multiple communication channels simultaneously through a technique called wavelength division multiplexing (WDM), which is a form of frequency division multiplexing (FDM). When implementing WDM, each of multiple carrier wavelengths (or, equivalently, frequencies or colors) is used to provide a communication channel. Thus, a single fiber looks like multiple virtual fibers, with each virtual fiber carrying a different data stream. Each of these data streams may be a single data stream, or may be a time division multiplex (TDM) data stream. Each of the wavelengths used for these channels is often referred to as a lambda.

A lightpath is a one-way path in an optically switched network for which the lambda does not change. For a given lightpath, the optical nodes at which its path begins and ends are respectively called the source node and the destination node; the nodes (if any) on the lightpath in-between the source and destination nodes are called intermediate nodes. An optical circuit is a bi-directional, end-to-end (between the access nodes providing the ingress to and egress from the optically switched network for the traffic carried by that optical circuit) path through the optically switched network. Each of the two directions of an optical circuit is made up of one or more lightpaths. Specifically, when a given direction of the end-to-end path of an optical circuit will use a single wavelength, then a single end-to-end lightpath is provisioned for that direction (the source and destination nodes of that lightpath are access nodes of the optically switched network and are the same as the end nodes of the optical circuit). However, in the case where a single wavelength for a given direction will not be used, wavelength conversion is necessary and two or more concatenated lightpaths are provisioned for that direction of the end-to-end path of the optical circuit. Thus, a lightpath comprises a lambda and a path (the series of optical nodes (and, of course, the interconnecting links) through which traffic is carried with that lambda).

Put another way, when using Generalized Multiprotocol Label Switching (GMPLS) [RFC3471] on an optically switched network, the optically switched network can be thought of as circuit switched, where LSPs are the circuits. Each of these LSPs (unidirectional or bi-directional) forms an end-to-end path where the generalized label(s) are the wavelength(s) of the lightpath(s) used. When wavelength conversion is not used for a given bi-directional LSP, there will be a single end-to-end lightpath in each direction (and thus, a single wavelength; and thus, a single generalized label).

The term disjoint path is used to describe a relationship between a given path and certain other network resources (e.g., nodes, links, etc.). There are various levels of disjointness (e.g., maximally link disjoint, fully link disjoint, maximally node disjoint, and fully node disjoint; and each can additionally be shared risk group (SRG) disjoint). For instance, a first and second path are disjoint if the network resources they use meet the required level of disjointness.

Disjoint paths are formed for a variety of reasons, including to form restricted paths and protection paths. Restricted paths are formed to carry traffic that is not to travel through certain network resources for security reasons. Protection paths are used to provide redundancy; that is, they are used as alternate paths to working paths in case of a network failure of some kind. Protection paths are commonly implemented as either: 1) 1+1 protected; 2) 1:1 protected; or 3) 1:N mesh restored. A 1+1 or 1:1 protected path is a disjoint path from node A to node B in the network where one of the paths is a working path, and the other is a protection path. The working path and the protection path are typically established at the same time. In the case of a 1+1 protected path, the same traffic is carried on both paths, and the receiving node selects the best of the paths (i.e., if the one currently selected by the receiving node degrades or fails, that node will switch to the other). In contrast, in the case of a 1:1 protected path, traffic is transmitted on the working path; when a failure occurs on the working path, traffic is switched to the protection path. A mesh restored path from node A to node B is a pair of shared resource group disjoint paths in the network, where one of the routes is a working path and the other is a backup path. The capacity dedicated on the backup path can be shared with backup paths of other mesh-restored paths.

Connecting Optically and Electrically Switched Networks

As mentioned above, an access node allows traffic to enter and/or exit the optically switched network. When traffic is entering the optically switched network from an electrically switched network, the electrical network traffic must be placed onto a lightpath. The conversion of electrical signal to a light signal is carried out by the access node or any other device interfacing with the access node. An electrically switched network switches packets in the electrical domain typically using traditional packet routers and switches. A typical electrical switching device is represented as a “L2/L3 device” meaning the device switches packets in the electrical domain based on the electrical domain protocol encapsulations as illustrated in FIG. 2. Conversely, as mentioned above, an optically switched network switches light based on the wavelength transporting the packets.

FIG. 1 (Prior Art) is a block diagram illustrating one embodiment of optically and electrically switched networks. In FIG. 1, network 100 comprises of electrically switched network 102 and optically switched network 110. L2/L3 devices 104-108 comprise electrically switched network 102. Four DWDM transports comprise the optically switched network 110: DWDM transport 112 connected to L2/L3 Device 104, DWDM transport 118 connected to L2/L3 device 106, DWDM transport 114 connected to a L2/L3 Device (not shown in FIG. 1), and DWDM transport 114. In FIG. 1, each DWDM transport is interconnected to the other DWDM transports in a ring fashion, i.e. DWDM transport 112 is connected to DWDM transport 114, DWDM transport 114 in turn is further connected to DWDM transport 118, DWDM transport 118 in turn is further connected to DWDM transport 116, and, finally, DWDM transport 116 connects back to DWDM transport 112.

Furthermore, in FIG. 1, the optically switched network is not viewed as distinct optical hops by L2/L3 devices 104-108 in the electrically switched network. The L2/L3 devices 104 and 106 view the electrically switched connection between the two devices as a simple point-to-point connection because the optically switched network 110 operates at a lower layer of the protocol stack. The difference between the packet protocol layers used for electrical and optical switching in further described in FIG. 2 below. Returning to FIG. 1, as an example, L2/L3 device 104 views the connection to L2/L3 device 106 as a single hop. L2/L3 devices 104 and 106 contain no knowledge of the inner architecture of optically switched network 110.

FIG. 2 (Prior Art) is a block diagram illustrating exemplary data packet encapsulation in the optically switched domain with DWDM encapsulation and in the electrically switched domain using a variety of protocols. Line 218 illustrates the protocol layer boundary between optically and electrically switched network protocols. Electrically switching network elements typically switch packets based on the information contained in the protocol encapsulation layers. For example, electrically switched packets use a variety of encapsulations such as, but not limited to Internet Protocol (IP) 216, Ethernet 210, Virtual Local Area Network (VLAN) 212, Multi-Protocol Label Switch (MPLS) 214, Asynchronous Transfer Mode (ATM) 208, General Framing Procedure (GFP) 206 and Synchronous Optical Networking (SONET) 204. A L2/L3 device that supports the encapsulation forwards the packets. In contrast, optically switching network elements switch packets based on the wavelength carrying the packet.

In FIG. 2, the electrically switched packets (and associated protocol layers) are encapsulated for optical switching with DWDM 200 (and optionally Optical Transport Network (OTN) 202). For example, DWDM 200 may encapsulate ATM 208 cells directly or through SONET 204 and OTN 202 encapsulations. All other non-ATM encapsulations may be encapsulated through OTN 202, SONET 204 and GFP 206. For example, Ethernet 210 packets are encapsulated through ATM 208 or GFP 206. In addition, Ethernet 210 encapsulates VLAN 212, MPLS 214, and IP 216 packets. Furthermore, ATM 208 or GFP 206 can directly encapsulate IP 216 packets without an intermediate Ethernet 210 encapsulation.

Currently, traffic is converted between electrically and optically switched networks by two schemes: (i) mapping electrical network ports to wavelengths and (ii) mapping SONET channels to wavelengths. FIG. 3A (Prior Art) is a block diagram of an access node 300 that maps electrical network ports to optical wavelengths. In FIG. 3A, packets from L2/L3 devices 302A-C enter on electrical network ports 304A-C, respectively. Transponder 306A converts the packets entering on port 304A from a non-International Telecommunications Union (ITU) wavelength to ITU wavelength λ₁. Similarly, transponder 306B converts the packets from port 304B using a non-ITU wavelength to ITU wavelength λ₂. In addition, L2/L3 device 302C transmits packets to access node 300 on an ITU wavelength λ₃ (sometimes referred to as an alien wavelength). Multiplexer/demultiplexer logic 308 multiplexes the three rrU wavelengths λ₁, λ₂ and λ₃ onto a single fiber carrying the three wavelengths. Conversely, multiplexer/demultiplexer logic 308 demultiplexes wavelengths λ₁, λ₂ and λ₃ entering the access node 300 and forwards the packets on these to the appropriate ports.

Typically, access node 300 is deployed with one or more separate Quality of Service (QoS) type devices (such as an L2/L3 device that supports QoS) in front of it as illustrated in FIG. 3B. FIG. 3B (Prior Art) is a block diagram of multiple L2/L3 devices 320A-B and an access node 332 that maps electrical network ports to optical wavelengths. Access node 332 is the similar to access node 300 described in FIG. 3A. L2/L3 device 320A maps traffic flows 322A comprising packet classifications PC₁, PC₂ and PC₃ into traffic flows 324A-B that enters ports 326A-B respectively, of access node 332. Similarly, L2/L3 device 320B maps traffic flows 322B comprising packet classifications PC₄, PC₅ and PC₆ into traffic flow 324C entering on port 326C of access node 332. Thus, L2/L3 devices 320A-B are aggregating and/or separating received traffic flows to access node 332.

As in FIG. 3A, access node maps in a 1:1 fashion between ports 326A-C and wavelengths. Transponders 328A-C convert the packets entering on port 326A-C, from a non-ITU wavelength to ITU wavelength λ₁, λ₂, and λ₃, respectively. Multiplexer/demultiplexer logic 330 multiplexes the wavelengths λ₁, λ₂ and λ₃ onto a single fiber carrying the three wavelengths. Conversely, multiplexer/demultiplexer logic 330 demultiplexes wavelengths λ₁, λ₂, and λ₃ entering the access node 332 and forwards the packets on these to the appropriate electrical network ports 326A-B.

The 1:1 mapping between electrical network ports and wavelengths limits access nodes 300/332 in several ways: (1) traffic entering access nodes 300/332 on a given port cannot but be put on a wavelength other than the one mapped to that port (e.g. traffic entering port 304A cannot be transmitted on a lightpath using 2); (2) access nodes 300/332 cannot classify traffic into separate traffic flows according to the characteristics of access nodes 300/332 cannot classify the data packets carrying the traffic; (3) access nodes 300/332 cannot electrically switch packets to protected optical circuits; (4) access nodes 300/332 cannot associate a traffic flow with a particular optical service level; (5) access nodes 300/332 cannot aggregate traffic flows from multiple L2/L3 devices to the same wavelength, or separate multiple traffic flows from one wavelength to multiple L2/L3 devices; (6) access nodes 300/332 do not represent any visibility of the optically switched network to the electrically switched network; and (7) increasing the number of wavelengths used requires a corresponding increase in the number of access node 300/332 and L2/L3 device ports.

Another scheme used to map electrically switched and optically switched traffic is a 1:1 mapping between SONET channels and optical wavelengths. In FIG. 3C, SONET connection 352 connects to the SONET interface 356 of access node 350. By way of example, FIG. 3C shows the two SONET channels 354 with frequencies f1 and f2 are split to STS VT/XT units 358 and 360. Each STS VT/XT unit transforms the input frequencies into modified frequencies f1′ and f2′ for ITU wavelengths, λ₁ and λ₂. Multiplexer/demultiplexer logic 362 multiplexes the two ITU wavelengths λ₁ and λ₂ onto a single fiber carrying the two wavelengths. Conversely, multiplexer/demultiplexer logic 362 demultiplexes traffic entering the access node 350 on wavelengths λ₁ and λ₂ into packets headed for the appropriate SONET channels.

Although access node 350 does not have a strict 1:1 mapping between electrical network ports and wavelengths like access nodes 300 and 332, access node 350 still suffers from problems (1)-(7) above.

### BRIEF SUMMARY

A method and apparatus for an electrically switched optically protecting network device is described. One embodiment of the invention establishes pairs of optical circuits between different electrically switched optically protecting network devices acting as access nodes of an optically switched network. The network device communicates different add/drop traffic flows between externally facing ports of different electrically switched optically protecting network devices by transmitting over the optical circuit. In addition, the network device optically switches optical circuits for which the network device is an intermediate node and electrically switches packets between different ones of the network devices' externally facing ports and those of the optical circuits for which the network device is an end node. Furthermore, the network device protects the communication of traffic flows across the optical network by controlling the packet electrical switching to the pairs of optical circuits.

### BRIEF DESCRIPTION OF THE DRAWINGS

The invention may best be understood by referring to the following description and accompanying drawings that are used to illustrate embodiments of the invention. The numbering scheme for the Figures included herein are such that the leading number for a given element in a Figure is associated with the number of the Figure. For example, access node 300 can be located in FIG. 3A. However, element numbers are the same for those elements that are the same across different Figures. In the drawings:

FIG. 1 (Prior Art) is a block diagram illustrating one embodiment of optical and electrically switched networks.

FIG. 2 (Prior Art) is a block diagram illustrating exemplary data packet encapsulation in the optically switched domain with DWDM encapsulation and the electrically switched domain using a variety of protocols.

FIG. 3A (Prior Art) is a block diagram of an access node that maps electrical ports to optical wavelengths.

FIG. 3B (Prior Art) is a block diagram of an access node that maps SONET channels ports to optical wavelengths.

FIG. 3C (Prior Art) is a block diagram of a packet classifier and an access node that map data packets to optical wavelengths.

FIG. 4 illustrates exemplary optical and electrically switched networks using a DWDM transport and switching platform (DTSP) node according to one embodiment of the invention.

FIG. 5 illustrates an exemplary optically switched network within a surrounding electrically switched network using DTSP nodes according to one embodiment of the invention.

FIG. 6 illustrates an exemplary optically switched network that reveals networks hops to the surrounding electrically switched network using DTSP nodes according to one embodiment of the invention.

FIG. 7A illustrates an exemplary optically switched network that reveals optical endpoints to the surrounding electrically switched network using DTSP nodes according to one embodiment of the invention.

FIG. 7B illustrates an exemplary optically switched network that reveals the internal optically switched network to the surrounding electrically switched network using DTSP nodes according to one embodiment of the invention.

FIG. 8A is a block diagram of optical circuits using DTSP nodes according to one embodiment of the invention.

FIG. 8B is a block diagram of optical circuits including optical protection using DTSP nodes according to one embodiment of the invention.

FIG. 8C is a block diagram of optical circuits including optical service levels using DTSP nodes according to one embodiment of the invention.

FIG. 9A is a block diagram of a DTSP node illustrating packet classification and wavelength selection according to one embodiment of the invention.

FIG. 9B is a block diagram of a DTSP node illustrating wavelength sharing among multiple traffic flows according to one embodiment of the invention.

FIG. 9C is a block diagram of a DTSP node illustrating packet classification and wavelength selection with optical path protection according to one embodiment of the invention.

FIG. 10 is a block diagram of a DTSP node illustrating rate-limiting packet service levels according to one embodiment of the invention.

FIG. 11A is a block diagram illustrating optical circuit selection for traffic flows according to one embodiment of the invention.

FIG. 11B is a block diagram illustrating optical circuit selection for traffic flows that includes traffic flow optical circuit sharing according to one embodiment of the invention.

FIG. 11C is a block diagram illustrating optical circuit selection for traffic flows that includes traffic flow optical circuit sharing and traffic flow optical protection according to one embodiment of the invention.

FIG. 11D is a block diagram illustrating optical circuit selection for traffic flows including multiple optical circuits for similar traffic flows according to one embodiment of the invention.

FIG. 12A is a block diagram illustrating connections sharing calls and optical circuits according to one embodiment of the invention.

FIG. 12B is a block diagram illustrating call optical protection according to one embodiment of the invention.

FIG. 13 is a block diagram illustrating the marks added to the data packets as the data packets traverse a node according to one embodiment of the invention.

FIGS. 14A-H are block diagrams illustrating call and connection protection performed by the NPU according to one embodiment of the invention.

FIGS. 15A-B are exemplary tables of configuration data used to configure DTSP according to one embodiment of the invention.

FIG. 16 is an exemplary flow diagram for provisioning traffic flows according to one embodiment of the invention.

FIG. 17 is an exemplary flow diagram for de-provisioning traffic flows according to one embodiment of the invention.

FIG. 18 is an exemplary flow diagram for processing data packets into traffic flows and switching the traffic flows to optical circuits according to one embodiment of the invention.

FIG. 19 is an exemplary flow diagram for internally marking data packets for traffic flows according to one embodiment of the invention.

FIG. 20 is an exemplary flow diagram for marking data packets for working and/or protected optical circuits for the call associated with the data packet according to one embodiment of the invention.

FIG. 21 is a block diagram illustrating a system architecture of the DTSP according to one embodiment of the invention.

FIG. 22 is a block diagram illustrating the control plane architecture of the client interface module according to one embodiment of the invention.

FIG. 23 is a block diagram illustrating the architecture of the ESM and NPU(s) according to one embodiment of the invention.

FIGS. 24A-D are block diagrams illustrating ingress path CIM protection schemes according to one embodiment of the invention.

FIGS. 25A-C are block diagrams illustrating ingress path CIM protection schemes according to one embodiment of the invention.

FIGS. 26A-C are block diagrams illustrating egress path CIM protection schemes according to one embodiment of the invention.

FIGS. 27A-B are block diagrams illustrating CIM 1+1 and DTM 1+1 protection schemes according to one embodiment of the invention.

FIGS. 28A-D are block diagrams illustrating CIM 1:1 and DTM 1+1 protection schemes according to one embodiment of the invention.

FIGS. 29A-D are block diagrams illustrating egress path DTM protection schemes according to one embodiment of the invention

### DETAILED DESCRIPTION

In the following description, numerous specific details are set forth (e.g., such as logic resource partitioning/sharing/duplication implementations, types and interrelationships of system components, and logic partitioning/integration choices). However, it is understood that embodiments of the invention may be practiced without these specific details. In other instances, well-known circuits, software instruction sequences, structures and techniques have not been shown in detail in order not to obscure the understanding of this description.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct contact with each other (e.g., physically, electrically, optically, etc.). “Coupled” may mean that two or more elements are in direct contact (physically, electrically, optically, etc.). However, “coupled” may also mean that two or more elements are not in direct contact with each other, but yet still co-operate or interact with each other.

### Overview

According to embodiments of the invention, a group of network devices act as access nodes between an optically switched VDM network and an electrically switched network. The access nodes integrate electrical and optical switching functions by electrically switching packets to/from those optical circuits for which the node is an end node, and by optically switching those optical circuits for which the node acts as an optical circuit intermediate node. According to another aspect of the invention, an access node provides electrically switched optical protection by controlling the electrical switching of the packets to/from optical circuits pairs to protect the communication of the traffic flows. According to another aspect of the invention, an access node electrically switches to aggregate multiple traffic flows onto a single wavelength. Conversely, the access node electrically switches to separate aggregated traffic flows carried on the single wavelength. According to another aspect of the invention, optical circuits terminated by the access nodes are represented in the forwarding databases of electrically switched devices as single hops between access node endpoints of the optical networks.

Since each of the above aspects is independent, different embodiments may implement different ones, different combinations, or all of the above aspects of the invention. For example, certain embodiments of the invention include an access node that integrates electrical and optical switching with electronically switched optical protection. In addition to the switch integration and optical protection, the access node further aggregates multiple traffic flows from multiple L2/L3 devices onto a variety of WDM wavelengths including aggregating multiple traffic flows onto a single WDM wavelength. Furthermore, the access node includes a mapping of optical circuits comprising the WDM network and the access nodes terminating the optical circuits. The access node represents this mapping to L2/L3 devices in the electrically switched network as a collection of single hops between the access nodes endpoints. The L2/L3 devices use this representation in there forwarding database to make decision on forwarding packets.

Of course, one or more parts of an embodiment of the invention may be implemented using any combination of software, firmware, and/or hardware. Such software and/or firmware can be stored and communicated (internally and with other access nodes over the network) using machine-readable media, such as magnetic disks; optical disks; random access memory; read only memory; flash memory devices; electrical, optical, acoustical or other form of propagated signals (e.g., carrier waves, infrared signals, digital signals, etc.); etc.

### Exemplary Network Node

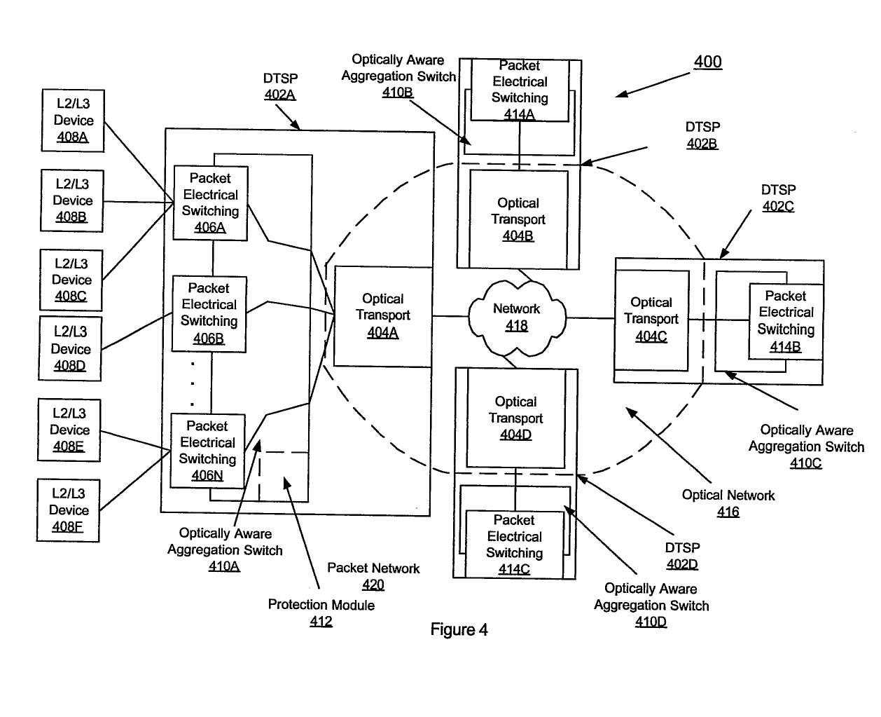

FIG. 4 illustrates exemplary optical and electrically switched networks using DTSP nodes according to one embodiment of the invention. In FIG. 4, optically switched network 416 comprises four DTSP 402A-D coupled to optical network 418. Optical network 418 represents the optically switched network 416 except for DTSP 402A-D. Outside of optically switched network 416 is the electrically switched network 420. As described above, optically switched network 416 carries traffic on wavelengths of light and switches the traffic based on wavelengths, while electrically switched network 420 switches the traffic based on the contents of the traffic data packets.

Each DTSP 402A-D acts an access node by bridging the optically switched 416 and electrically switched 420 networks. Each DTSP 402A-D comprises an optical transport part 404A-D that couples to optical network 418. Furthermore, each DTSP 402A-D comprises packet electrical switching part (414A-414C for DTSP 402B-D and 406A-N for DTSP 402A) and an optically aware aggregation switch 410A-D. The packet electrical switching part (414A-C for DTSP 402B-D and 406A-N for DTSP 402A) may electrically switch traffic between electrically switched network 420 and optically switched network 416. In addition, packet electrical switching part (414A-C for DTSP 402B-D and 406A-N for DTSP 402A) electrically switches traffic in-between L2/L3 devices 408A-F in electrically switched network 420 without traffic being part of the optical domain. Optically aware aggregation switch 410A-D aggregates traffic into traffic flows from the electrically switched network 420 onto wavelengths transmitted by optical transport 404A-D. Conversely, optically aware aggregation switch separates aggregated traffic flows carried on the wavelengths from the optically switched network 416 to the electrically switched network 420. Each optically aware aggregation switch can support one or more packet electrical switches (414A-414C for DTSP 402B-D and 406A-N for DTSP 402A). In an exemplary embodiment, each optically aware aggregation switch 410A-D supports up to eight packet electrical switches (414A-C for DTSP 402B-D and 406A-N for DTSP 402A). In addition, each packet electrical switch 406A-N switch may couple to multiple L2/L3 devices 408A-F. Furthermore, each optically aware aggregation switch 410A-D includes a protection unit 412 that controls electrically switched optical platform for traffic flows using one or more of the traffic protection schemes outlined above. For example, protection unit could provide protection for a traffic flow such as, but not limited to, 1+1, 1:1, 1:N, etc.

Optical transport parts 404A-D participate in provisioning of optical circuits in the optical network 418. Provisioning the optical network 418 may be implemented differently in different embodiments. By way of example, and not limitation, it may be completed as described in (Ser. No. 10/455,933, filed Jun. 6, 2003; Ser. No. 10/626,055, filed Jul. 23, 2003; Ser. No. 10/626,363, filed Jul. 23, 2003; and Ser. No. 10/862,142, filed Jun. 3, 2004).

FIG. 4 illustrates the integration of electrical switching capability (e.g., 414A-C for DTSP 402B-D and 406A-N for DTSP 402A) with optically switching capability. (e.g., optical transport port 404A-D) in an access node. This is unlike the prior art where access node 300/322/350 does not have any electrical switch capability and relies on an external device (e.g. L2/L3 devices 302A-C) for this capability. Furthermore, integration of electrical and optical switch capabilities into a single device allows numerous other capabilities such as aggregation/separation of multiple traffic flows onto/from a single DWDM wavelength; electrically switch optical protection of traffic flows; visibility of access nodes in an electrically switched network; mapping traffic flow to different optical service levels; conserving DWDM wavelengths; and directing distinct traffic flows from the same packet port to different DWDM wavelength. Such capabilities are illustrated in the figures below.

### Exemplary Network Visibility

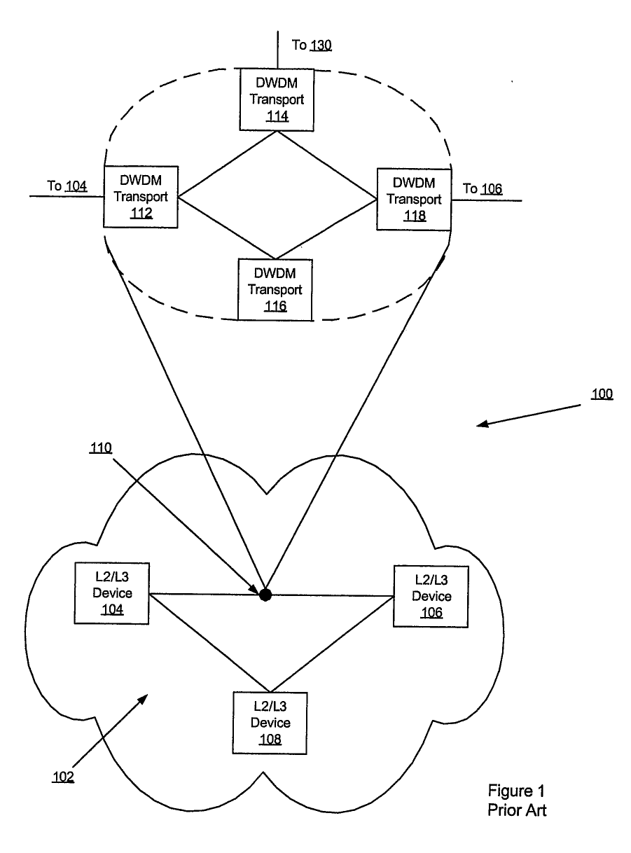

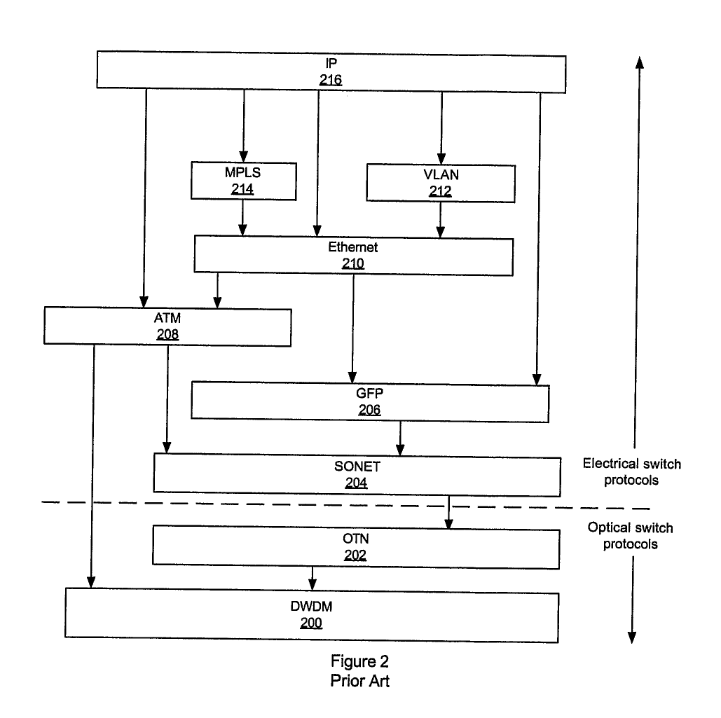

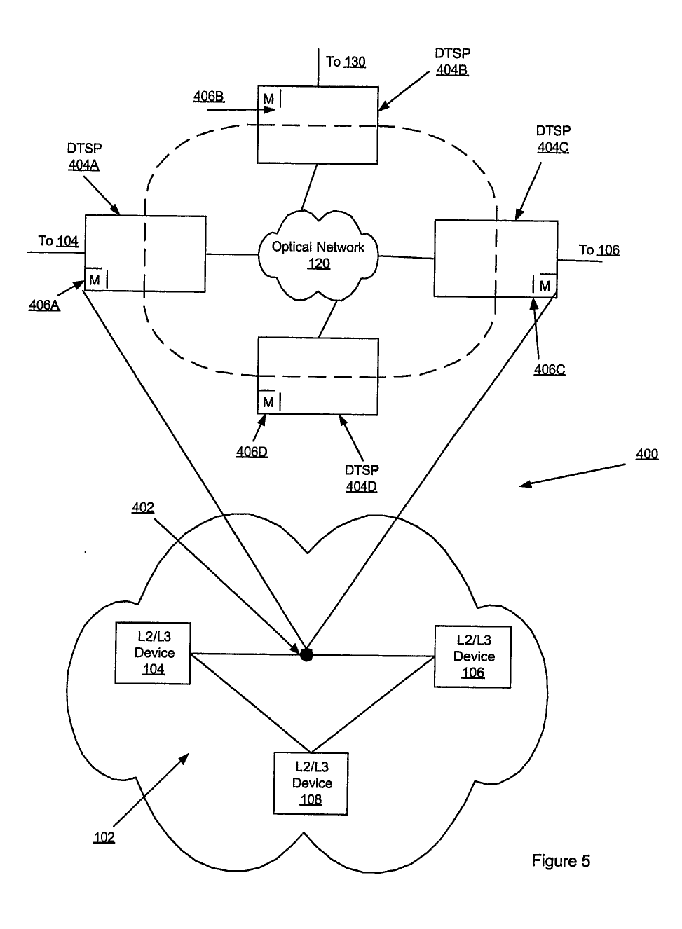

FIGS. 5-7B are block diagrams of different exemplary network visibility. FIG. 5 illustrates an exemplary optically switched network within a surrounding electrically switched network using DTSPs according to one embodiment of the invention. In FIG. 5, network 400 comprises electrically switched network 102 and optically switched network 402. L2/L3 devices 104-108 comprise the electrically switched network 102. Four DTSP 404A-D comprise optically switched network 402: DTSP 404A connects to L2/L3 device 104, DTSP 404C connects to L2/L3 device 130 (not shown in FIG. 1), DTSP 404C connects to L2/L3 device 106 and DTSP 404D. Unlike FIG. 1 where DWDM transports 112-118 are interconnected in a ring fashion, DTSP 404A-D connect with optically switched network 120 in a general fashion. That is, DTSP 404A-D can be, but not limited to, connection in a ring, a mesh, etc.

As in FIG. 1, the optically switched network 402 is not viewed as distinct network hops by L2/L3 devices 104-108 in the electrical switched network 102. L2/L3 devices 104 and 106 view the electrically switched connection between the two devices over the optically switched network 402 as a simple point-to-point connection because the optically switched network 402 operates at a lower layer of the protocol stack. However, unlike FIG. 1, DTSP 404A-D each contain a connection map 406A-D between each boundary DTSP 404A-D in optically switched network 402 and the L2/L3 device connected to the boundary DTSPs 404A-D. DTSP 404A-D use map 406A-D to forward incoming traffic flows to appropriate optical circuits based on the destination L2/L3 devices of the traffic flows.

Different embodiments may generate map 406A-D in different ways; by way of example, several embodiments immediately follow. In one embodiment, an operator manually generates map 406A-D on each DTSP 404A-D by entering values for the other boundary DTSPs. For example, and by way of illustration, the operator manually enters in each DTSP 404A-D that DTSP 404A is connected with L2/L3 device 104, DTSP 404B is connected with L2/L3 device 130, DTSP 404C is connected with L2/L3 device 106. Because DTSP 404D is not connected to any L2/L3 device in this example, DTSP 404D is not an entry in the map. In one embodiment, map 406A-D is as illustrated in Table 1. Alternatively, map 406A-D contains addresses of DTSP 404A-C and L2/L3 devices (104, 106 and 130). In a further embodiment, map 406A-D contains address(es) of DTSP 404A-C and networks accessible by L2/L3 devices 104-106 and 130.

TABLE 1
DTSP-L2/L3 Connection Map

| DTSP | L2/L3 Device |
|---|---|
| 404A | 104 |
| 404B | 130 |
| 404C | 106 |

In another embodiment, the operator enters the addresses for L2/L3 device 104-108 and 130 connected to each boundary DTSP 404A-D and DTSP 404A-D automatically exchanges with other DTSP 404A-D the L2/L3 device (104-108 and 130) connection information. For example, and by way of illustration, the operator: enters at DTSP 404A that DTSP 404A is connected to L2/L3 device 104; enters at DTSP 404B that DTSP 404B is connected to L2/L3 device 130; and enters at DTSP 404C that DTSP 404C is connected to L2/L3 device 106. Typically, once the operator completes entering of the local connection information at each DTSP, DTSPs 404A-D automatically exchanges the connection information. Automatically exchanging the connection information creates the map 406A-D as illustrated in Table 1. This embodiment lessons the need for operator involvement as compared with the fully manual embodiment above.

In another embodiment, each DTSP 404A-D discovers the L2/L3 devices (104-108 and 130) connected to it and automatically exchanges the connection information with the other DTSPs in the optically switched network 402. For example and by way of illustration, DTSP 404A discovers that it is connected to L2/L3 device 104, DTSP 404B discovers that it is connected to L2/L3 device 130, and DTSP 404C discovers that it is connected to L2/L3 device 106. The DTSPs automatically exchange the connection information with other DTSPs. As above, exchanging of the connection information creates map 406A-D.

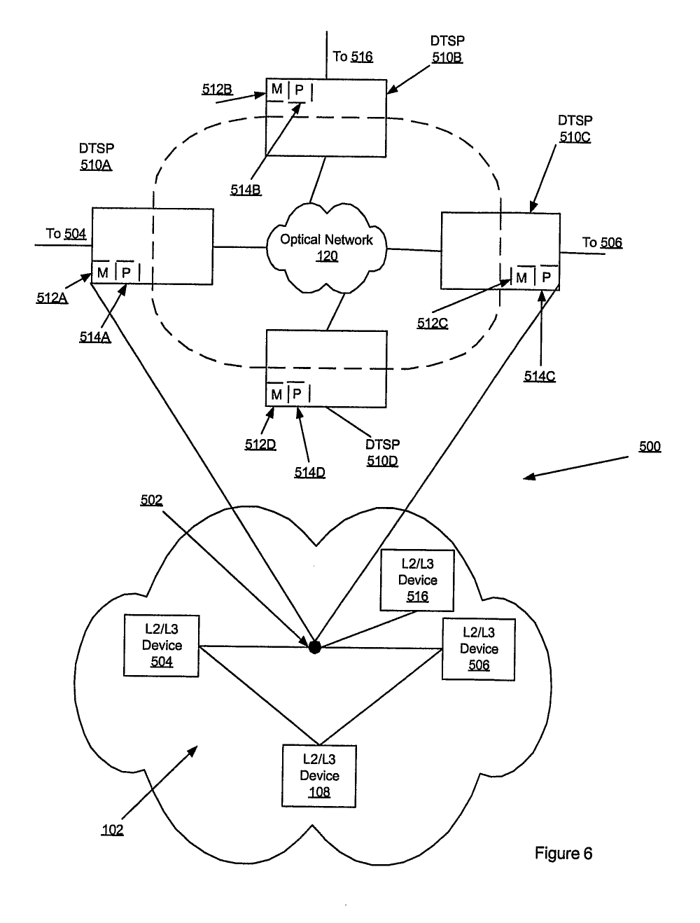

FIG. 6 illustrates an exemplary optically switched network that reveals networks hops to the surrounding electrically switched network using DTSP nodes according to one embodiment of the invention. FIG. 6 is similar to FIG. 5 in that in FIG. 6, network 500 comprises electrically switched network 102 and optically switched network 502. L2/L3 devices 108, 504, 506 and 516 comprise the electrically switched network 102. Four DTSP S10A-D comprise the optically switched network: DTSP 510A connects to L2/L3 device 504, DTSP 510BC connects to L2/L3 device 516, DTSP 510C connects to L2/L3 device 506 and DTSP 510D. Similar to FIG. 5, DTSP 510A-D are connected to optical network 120.

As in FIGS. 1 and 5, optically switched network 502 is not viewed as distinct network hops by L2/L3 devices (108, 504, 506, and 516) in the electrical switched network 102. However, unlike FIGS. 1 and 5, end node DTSP 510A-D exposes the electrically switched forwarding information contained by the DTSP (i.e. map 512A-D) to the L2/L3 devices locally connected to each DTSP. Typically, map 512A-D comprises the same information as in map 406A-D (e.g. Table 1), above. Furthermore, map 512A-D may be generated in the same fashion as map 406A-D. However, in one embodiment, DTSP 510A-D exposes part of map 512A-D using protocol 514A-D. In this embodiment protocol 514A-D exposes to L2/L3 devices (504, 506 and 510) coupled to optically switched network 502 switch which L2/L3 devices (504, 506 and 516) are accessible through the optically switched network 502. For example, protocol 514A-D exposes the L2/L3 device entries in map 512A-D to L2/L3 device (504, 506 and 510) that are coupled to optically switched network 502. In this embodiment, L2/L3 devices (504, 506, and 510) may be modified to work with protocol 514A-D, or protocol 514A-D may be a protocol known in the art and/or developed in the future that can expose availability of neighboring L2/L3 devices from an optically switched network.

Because DTSP 510A-D expose map 512A-D to the neighboring L2/L3 devices 504, 506 and 516, neighboring devices L2/3 504, 506 and 516 device may discover new routes to inaccessible L2/L3 devices and/or associated networks. For example and by way of illustration, in FIG. 6, there is no electrically switched path between L2/L3 device 504 and L2/L3 device 516. By DTSP 510A exposing map 512A to L2/L3 device 504 via a routing or signaling protocol, L2/L3 device 504 learns the path to L2/L3 device 516 over optical switched network 502. Because L2/L3 devices do not view optically switched network 502 as distinct network hops, L2/L3 device 504 represents the learned path to L2/L3 device 516 as a single electrically switched hop.

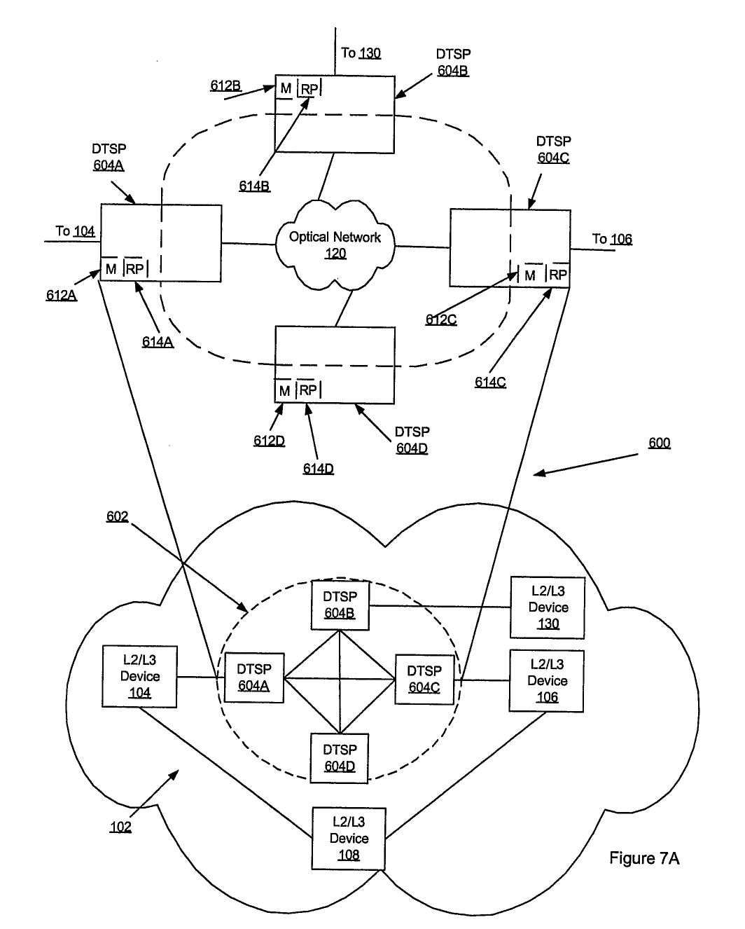

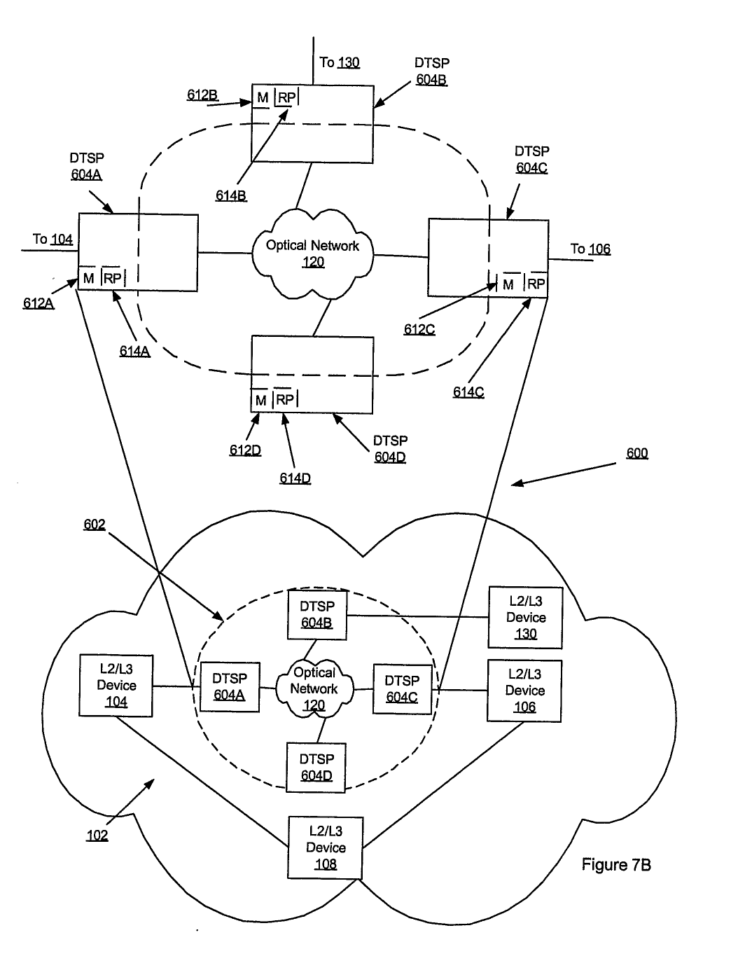

FIG. 7A illustrates an exemplary optically switched network that reveals optical endpoints to the surrounding electrically switched network using DTSPs according to one embodiment of the invention. FIG. 7A is similar to FIG. 6 in that in FIG. 7A, network 600 comprises electrically switched network 102 and optically switched network 602. Four DTSP 604A-D comprise the optically switched network: DTSP 604A connects to L2/L3 device 104, DTSP 604B connects to L2/L3 device 130, DTSP 604C connects to L2/L3 device 106 and DTSP 604D. Similar to FIG. 6, DTSP 604A-D are connected to optical network 120. In addition, electrically switched network 102 comprises L2/L3 devices 104, 106, 108, and 130.

Each DTSP 604A-D contains map 612A-D and routing protocol 614A-D. Map 612A-D comprises similar DTSP 604A-D and L2/L3 device (104-108 and 130) connection information as illustrated in FIG. 6. Routing protocol 614A-D may be a routing or signaling protocol known in the art and/or developed in the future. Examples of routing protocols that may be used are, but not limited to, Border Gateway Protocol (BGP), Open Shortest Path First (OSPF), etc. In an alternate embodiment, if map 512A-D contains signaling information, a signaling protocol is used to expose the signaling information to the neighboring L2/L3 devices 108, 504, 506, and 516. Examples of signaling protocols are, but not limited to, Resource Reservation Protocol (RSVP)+MPLS, Label Distribution Protocol (LDP)+MPLS, Constraint Route Label Distribution Protocol (LDP)+MPLS, etc. In addition, routing protocol 614A-D contains a connection table that represents single electrically switched hops between end nodes DTSP 604A-D. An exemplary embodiment of the routing protocol connections table (Table 2) lists: (1) DTSP 604A connected to DTSPs 604B-D; (2) DTSP 604B connected to DTSP 604C-D; and (3) DTSP 604C connected to DTSP 604D.

TABLE 2
Routing Protocol 614A-D Connection Table.

| DTSP | DTSP |
|---|---|
| 604A | 604B |
| 604A | 604C |
| 604A | 604D |
| 604B | 604C |
| 604B | 604D |
| 604C | 604D |

Each connection in this table represents one or more optical circuits between the DTSP pair. Thus, the routing protocol connection table represents an abstraction of optically switched network 602 to the electrically switched network 102.

Furthermore, DTSP 604A-D acts as a L2/L3 device in the electrically switched network 102. Routing protocol 614A-D exposes the packet electrical switch part of DTSP 604A-D to electrically switched network 102 via map 612A-D and routing protocol connection table 614A-D, so that each DTSP 604A-D appears as a node in electrically switched network 102. Thus, packet electrical switch part causes each DTSP 604A-D to act as an L2/L3 device in electrically switched network 102. Thus, FIG. 7A illustrate DTSP 604A-D exposing a representation of optically switched network 602 to electrically switched network 102. This is in contrast with the prior art where access node 300/322/350 docs export any visibility of optically switched network to electrically switched network.

However, optically switched network 602 is not exposed to network 102. Instead, DTSP 604A-D are represented in the electrically switched network 102 as connected in a single hop mesh, regardless of the optical circuits interconnecting each DTSP 604A-D (e.g., as represented in routing protocol connection table (Table 2)). For example and by way of illustration, in the electrically switched domain, DTSP 604A connects to DTSP 604B-D with one hop. Furthermore, DTSP 604B-D are similarly interconnected in electrically switched network 102. Thus, FIG. 7A represents DTSP 604A-D exposing a representation of optically switched network 602 to electrically switched network 102. This is in contrast with the prior art where access node 300/332/350 does not expose visibility of the optically switched network to an electrically switched network.

FIG. 7B illustrates an exemplary optically switched network that reveals the internal optically switched network to the surrounding electrically switched network using the DTSP node according to one embodiment of the invention. FIG. 7B is similar to FIG. 7A in that in FIG. 7B, network 600 comprises electrically switched network 102 and optically switched network 602. Four DTSP 604A-D comprise the optically switched network: DTSP 604A connects to L2/L3 device 104, DTSP 604B connects to L2/L3 device 130, DTSP 604C connects to L2/L3 device 106 and DTSP 604D. Similar to FIG. 7A, in FIG. 7B, DTSP 604A-D connect to optical network 120. Furthermore, each DTSP 704A-D contains map 712A-D and routing protocol 614A-D as in FIG. 7A.

In addition and similar to FIG. 7A, in FIG. 7B, each DTSP 604A-D acts as a L2/L3 device in the electrically switched network 102. In FIG. 7B, electrically switched network 102 comprises L2/L3 devices 104, 106, 108 and 130. Furthermore, electrically switched network 102 includes DTSP 604A-D, because the packet electrical switch part of DTSP 604A-D exposes DTSP 604A-D to the electrically switched network via map 612A-D and routing protocol 614A-D. However, unlike FIG. 7A, in FIG. 7B, the full complexity of optically switched network 120 is exposed to electrically switched network 102. Specifically, the full complexity of optically switched network 120 is exposed to L2/L3 devices 104, 106, 108 and 130 by DTSP 604A-D. In one embodiment, DTSP 604A-D exposes optically switched network 120 to electrically switched network 102 via GMPLS. Alternatively, any routing or signaling protocol that exposes optical circuits to electrically switched devices can be employed by DTSP 604A-D to expose optically switched network 120.

Thus, different embodiments may be implemented to operate in one or more different levels of network visibility (e.g., one or more of the exemplary network visibility levels from FIG. 5-7B; and/or others).

### Exemplary Applications

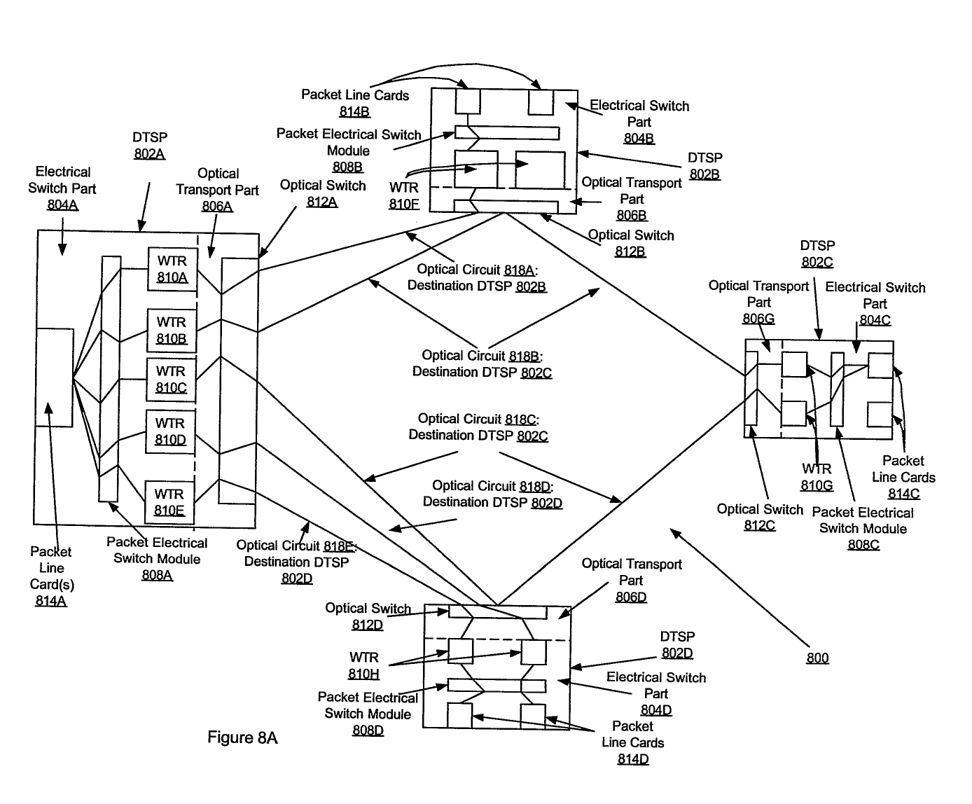

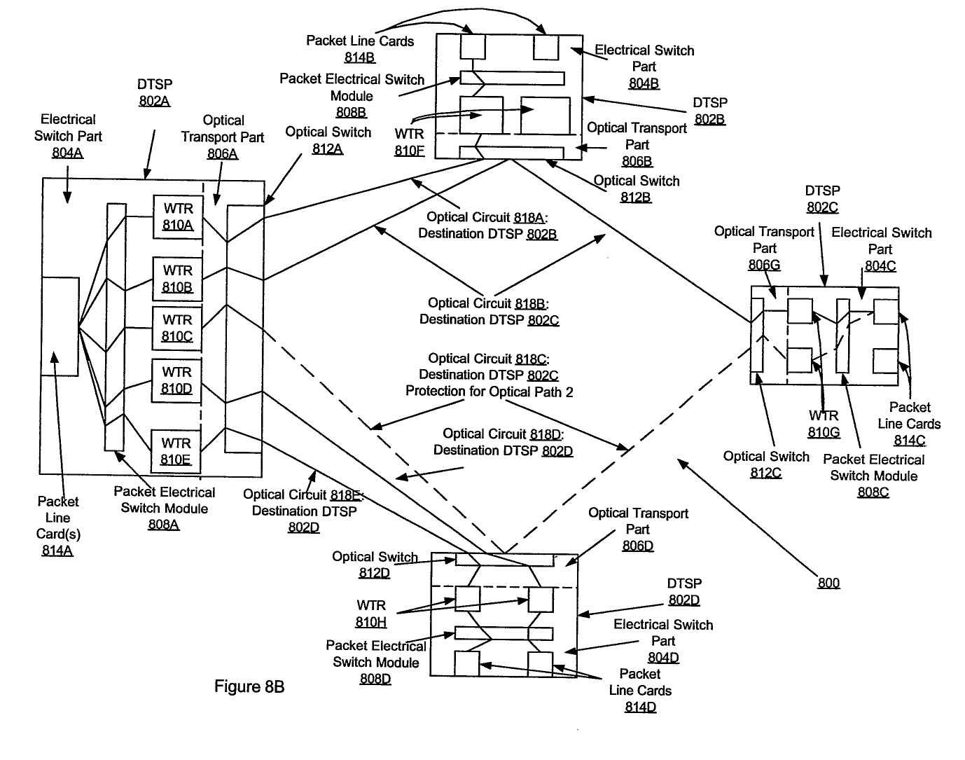

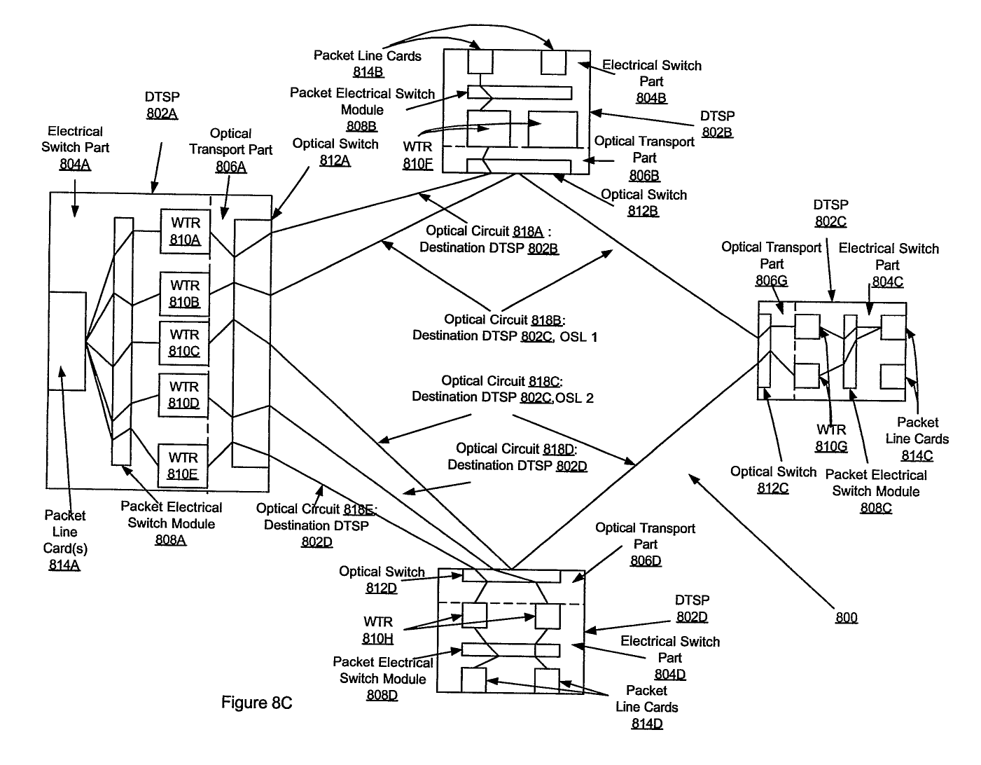

FIGS. 8A-C are block diagrams that use an exemplary architecture of a DTSP node to illustrate different exemplary applications according to one embodiment of the invention. In particular, FIG. 8A is a block diagram of optical circuits using DTSP nodes according to one embodiment of the invention. In FIG. 8A, network 800 comprises four DTSP 802A-D interconnected by five optical circuits 818A-E. The optical circuit interconnections are: optical circuit 818A interconnects DTSP 802A and DTSP 802B; optical circuit 818B interconnects DTSP 802A and DTSP 802C via DTSP 802B; optical circuit 818C interconnects DTSP 802A and DTSP 802C via DTSP 802D; and optical circuits 818D-E interconnects DTSP 802A and DTSP 802D. Thus, DTSP 802B and 802D optically switch optical circuits 818B and 818C, respectively. In addition, network 800 has multiple optical circuits having the same end nodes: optical circuits 818B-C having DTSP as end nodes 802A and 802C and optical circuits 818D-E having DTSP 802A and 802B as end nodes. Multiple optical circuits having the same end nodes allows for working optical circuits protection, optical service levels, and/or increased bandwidth.

DTSP 802A-D comprises an electrical switch part 804A-D and an optical transport part 806A-D. The electrical switch part 804A-D comprises three parts: packet line card(s) 814A-D, packet electrical switch module 808A-D and WDM transmit/receive modules (WTR) 810A-H. The packet line card(s) 814A-D transmit and receive packets with the electrically switched network (such as electrically switched network 102 in FIG. 5). Each DTSP 802A-D may have multiple packet line cards. In an exemplary embodiment, DTSP 802A-D have up to eight packet line cards 814A-D with each line card 814A-D having either four OC-48c packet over SONET (POS) ports, eight Gigabit Ethernet ports or one OC-192c POS port.

Packet electrical switch module 808A-D processes the received packets from packet line card(s) into traffic flows and electrically switches the traffic flows to the appropriate WTR 810A-H for transmission onto wavelengths in the optically switched network. Traffic flows are groups of packets with similar characteristics. Examples of packet characteristics are, but not limited to, IP source, IP destination, IP source port, IP destination port, MPLS tag, VLAN tag, MAC source address, MAC destination address, DSCP bit, ATM virtual circuit information (VCI)/virtual path information (VPI), etc. or combinations thereof. Conversely, the packet electrical switch module 808A-D processes the received packets from the WTR 810A-H into traffic flows and electrically switches the traffic flows to the appropriate packet line card(s) 814A-D for transmission to the electrically switched network.

WTR 810A-H receives traffic flows from packet electrical switch module 808A-D and adapts the packets in the traffic flow for transmission on a wavelength. In one embodiment, WTR 810A-H encapsulates each packet with a DWDM 200 protocol layer. Alternatively, WTR 810A-H encapsulates each packet with OTN 202 and DWDM 200 protocol layers. With a properly encapsulated packet, WTR 810A-H transmits each packet in a traffic flow on a corresponding DWDM wavelength. Furthermore, each WTR 810A-H can receive multiple traffic flows and transmit these traffic flows on different DWDM wavelengths.

Furthermore, WTR 810A-H receives packets on multiple DWDM wavelengths from the optically switched network. In addition, WTR 810A-H coverts the packets to be ready for electrical switching with packet electrical switch module 808A-D by decapsulating the DWDM protocol layer 200 or and possibly OTN 202 protocol layers from packets carried on the DWDM wavelength. WTR 810A-H forwards the deencapsulated packets to packet electrical switch module 808A-D.

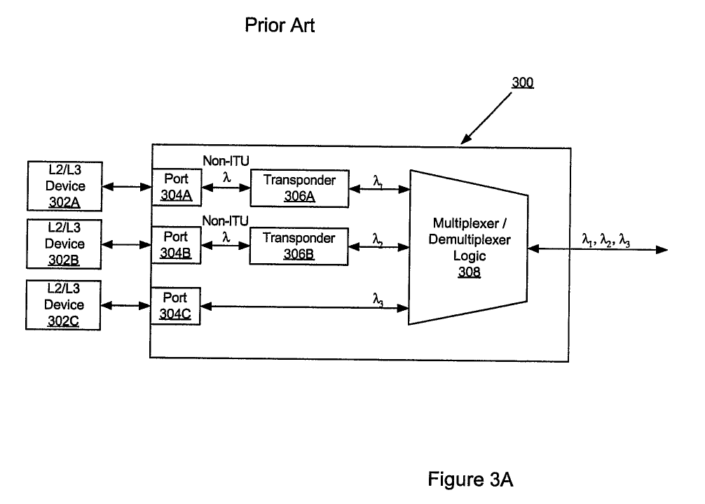

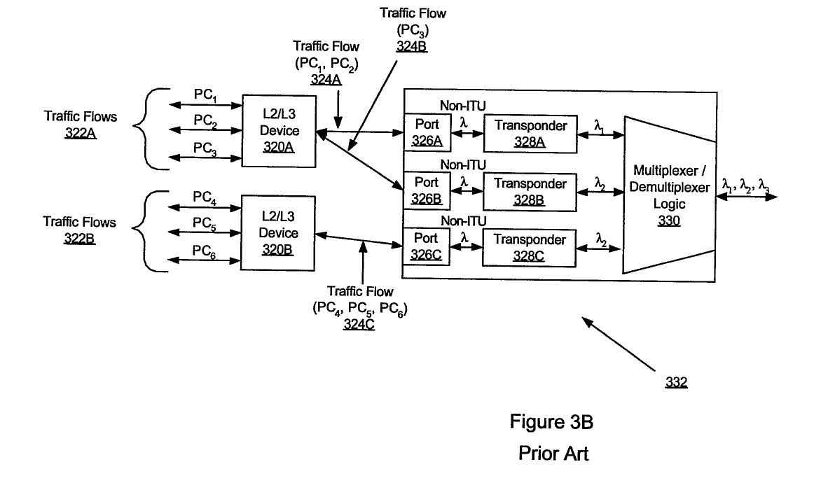

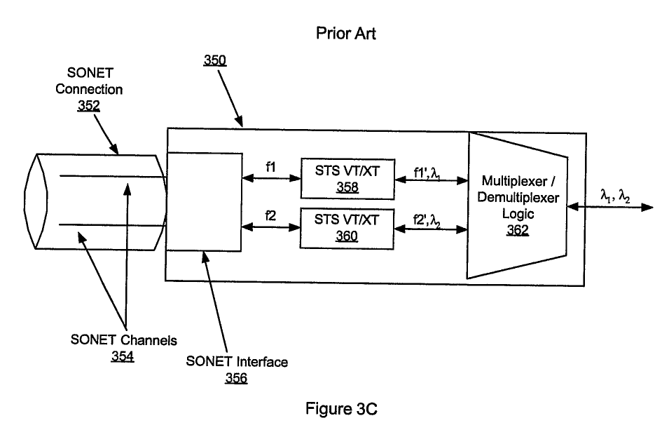

Referring back to FIG. 3A, each WTR 810A-H performs the function of transponder 306A-B access node 300.

Returning to FIG. 8A, each DTSP 802A-D may have multiple WTR 810A-H. In an exemplary embodiment, DTSP 802A-D has up to eight WTR 810A-H. The optical transport part 806A-D of each DTSP comprises optical switch 812A-D, as well as optical amplifiers and filters needed for optical communication. Optical switch 812 A-D optically switches wavelengths, multiplexes wavelengths to DWDM fibers, demultiplexes to individual wavelengths, optically switch to WTR 812 A-N, and switches from one DWDM to another. For example and by way of illustration, in FIG. 8A, optical switch 812A switches wavelengths from WTR 810A-E, respectively. In addition, optical switch 812A-D receives wavelengths from optical circuits 818A-E and either switches the wavelengths to WTR 810A-H or switches the optical circuits to the next DTSP 802A-D. Thus, optical switch 812A-D adds/drops optical circuits 818A-E to/from the optically switched network in which the corresponding DTSP 802A-D is an end node of the optical circuit 818A-E. Furthermore, optical switch 812A-D switches optical circuits 818A-E where the corresponding DTSP 802A-D is an intermediate node of optical circuit 818A-E.

FIG. 8B is a block diagram of optical circuits including optical protection using DTSP nodes according to one embodiment of the invention. FIG. 8B is similar to FIG. 8A in network 800 is comprised of DTSP 802A-D interconnected by optical circuits 818A-E in the same fashion as in FIG. 8A. Furthermore each DTSP 802A-D is comprised of an electrical switch part 804A-D and optical transport part 806A-D, where electrical switch part 804A-D comprises packet lines card(s) 814A-D, packet electrical switch module 808A-D, WTR 810A-H and optical transport part comprises optical switch 812A-D, as in FIG. 8A. In addition, each entity in FIG. 8B performs the same function as described in FIG. 8A. However, unlike FIG. 8A, in FIG. 8B, optical circuit 818C protects optical circuit 818B. In one embodiment, optical circuit 818C protects optical circuit 818B with 1+1 protection, meaning that for each packet transmitted on optical circuit 818B, a duplicate packet is transmitted on optical circuit 818C. In an alternate embodiment, optical circuit 818C protects optical circuit 818B with 1:1 protection. In this protection scheme, packets destined for optical circuit 818B are instead transmitted on optical circuit 818C if optical circuit 818B is unavailable. Furthermore, optical circuit 818C protects optical circuit 818B with optical protection schemes known in the art and/or those developed in the future.

FIG. 8C is a block diagram of optical circuits including optical service levels using the DTSP nodes according to one embodiment of the invention. FIG. 8C is similar to FIG. 8A in network 800 is comprised of DTSP 802A-D interconnected by optical circuits 818A-E in the same fashion as in FIG. 8A. Furthermore each DTSP 802A-D is comprised of an electrical switch part 804A-D and optical transport part 806A-D, where electrical switch part 804A-D comprises packet lines card(s) 814A-D, packet electrical switch module 808A-D, WTR 810A-H and optical transport part comprises optical switch 812A-D, as in FIG. 8A. In addition, each entity in FIG. 8C performs the same function as described in FIG. 8A. However, unlike FIG. 8A, in FIG. 8C, optical circuit 818B has optical service level one whereas optical circuit 818C has optical service level two. Each optical circuit 818A-E can have different optical service levels, where an optical service level guarantees a particular performance level for packets transmitted on that optical circuit. Examples of optical service level guarantees are, but not limited to, bit error rate (BER) guarantees, minimum bandwidth, optical protection schemes, etc. For example, and by way of illustration, optical circuit 818B may have a higher BER than optical circuit 818C.

Thus, different embodiments may be implemented to perform one or more different applications combinations of applications (e.g., one or more of the exemplary applications or from FIGS. 8A-C; and/or other applications).

### Processing of Traffic Flows

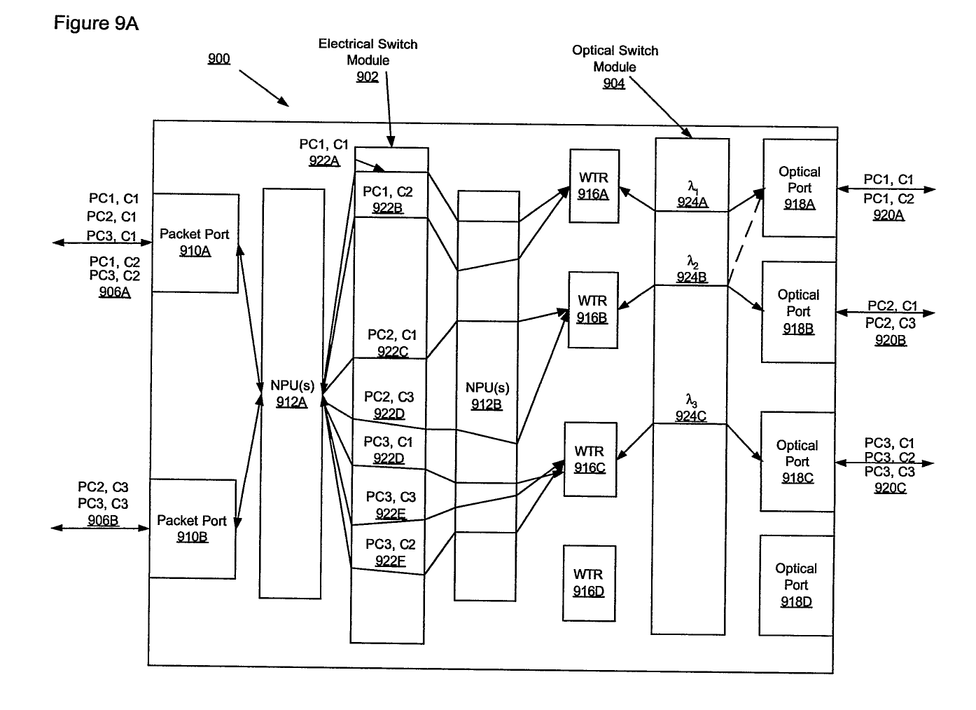

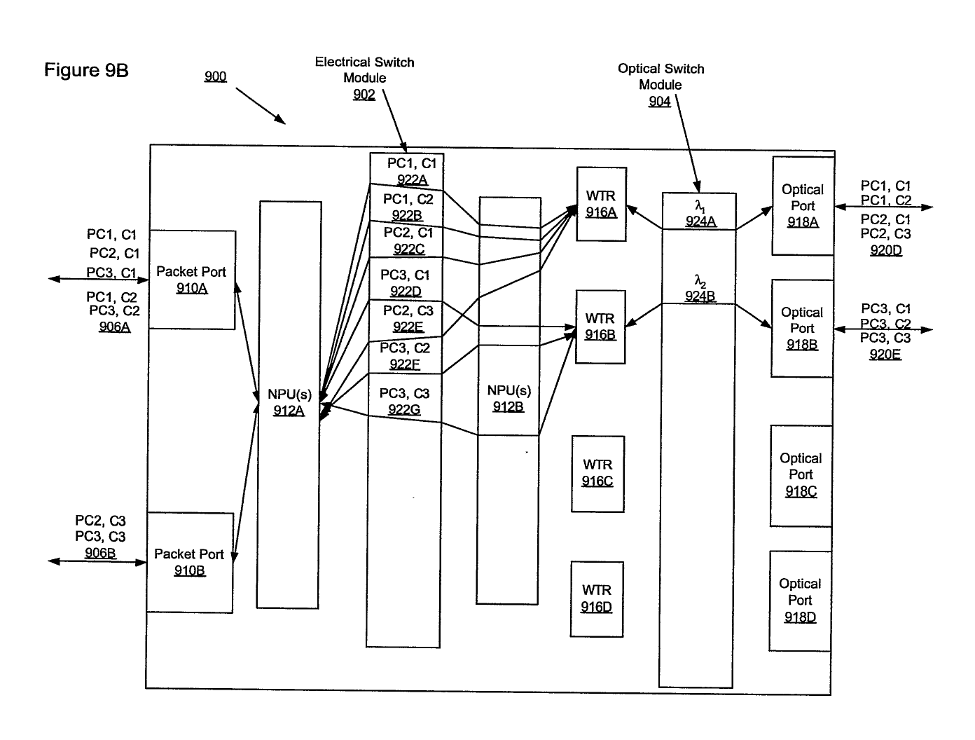

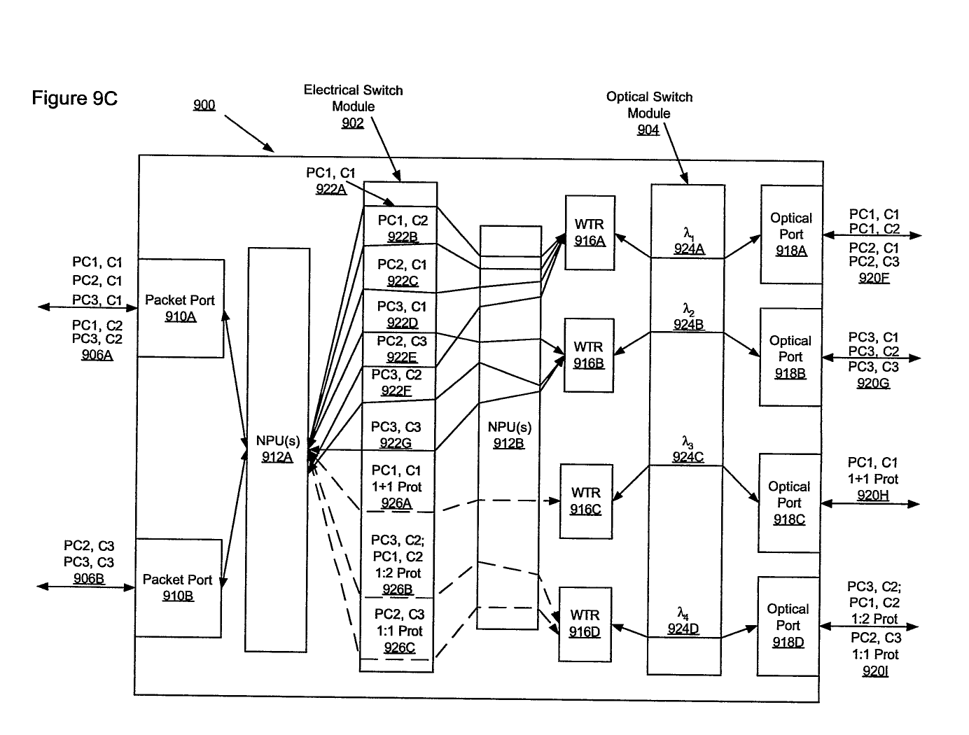

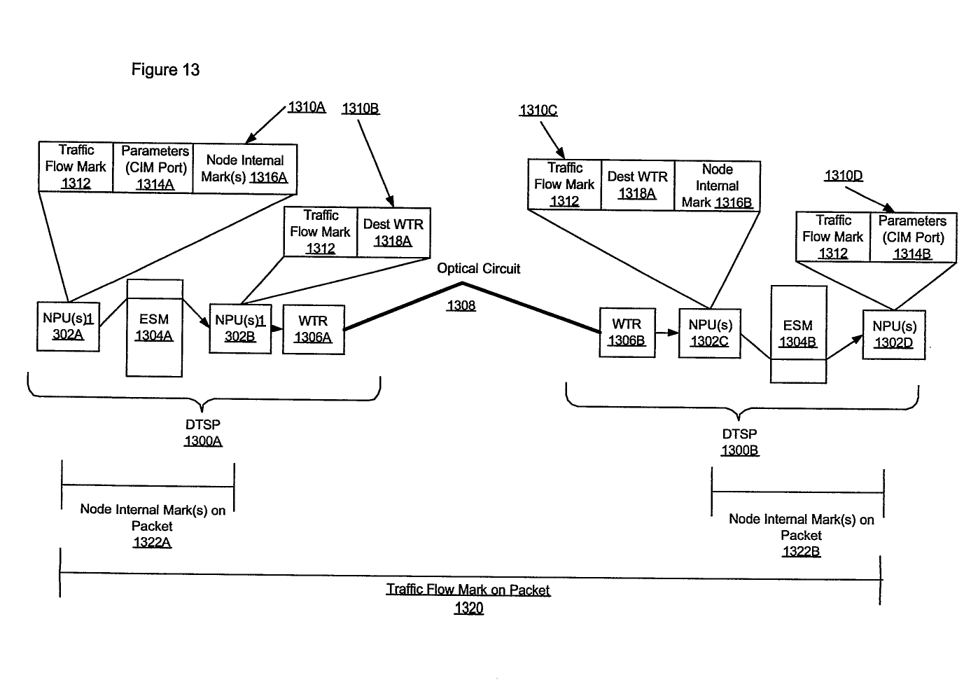

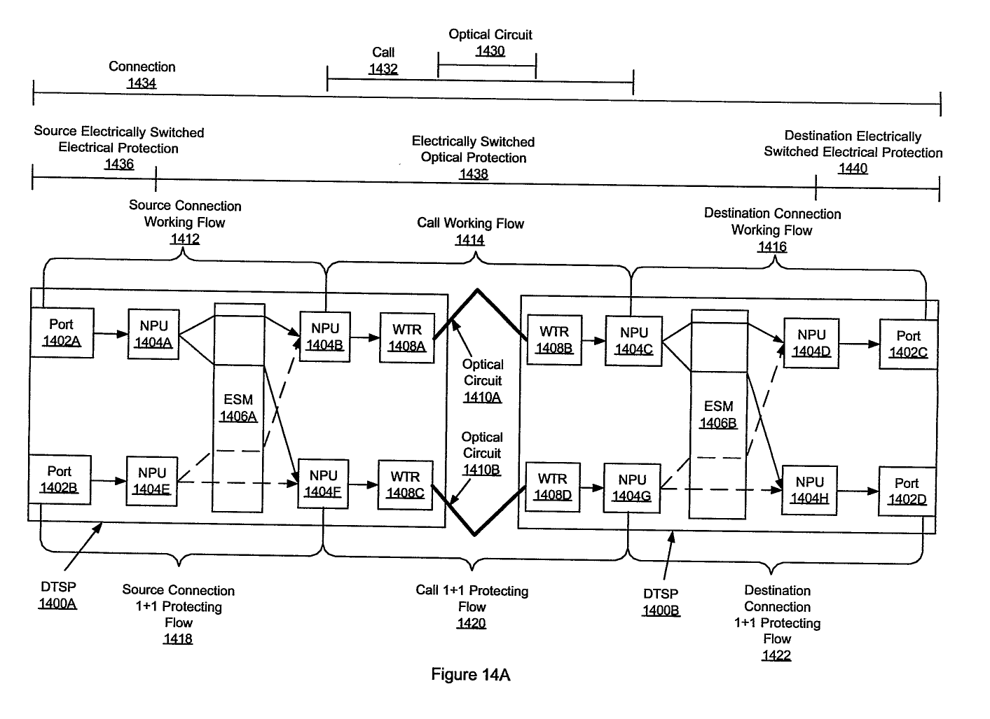

FIGS. 9A-C are block diagrams that use an exemplary architecture at a DTSP node to show different exemplary ways of processing traffic flows. In particular, FIG. 9A is a block diagram of a DTSP node, illustrating packet classification and wavelength selection according to one embodiment of the invention. In FIG. 9A, DTSP 900 comprises packet port 910A-B, NPU(s) 912A-B, electrical switch module 902, WTR 916A-D, optical switch module 904 and optical ports 918A-D. Packet ports 910A-B receive/transmit packets to/from electrically switched network. In particular, packet port 910A receives five different traffic flows 906A: packets with packet classifications one, two, and three from client one (PC1, PC2, PC3 from Cl; traffic flows 922A-C); and packet classification one and three from client two (PC1, PC3 from C2; traffic flows 922D-E). Furthermore, packet port 910B receives two different traffic flows 906B: packet classification one and three from client two (PC1, PC3 from C3; traffic flows 922F-G). Traffic flows from packet ports 910A-B are processed by NPU(s) 912A. In one embodiment, NPU(s) 912A process the packets in the traffic flows by examining each packet and marking the packet with two marks: (1) A node internal mark that signals to electrical switch module 902 how to switch the packet and (2) A traffic flow mark used with the optically switched network that uniquely identifies the traffic flow to which the packet belongs. Packet marking is further described in FIG. 13, below.

Returning to FIG. 9A, NPU(s) 912A separate traffic flows 906A-B into individual traffic flows 922A-G based on packet classification and client and forward the individual traffic flows 922A-G to electrical switch module 902. Electrical switch module 902 switches individual traffic flows 922A-G to packet network processor 912B based on the node internal mark added by NPU(s) 912A. Packet network processor 912B processes the individual traffic flows 922A-G and forwards these flows 922A-G to corresponding WTR 916A-D. Furthermore, NPU(s) 912B removes the node internal mark from each packet in the individual traffic flows.

In one embodiment, NPU(s) 912B aggregates traffic flows with the same packet classification and forwards the aggregated traffic flows to corresponding WTR 916A-D. Specifically in FIG. 9A, NPU(s) 912B aggregate and forward the following traffic flows: (1) traffic flows 922A (PC1, C1) and 922B (PC1, C2) to WTR 916A; (2) traffic flows 922C (PC2, C1) and 922D (PC2, C3) to WTR 916B; and (3) traffic flows 922E-G (PC3, C1), (PC3, C2) and (PC3, C3) to WTR 916C. Although FIG. 9A illustrates a specific classification and aggregation of traffic flows 906A-B by NPU(s) 912A-B, alternate embodiments can have other possible classifications and aggregation of traffic flows.

In addition, each WTR 916A-C may be a beginninglend point of an optical circuit, and thus encapsulate/decapsulate to/from a DWDM wavelength. Thus, WTR 916A-C encapsulates packets in traffic flows 906A-B and transmits the traffic flow on DWDM wavelengths. Specifically, WTR 916A transmits traffic flows 922A-B on wavelength λ₁ 924A; WTR 916B transmits traffic flows 922C-D on wavelength λ₂ 924B; and WTR 916C transmits traffic flows 922E-G on wavelength λ₃. WTR 916A-C provides DWDM wavelengths to the optical switch module, which optically switches and multiplexes DWDM wavelengths onto different of the optical ports 918A-D. In turn, optical ports 918A-C forward the wavelengths λ₁, λ₂ and λ₃ 924A-C, respectively, on connected DWDM fibers. Alternatively, optical switch module 904 multiplexes wavelengths λ₁ 924A and λ₂ 924B onto the fiber coupled to optical port 918A.

In this embodiment and by way of illustration, traffic flows with the same packet classification are transmitted on the same wavelength. Alternatively, other embodiments can aggregate traffic flows with different packet classification transmitted on the same wavelength. Each traffic flow 922A-G is illustrated as unprotected working traffic flows. A working traffic flow is the main traffic flow used to transmit packets over the optical circuit.

Traffic flows 920A-C entering DTSP 900 on optical ports 918A-C are processed in a reciprocal fashion as traffic flows 906A-B entering on packet ports 910A-B. Traffic flows 920A-C entering optical ports 918A-C, respectively, are demultiplexed and optically switched by optical switch module 904 to the corresponding WTR 916A-C. WTR 916A-C converts the packets in traffic flows 920A-C into packets ready for processing by NPU(s) 912A-B. Specifically, WTR 916A-C deencapsulate and forward the converted packets in traffic flows 920A-C to NPU(s) 912B. Packet network processor(s) 912B separates traffic flows 920A-C into individual traffic flows 922A-G. In addition, NPU(s) 912B adds a node internal mark to each packet that signals to the electrical switch module 902 how to switch the packet. Electrical switch module 902 switches the individual traffic flows to NPU(s) 912A based on the marks added to the traffic flow packets by NPU(s) 912B. Packet network processor(s) 912A removes the node internal mark from each packet added by NPU(s) 912B and the traffic flow mark from each packet added by the source DTSP. Packet marking and removal of marks is further described in FIG. 13 below. In addition, NPU(s) 912A forwards traffic flows 922A-G to the corresponding packet port 910A-B. Packet port 910A-B transmits traffic flows 906A-B to the electrically switched network.

In FIG. 9A, DTSP 900 directs traffic flows from the same packet port 910A-B to different wavelengths 924A-D. This is unlike the prior art, where access node 300/332 that can only map traffic flows incoming on a port to one wavelength. DTSP 900 can direct different traffic flows because packet processor(s) 912A classifies and marks traffic flows, while electrical switch module 902 switches traffic flows to appropriate destination via corresponding WTR 916A-D.

FIG. 9B is a block diagram of a DTSP node illustrating wavelength sharing among multiple traffic flows according to one embodiment of the invention. In FIG. 9B, DTSP 900 comprises packet ports 910A-B, NPU(s) 912A-B, electrical switch module 902, WTR 916A-D, optical switch module 904 and optical ports 918A-D as in FIG. 9A. In addition, each module performs the same function as described in FIG. 9A. Furthermore, packet ports 910A-B receive the same traffic flows 906A-B as in FIG. 9A.

However, FIG. 9B differs from FIG. 9A in the manner in which DTSP 900 aggregates the incoming traffic flows 906A-B. Unlike in FIG. 9A where DTSP 900 aggregates traffic flows with the sarne packet classification onto the same wavelength, in FIG. 9B, DTSP 900 aggregates traffic flows with different packet classifications onto the same wavelength. For example and by way of illustration, NPU(s) 912B aggregate and forward traffic flows with packet classification one and two to wavelength, λ₁ and traffic flows with packet classification three to wavelength λ₂. Thus, WTR 916A transmits aggregated traffic flows 920D ((PC1, C1), (PC1, C2), (PC2, C1) and (PC2, C2)) out optical port 918A on wavelength λ₁, and WTR 916B transmits aggregated traffic flows 920E ((PC3, C1), (PC3, C2), and (PC3, C3)) out optical port 918B on wavelength 2. Optical ports 918C-D are not used in this example. Traffic flows 920A-B entering DTSP 900 on optical ports 918A-B are processed in a similar fashion as in FIG. 9A.

FIG. 9B illustrates the ability of DTSP to aggregate multiple traffic flows onto a single wavelength (and conversely, separate multiple traffic contained in one wavelength). This is in contrast to access nodes 300/322/350 that could not aggregate/separate multiple traffic flows onto/from a single wavelength. This additional capability stems from the electrical switching capability of DTSP 900 with an array of WTR 916 A-D. In addition, because optical circuits corresponding, to WTR 916A-D can have different optical service levels (as illustrated in FIG. 8C above), DTSP 900 allows mapping of traffic flows from one packet to optical circuits with different optical services levels. Because the prior art does not disclose an access node mapping traffic flows from one port to different optical circuits, access nodes 300/322/350 does not map different traffic flows from one port to optical circuits with different optical service levels.

FIG. 9C is a block diagram of a DTSP node illustrating packet classification and wavelength selection with optical path protection according to one embodiment of the invention. FIG. 9C is similar to FIG. 9B in that DTSP 900 comprises packet ports 910A-B, NPU(s) 912A-B, electrical switch module 902, WTR 916A-D, optical switch module 904 and optical ports 918A-D. Each module performs the same function as described in FIG. 9B. Furthermore, packet ports 910A-B receives the same traffic flows 906A-B as in FIG. 9B. In addition, in FIG. 9C, DTSP 900 separates and aggregates traffic flows 906A-B into traffic flows 920A-B in the same manner as FIG. 9B.

However, unlike in FIG. 9A-B, DTSP 900 protects some of the individual traffic flows 922A-G with protecting traffic flows 926A-C. A protecting traffic flow is used to transmit packets originally destined for a working traffic flow when the working traffic flow is unavailable. In one embodiment, NPU(s) 912A protects selected working traffic flows 922A-G. In this embodiment, NPU(s) 912A protects working traffic flows 922A-G by either redirecting or duplicating traffic flows 922A-G to different optical circuits using one or more optical protection schemes known in the art such as, but not limited to, 1+1, 1:1, 1:N, etc.

In FIG. 9C, NPU(s) 912A protects a traffic flow with a 1+1 protection scheme by duplicating each packet in that traffic flow and directing the duplicated packets to the protecting optical circuit. Packet network processor(s) 912A directs the duplicated packet by marking each packet with the corresponding node internal and traffic flow marks associated with the protecting optical circuit. For example and by way of illustration, in this embodiment, NPU(s) 912A directs packets in working traffic flow 922A to WTR 916A by appropriate packet marking. Electrical switch module 902 switches the packets in traffic flow 922A to WTR 916A as described in FIG. 9A. Furthermore, NPU(s) 912A implements 1+1 protection for traffic flow 922A by duplicating each packet in traffic flow 922A and marking the packets for traffic flow 926A and WTR 916C. Electrical switch module 902 switches the duplicated packets in protecting traffic flow 926A to WTR 916C via NPU(s) 912B. WTR 916C transmits protecting traffic flow 926A on wavelength λ₃ to optical port 918C via optical switch module 904. Thus, in a 1+1 protection scheme, DTSP 900 transmits two identical traffic flows on different optical circuits.

In FIG. 9C, NPU(s) 912A protects one of the traffic flows 922A-G with a 1:1 protection scheme by redirecting packets in traffic flow 922E to traffic flow 926C if traffic flow 922E is unavailable. Traffic flow 922E can be unavailable for a variety of reasons, such as, but not limited to, intermediate node of the optical circuit not functioning, WTR 916A not functioning, WTR in destination DTSP not functioning, etc. If traffic flow 922E is unavailable, NPU(s) 912A marks each packet originally in traffic flow 922E as part of protecting traffic flow 926C destined for WTR 916D. WTR 916D transmits traffic flows onto wavelength λ₄ to optical port 918D via optical switch module 904. Thus, in a 1:1 protection scheme, DTSP transmits one traffic flow, as opposed to DTSP transmitting two traffic flows for a 1+1 protection scheme. The DTSP transmits the traffic flow on the working optical circuit if available; otherwise DTSP transmits the traffic flow on the protecting optical circuit.

In FIG. 9C, NPU(s) 912A protects two of the traffic flows 922A-G with a 1:2 protection scheme by redirecting packets in traffic flows 922B and 922F to traffic flow 926B if the corresponding working optical circuits are unavailable. A 1:2 protection scheme is a specific example of an 1:N protection scheme. The generalized 1:N protection scheme protects N working traffic flows with one protecting traffic flow. Specifically, in a 1:2 protection scheme, DTSP protects two working traffic flows with one protecting traffic flow. Consequently, under this protection scheme, DTSP can protect one of the two traffic flows at a time (unless protecting traffic flow has the capacity for both traffic flows). If the optical circuits supporting the working traffic flows fail for the two traffic flows, then one of the traffic flows is unprotected. For example and by way of illustration, if NPU(s) 912A determines that traffic flow 922B is unavailable, NPU(s) 912A marks the packet originally in traffic flow 922B as part of protecting traffic flow 926B destined for optical circuit 928D. WTR 916D transmits traffic flow 926B onto wavelength λ₄ to optical port 918D via optical switch module 904. Similarly, if NPU(s) 912A determines that traffic flow 922F is unavailable, NPU(s) 912A marks the packet originally in traffic flow 922F as part of protecting traffic flow 926B destined for WTR 916D. WTR 916D transmits traffic flow 926B onto wavelength λ₄ to optical circuit 928D and out optical port 918D via optical switch module 904. However, in one embodiment, if both traffic flow 922B and 922F are unavailable, NPU(s) can only protect one traffic flow, because protecting traffic flow 926B protects one traffic flow.

FIG. 9C illustrates DTSP 900 performs electronically switched optical protection. As illustrated in FIG. 9C, NPU(s) 912A control the traffic flows to working/protecting traffic flows using protection scheme involving optical circuits. Electrically switched optical protection is a fast protecting scheme, because the switching from working to protecting traffic flow occurs in the electrically switched part of DTSP 900 (i.e., packet networks processor(s) 912A and electrical switch module 902). Referring, to FIG. 3A-C, access nodes 300/320/350 cannot electrically protect traffic flows because access node 300/322/350 only optically switches wavelengths. Furthermore, L2/L3 devices 302 A-C (or 320A-B) cannot protect traffic flows across multiple optical circuits, because L2/L3 device 302A-C (and 320A-B) do not contain knowledge of the optically switched network. On the other hand, because DTSP 900 integrates electrical and optical switch, DTSP 900 can perform fast electrically switched optical protection of traffic flows.

Thus, different embodiments may be implemented to process traffic one or more different ways or combinations of ways (e.g., one or more of the exemplary ways in FIGS. 9A-C, and/or other ways).

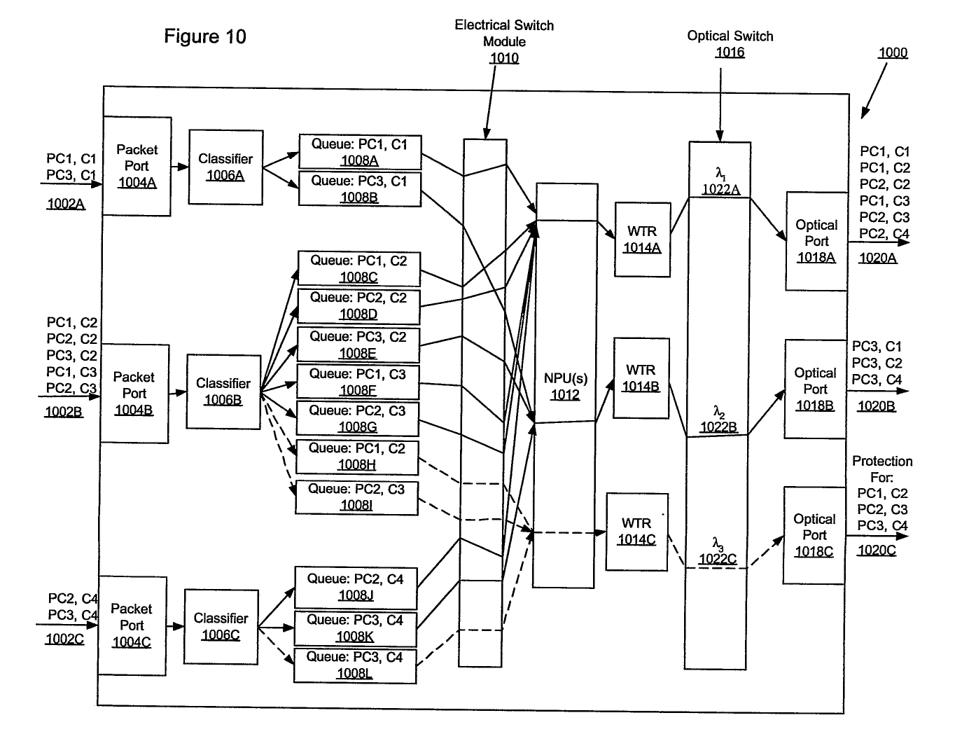

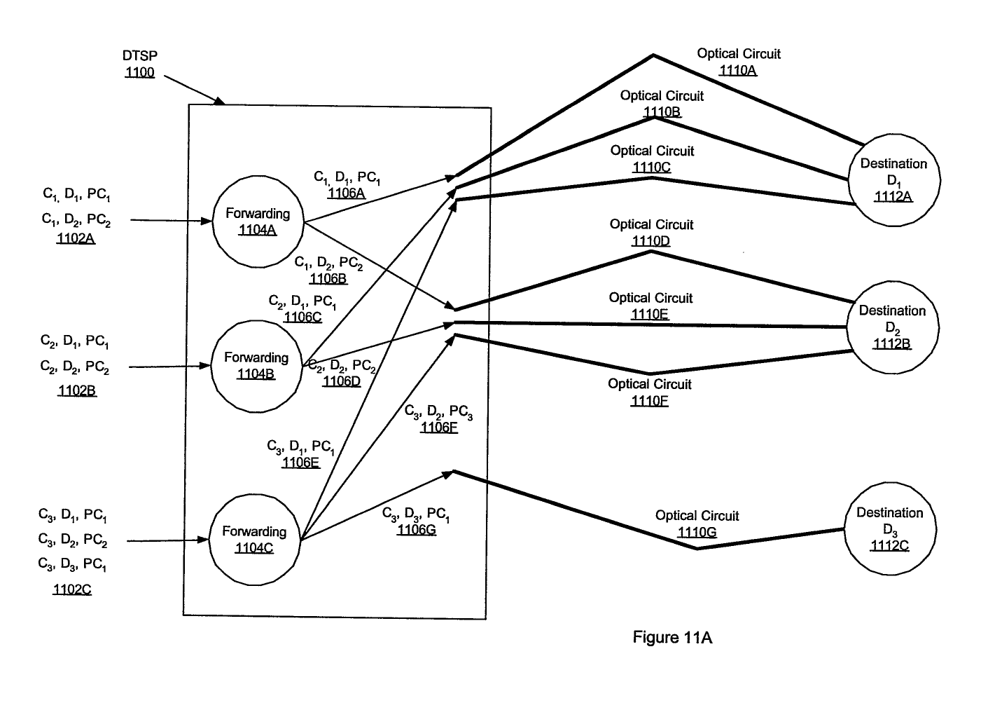

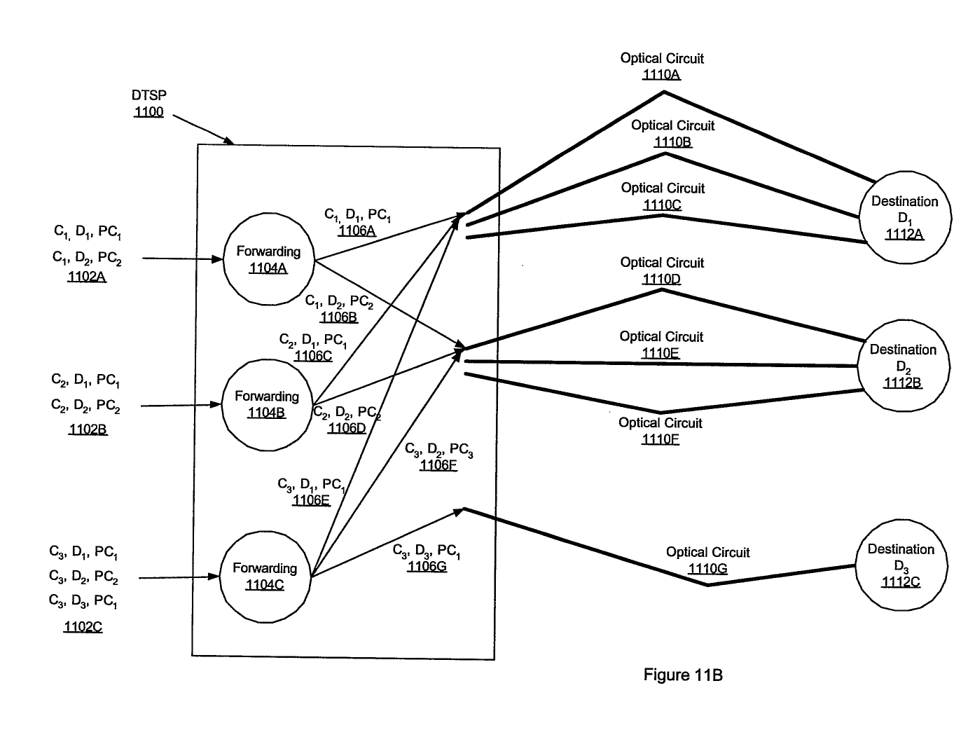

FIG. 10 is a block diagram of an exemplary architecture of a DTSP node illustrating rate-limiting packet service levels according to one embodiment of the invention. In FIG. 10, DTSP 1000 comprises packet ports 1004A-C, packet classifiers 1006A-C, queues 1008A-L, electrical module switch 1010, NPU(s) 1012, WTR 1014A-C, optical switch 1016 and optical ports 1018A-C. Similar to DTSP 900, the individual traffic flows in aggregated traffic flows 1002A-C enter DTSP 1000 on packet ports 1004A-C and exit as a second set of aggregated traffic flows 1020A-C. DTSP 1000 differs from DTSP 900 because DTSP 1000 rate limits each of the individual flows contained in aggregated traffic flows 1002A-C with queues 1008A-L. Traffic flow 1002A contains individual traffic flows comprising packets with packet classification one and three from client one (PC1, C1 and PC3, C1). In addition, traffic flow 1002B contains individual traffic flows comprising packets with packet classification one, two and three from client two (PC1, C2; PC2, C2 and PC3, C2) and packet classification one and two from client three (PC2, C2 and PC3, C2). Finally, traffic flow 1002C contains individual traffic flows comprising packets with packet classification two and three from client four (PC2, C4 and PC3, C4).

In FIG. 10, DTSP 1000 receives traffic flows 1002A-C at packet ports 1002A-C, respectively. In one embodiment, classifiers 1006A-C process and classify each individual traffic flow in traffic flows 1002A-C for use by queues 1008A-L. In embodiments where marking is used as previously described Classifiers 1006A-C may also perform this marking (e.g., node internal and traffic flow marks used by DTSP 1000 to forward each packet to the appropriate optical circuit 1022A-C); however, such marking may be performed elsewhere and/or a combination of places. In one embodiment, classifiers 1006A-C also participates in protecting the individual traffic flows (e.g., by duplicating, etc.) based on the individual traffic flow configuration and optical circuit availability. In this embodiment, classifiers 1006A-C may support the various protections schemes known in the art, such as, but not limited to, 1+1, 1:1, 1:N, etc. For example and by way of illustration, classifier 1006A classifies and separates traffic flow 1002A into the individual traffic flows (PC1, C1), (PC3, C1) for queues 1008A-B, respectively. In addition, classifier 1006B classifies and separates traffic flow 1002A into individual traffic flows (PC1, C2), (PC2, C2), (PC3, C2), (PC1, C3), (PC2, C3) for queues 1008C-G, respectively. Furthermore, classifier 1006B protects traffic flows (PC1, C2) and (PC2, C3) by forwarding these traffic flows to queues 1008H-I. Alternatively, classifier 1006B does not forward protecting traffic flows for traffic flows (PC1, C2), and (PC2, C3) to separate queues 1008H-I. Instead classifier marks the packets in traffic flows (PC1, C2), and (PC2, C3) for protecting while using existing queues 1008C and 1008G. Finally, classifier 1006C classifies and separates traffic flow 1002C into the individual traffic flows (PC2, C41), (PC3, C4) for queues 1008J-K, respectively. In addition, classifier 1006B protects traffic flow (PC3, C4) by forwarding this traffic flow to queue 1008L. While in certain embodiments classifiers 1006A-C participate in protection, alternative embodiments may perform such protection functions elsewhere (e.g., in between the queues 1008A-L and electrical switch module 1010).

Each queue 1008A-L manages the corresponding individual traffic flow by draining queues at a rate configured for each traffic flow. Each queue 1008A-L performs the traffic flow management using techniques known in the art and/or developed in the future, such as rate limiting, policing, etc.

DTSP 1000 processes the packets in the individual traffic flows in much the same manner as DTSP 900. For example and by way of illustration, electrical switch module 1010 switches packets in individual traffic flows (e.g., based on node internal marks added by classifiers 1006A-C). Packet network processor(s) 1012 aggregate traffic flows to corresponding WTR 1014A-C. Specifically, NPU(s) 1012 aggregate and forward the following traffic flows: (1) traffic flows (PC1, C1), (PC1, C2), (PC2, C2), (PC1, C3), (PC2, C3), and (PC2, C4) to WTR 1014A; (2) traffic flows (PC3, C1), (PC3, C2), and (PC3, C2) to WTR 1014B; and (3) protecting traffic flows (when necessary) for traffic flows (PC1, C2), (PC2, C3), and (PC3, C4) to WTR 1014C.

In turn, WTR 1014A transmits individual traffic flows (PC1, C1), PC1, C2), (PC2, C2), (PC, C3), (PC2, C3), and (PC2, C4) on wavelength λ₁ to optical circuit 1022A via optical port 1018A and optical switch module 1016. Similarly, WTR 1014B transmits individual traffic flows PC3, C1), (PC3, C2), and (PC3, C2) on wavelength λ₂ to optical circuit 1022B via optical port 1018B and optical switch module 1016. In addition, WTR 1014C transmits protecting traffic flows for traffic flows (PC1, C2), (PC2, C3), and (PC3, C4) (when necessary) on wavelength 3 to optical circuit 1022C via optical port 1018C and optical switch module 1016.

While embodiments are described in which traffic flows are handled individually (e.g., one per queue), alternative embodiments may handle them differently (e.g., by having one or more queue handle more than one traffic flow, by having multiple queues for a single traffic flow, etc.)

### Mapping Traffic Flows to Optical Circuits

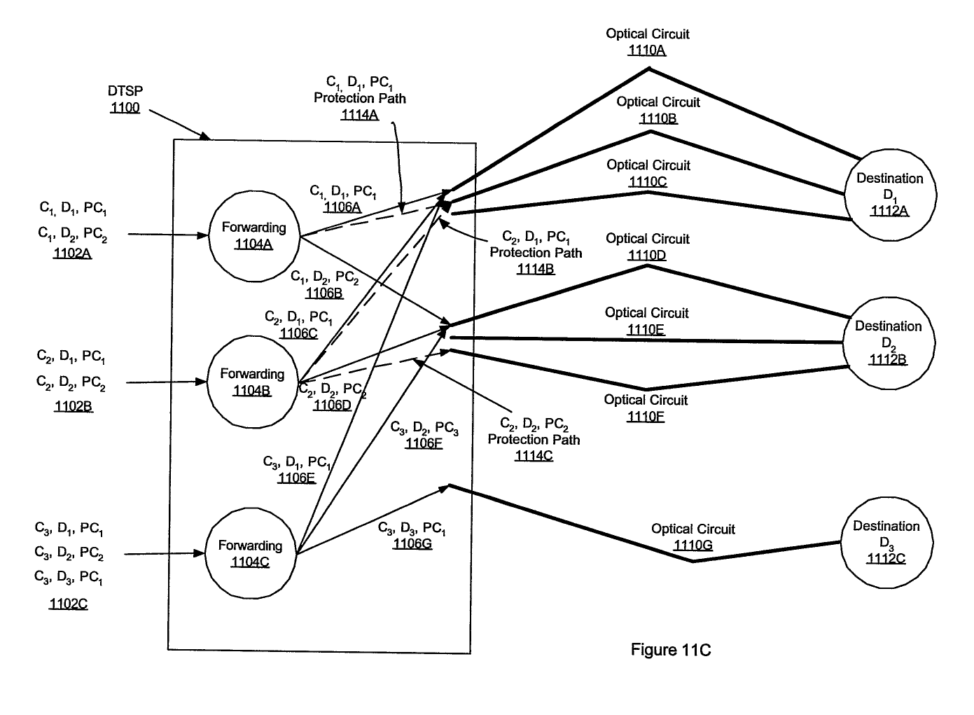

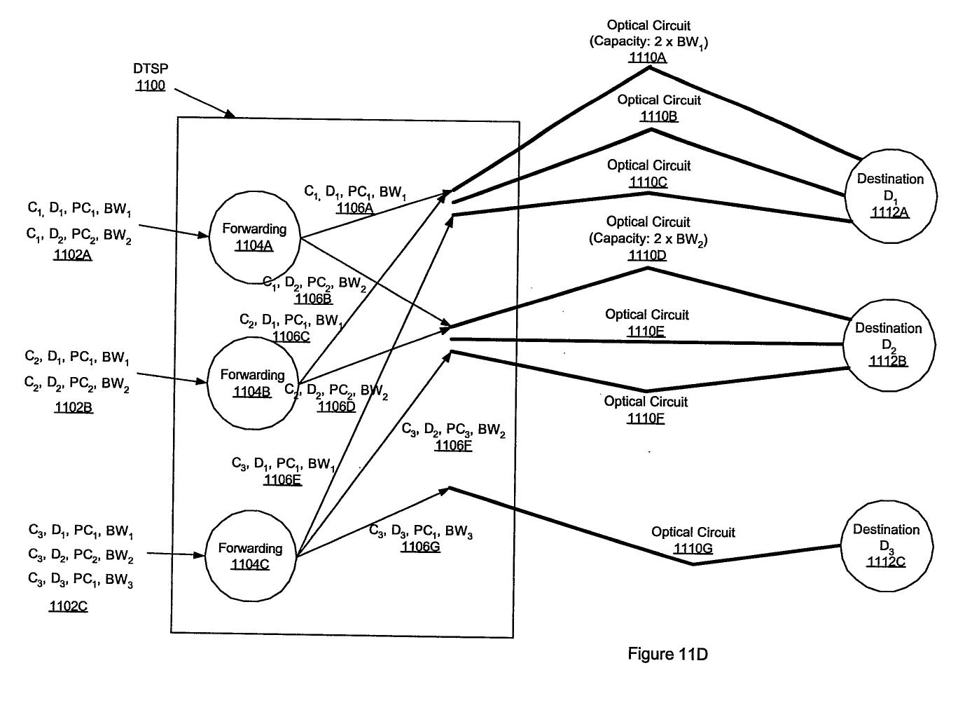

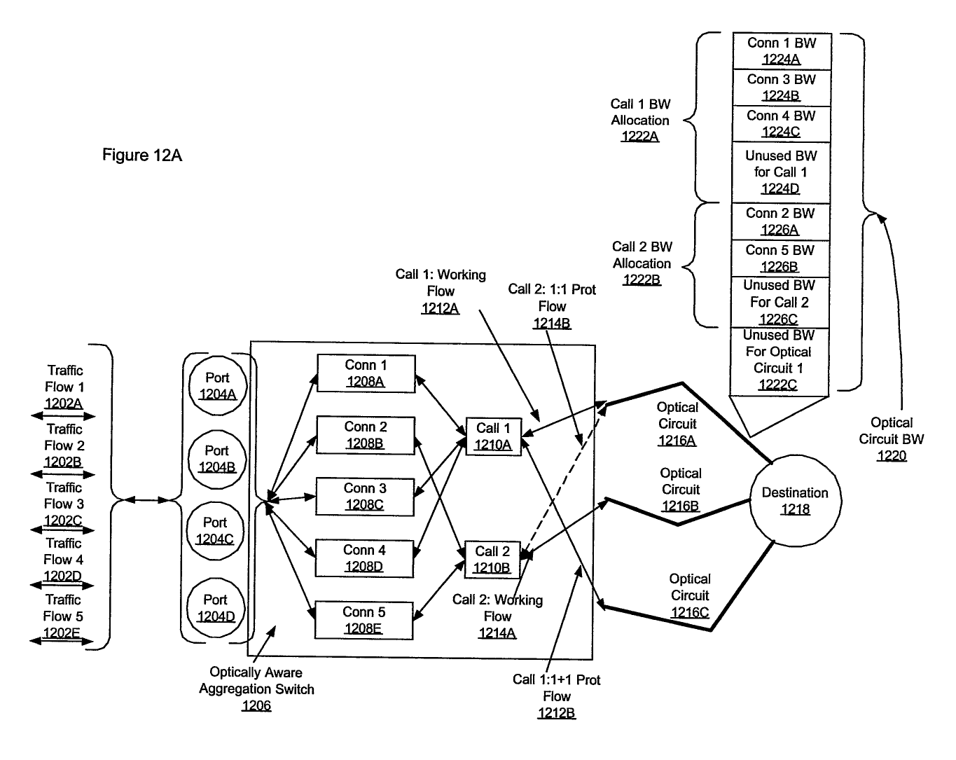

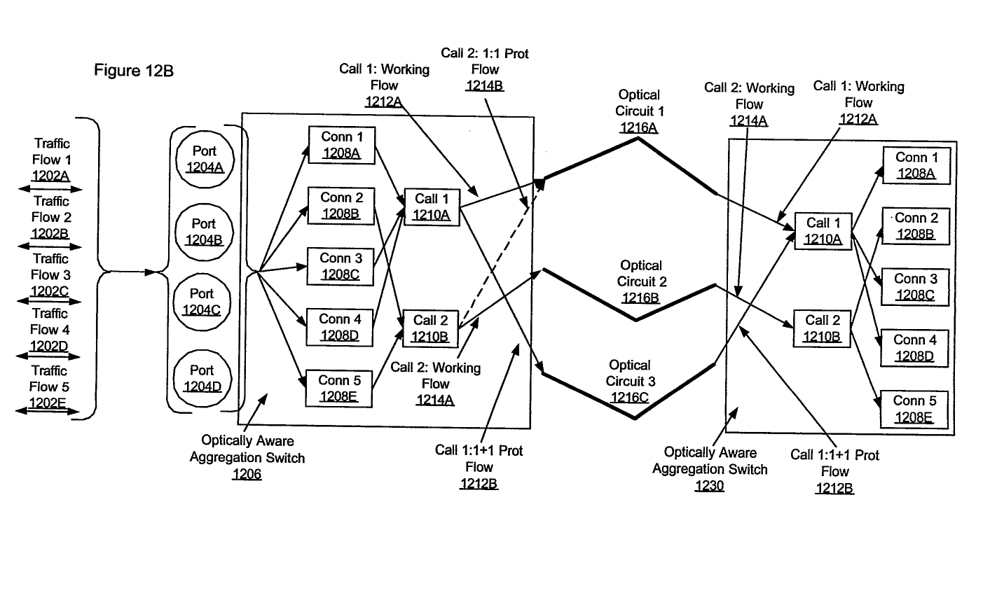

FIGS. 11A-C are block diagrams illustrating different exemplary ways of performing optical circuit selections including traffic flow aggregation and protections to multiple destinations. FIG. 11A is a block diagram illustrating optical circuit selection for traffic flows by DTSP node 1100 according to one embodiment of the invention. In FIG. 11A, forwarding engines 1104A-C process and forward traffic flows 1102A-C onto optical circuits 1110A-G towards destination nodes 1112A-C. With reference to previously described DTSP node architectures: 1) the traffic flow 1102A-C are each received at a packet part of a DTSP node 1100; and 2) the forwarding engines 1104A-C and beginning of the optical circuits are in the DTSP node 1100 and represent NPU(s), an electrical switch module, WTRs, (where the WTRs originate the optical circuits), an optical switch module, and optical parts. Each incoming traffic flows comprises different compositions of individual traffic flows with potentially different destinations. For example and by way of illustration, traffic flow 1102A comprises individual traffic flows for: (1) traffic flow 1106A comprising packets with packet classification one, from client one to destination one 112A (C₁, D₁, PC₁) and (2) traffic flow 1106B comprising packets with packet classification two, from client one to destination two 112B (C₁, D₂, PC₂). Furthermore, traffic flow 1102B comprises individual traffic flows for: (1) traffic flow 1106C comprising packets with packet classification one, from client two to destination one 112A (C₂, D₁, PC₁) and (2) traffic flow 1106D comprising packets with packet classification two, from client two to destination two 112B (C2, D₂, PC₂). Finally, traffic flow 1102C (comprises three individual traffic flows: (1) traffic flow 1106E comprising packets with packet classification one, from client three to destination one 112A (C₃, D₁, PC₁); (2) traffic flow 1106F comprising packets with packet classification two, from client three to destination two 1112B (C₃, D₂, PC₂) and (3) traffic flow 1106G comprising packets with packet classification one, from client three to destination three 112C (C₃, D₃, PC₁).

Forwarding engines 1104A-C separate the individual traffic flows 1106A-G and forward these traffic flows 1106A-G to corresponding optical circuits 1110A-G based on the destination of the individual traffic flow, the individual traffic flow packet classification and available bandwidth on the optical circuit. For example and by way of illustration, seven optical circuits 1110A-G are destined for three different destination nodes 1112A-C. Optical circuits 1110A-C are destined for destination D₁ 1112A, whereas optical circuits 1110D-F are destined for destination D₂ 1112B. Finally only one optical circuit 1110G is destined for destination D₃.

In FIG. 11A, DTSP 1100 forwards each individual traffic flow to its own optical circuit. For example and by way of illustration, forwarding engine 1104A forwards traffic flows 1106A-B to optical circuits 1110A and 1110D, respectively. Traffic flows 1106A-B have different destinations, necessitating transmission on separate optical circuits. In addition, forwarding engine 1104B forwards traffic flows 1106C-D to optical circuits 1110B and 1110E, respectively. Furthermore, forwarding engine 1104B forwards traffic flows 1106E-G to optical circuit 1110C, 1110F, and 1110G, respectively. Although each forwarding engine forwards traffic flows to different destinations, collectively, three optical circuits are used for destinations D₁ 1112A and D₂ 1112B, with one optical circuit used for destination D₃ 1112C. This embodiment may be useful for some network configurations; however, it may also be useful to aggregate traffic flows onto one or more optical circuits by forwarding engines 1104A-C. An example of traffic flow aggregation is described in FIG. 1108B, below.

FIG. 11B is a block diagram illustrating optical circuit selection for traffic flows that includes traffic flow optical circuit sharing according to one embodiment of the invention. FIG. 11B is similar to FIG. 11A in that forwarding engines 1104A-C process and forward aggregated traffic flows 1102A-C onto optical circuits 1110A-G to destination nodes 1112A-C. Each incoming aggregated traffic flow 1102A-C comprises the same individual traffic flows as in FIG. 11A.

However, unlike in FIG. 11A, forwarding engines forward individual traffic flows to single optical circuits based on destination. For example and by way of illustration, forwarding engines 1104A-C forward traffic flows 1106A, 1106C and 1106E having destination D₁ 1112A to optical circuit 1110A. This embodiment assumes that optical circuit 1110A has the capacity to carry all the bandwidth required from traffic flows 1106A, 1106C and 1106E (or alternatively, packets are dropped to meet the capacity). In addition, forwarding engines 1104A-C forward traffic flows 1106B, 1106D and 1106F having destination D₂ 1112B to optical circuit 1110D. Furthermore, forwarding engine 1104C forwards traffic flow having destination D₃ 1112C to optical circuit 1110G.

As illustrated in FIG. 11B and unlike FIG. 11A, forwarding engines 1104A-C do not use optical circuits 1110B-C, and 1110E-F. In this embodiment, the number of optical circuit used is conserved because forwarding engines 1104 A-C aggregate multiple traffic flows 1102 A-G onto optical circuits 1110A, 1110D and 1110F. For example, conserving optical circuits allows the unused optical circuits to be used as, but not limited to, protecting circuits (as is shown in FIG. 11C below), use the unused optical circuits for different optical service levels, extra bandwidth, etc. This is unlike the prior art where access node 300/322 maps traffic coming from individual ports to optical circuits. Thus, access node 300/322 is inefficiently uses the optical circuits because access node 300/322 cannot aggregate traffic flows onto optical circuits.

FIG. 11C is a block diagram illustrating optical circuit selection for traffic flows that includes traffic flow optical circuit sharing and traffic flow optical protection according to one embodiment of the invention. FIG. 11C is similar to FIG. 11A in that forwarding engines 1104A-C process and forward aggregated traffic flows 1102A-C onto optical circuits 1110A-G to destination nodes 1112A-C. Each incoming aggregated traffic flows 1102A-C comprises the same individual traffic flows as in FIG. 11A. In addition, FIG. 11C illustrates the same forwarding of traffic flows 1106A-G to optical circuits as in FIG. 11B.

However, added to FIG. 11C are three protecting traffic flows 1114A-C for traffic flows 1106A, 1106C and 1106D. In one embodiment, forwarding engine 1104A protects traffic flow 1106A by forwarding protecting traffic flow 1114A to optical circuit 1106B. In addition, forwarding engine 1104B protects traffic flows 1106C-D by forwarding protecting traffic flows 1114B-C to optical circuits 1106B and 1110F, respectively. Forwarding engines 1104A-B employ protection schemes known in the art, such as, but not limited to, 1+1, 1:1, 1:N, etc. Typically, forwarding engines 1104A-B protect traffic flows by forwarding protecting traffic flows to optical circuits that are disjoint from those used by the corresponding working traffic flows.

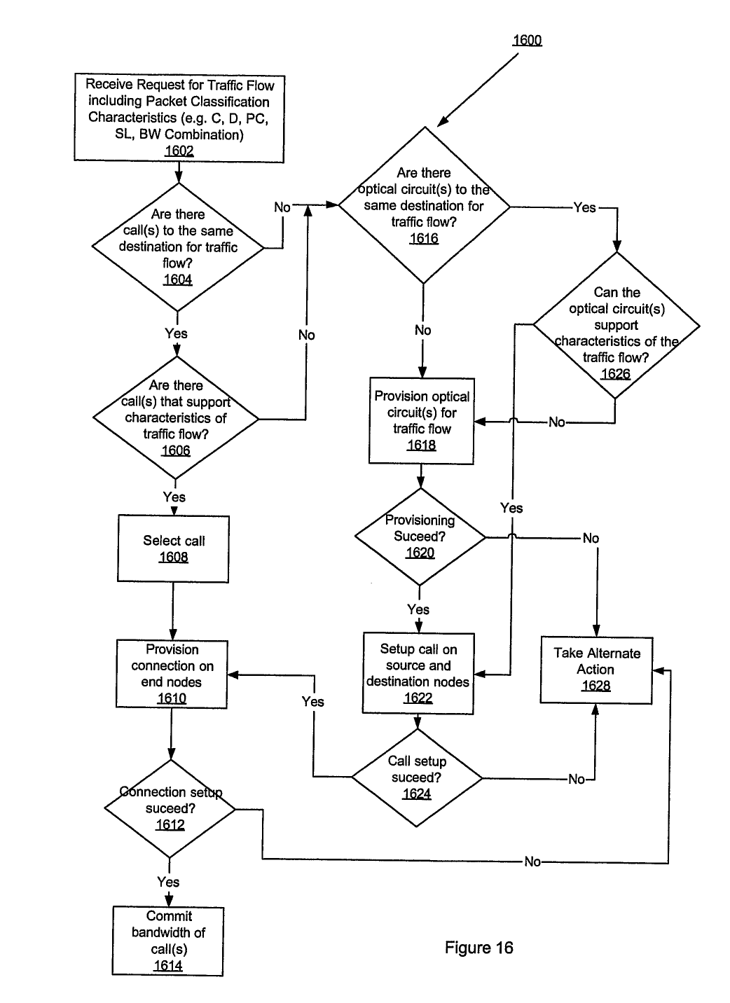

In one embodiment, optical circuit selection is performed as illustrated in FIGS. 12A, and 16. Thus, FIG. 11C illustrates forwarding engines 1104A-B taking advantage of the conserved optical circuits by protecting some of the traffic flows.

FIG. 11D is a block diagram illustrating optical circuit selection for traffic flows including multiple optical circuits for similar traffic flows according to one embodiment of the invention. In FIG. 11D, forwarding engines 1104A-C process and forwards aggregated traffic flows 1102A-C onto optical circuits 1110A-G to destination nodes 1112A-C as in FIG. 11A. Each incoming aggregated traffic flows 1102A-C comprises the same individual traffic flows as in FIG. 11A. Furthermore, traffic flows 1106A, 1106C and 1106E have a specified bandwidth BW₁, traffic flows 1106B, 1106D and 1106F have a specified bandwidth BW₂ and traffic flow 1106G has a specific bandwidth BW₃. In addition, optical circuit 1110A has bandwidth capacity 2×BW₁, while optical circuit 1110D has bandwidth capacity 2×BW₂.

Unlike in FIGS. 11A-C, forwarding engines 1104A-C forward traffic flows 1106A-G to optical circuits 1110A-G based on the specific bandwidth of the traffic flows and the capacity of the optical circuits. For example and by way of illustration, forwarding engines 1104A-B forward traffic flows 1106A and 1106C to optical circuit 1110A. However, optical circuit 1110A is fully allocated because optical circuit 1110A has a capacity of 2×BW₁. Thus, forwarding engine 1104C forwards traffic flow 1106E to optical circuit 1110C. Similarly, forwarding engines 1104A-B forward traffic flows 1106B and 1106D to optical circuit 1110D. However, optical circuit 1110D is fully allocated because optical circuit 1110A has a capacity of 2×BW₂. Thus, forwarding engine 1104C forwards traffic flow 1106F to optical circuit 1110F. In addition, forwarding engine 1104C forwards traffic flow 1106G to optical circuit 1110G. Thus, different embodiments may be implemented to perform optical circuit selection one or more different ways or combinations of ways (e.g., one or more of the exemplary ways in FIGS. 11A-D; and/or other ways).

### Organizing the Mapping of Traffic Flows and Providing Optical Protection

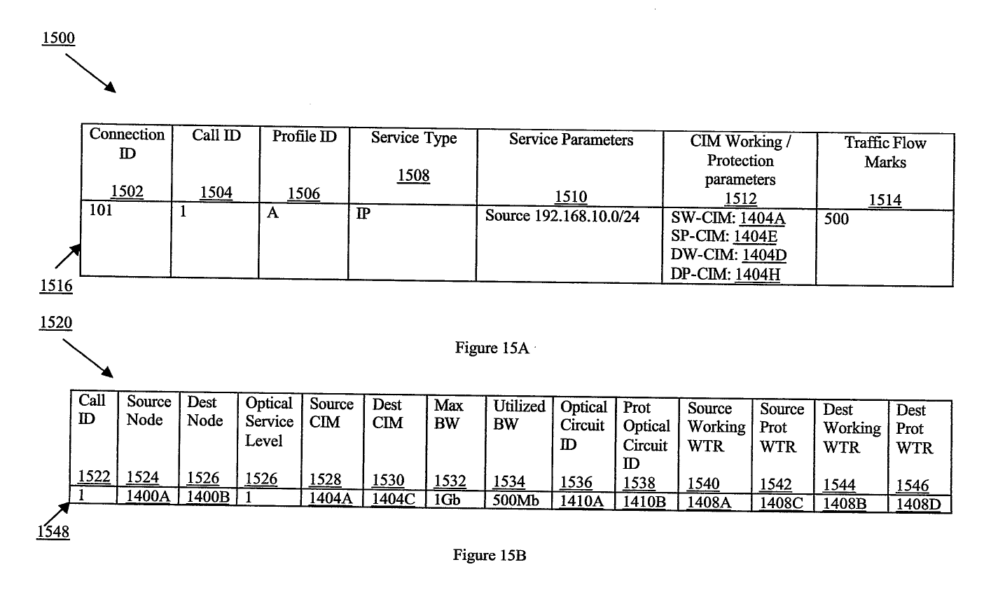

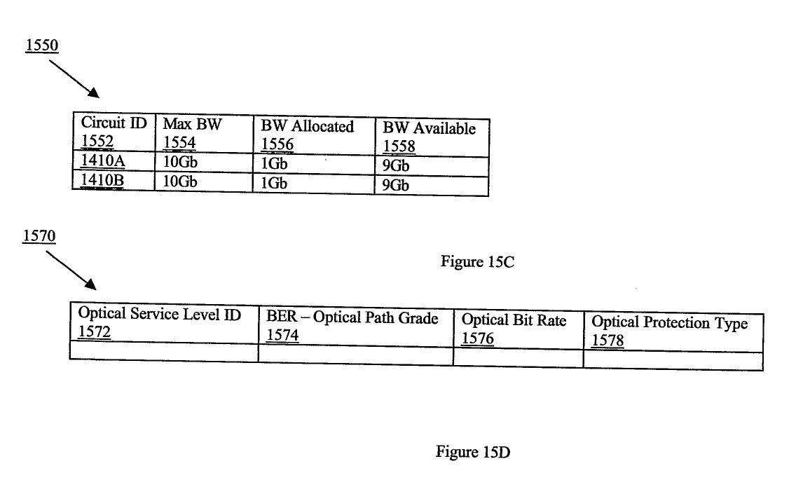

FIGS. 12A-B are block diagrams illustrating exemplary ways of organizing the mapping of traffic flows to optical circuits and providing traffic flow protection. FIG. 12A is a block diagram illustrating connections sharing calls and optical circuits according to one embodiment of the invention. Each optical circuit can support multiple calls, while each call supports multiple connections. While in the embodiment described below a connection is a traffic flow, in alternate embodiments each call may include a set of one or more connections. Thus, each DTSP maps incoming/outgoing traffic flows to connections, and maps the connections to calls, and maps the calls to optical circuits. In one embodiment, the mapping used by each DTSP is reflected in a set of configuration tables as illustrated in FIGS. 15 A-B, below.

In FIG. 12A, five traffic flows 1202A-E have destination 1218. Ports 1206A-D receive traffic flows 1202A-E. Optically aware aggregation switch 1206 processes incoming parts of traffic flows 1202A-E and maps them to five connections 1208A-E. In addition, optically aware aggregation switch 1206 maps and aggregates connections 1208A-E to calls 1210A-B. Optically aware aggregation switch 1206 maps connections 1208A, 1208C and 1208D to call 1210A and connections 1208B and 1208E to call 1210B. While FIG. 12A illustrates optically aware aggregation switch 1206 aggregating multiple connections to each call, alternate embodiments may map with different correspondence. Optically aware aggregation switch 1206 may map one connection to one call. Conversely, optically aware aggregation switch 1206 receives the incoming parts of calls 1210A-B coming from destination 1218 and separates calls 1210A-B into connections 1208A-E. Connections 1208A-E are sent through ports 1204A-D as outgoing parts of traffic flows 1202A-E.

In addition, optically aware aggregation switch 1206 protects calls 1210A-B. For example and by way of illustration, call 1210A and call 1210B are respectively 1+1 and 1:1 protected. Specifically, optically aware aggregation switch 1206 switches working call 1210A to optical circuit 1216A using call working flow 1212A. In addition, optically aware aggregation switch 1206 protects call 1210A by also switching in call 1210A to optical circuit 1216C using call 1+1 protecting flow 1212B. Because optically aware aggregation switch 1206 protects call 1210A using 1+1 protection, optically aware aggregation switch 1206 duplicates the traffic flows contained in call 1210A and forwards these flows to optical circuit 1216C. Furthermore, optically aware aggregation switch 1206 switches call 1210B to optical circuit 1216B (call working flow 1212A) and protects call 1210B using 1:1 protection with optical circuit 1216A (call 1+1 protecting flow 1212A). Thus, as illustrated, optically aware aggregation switch 1206 uses optical circuit 1216A for call working and protecting flows.

Consequently, optically aware aggregation switch 1206 aggregates call working flow 1212A and call protecting traffic flows 1214B to optical circuit 1216A. As illustrated, optical circuit 1216A carries five connections. Optical circuit 1216A bandwidth allocation 1220 illustrates an exemplary partition of the bandwidth by call and connection. At the call level, optical circuit 1216A bandwidth allocation 1220 shows an allocation for call 1210A bandwidth 1222A, call 1210B bandwidth 1222B, and unallocated bandwidth 1222C. At the connection level, call 1210A bandwidth 1222A is split between connection 1208A bandwidth 1224A, connection 1208C bandwidth 1224B, and connection 1208D bandwidth 1224C, with unused bandwidth 1224D allocated for call 1210A. Similarly, call 1210B bandwidth is split between connection 1208B bandwidth 1224A and connection 1208E bandwidth 1224B, with unused bandwidth 1226C allocated for call 1210B. While FIG. 12A illustrates unused bandwidth in optical circuit 1220 and unused bandwidth in both allocations 1222A and 1222B, this is by way of example (e.g. allocation may result in a single connection and call taking up all the optical circuit bandwidth, allocation may result in the connection(s) of a call taking up all bandwidth allocated for that call, allocation may result in multiple calls taking up all of the optical circuit bandwidth, etc.)

FIG. 12B is a block diagram illustrating call optical protection according to one embodiment of the invention. As in FIG. 12A, optically aware aggregation switch 1206 receives traffic flows 1202A-E through ports 1204A-D and maps traffic flows to connections 1208A-E. Furthermore, optically aware aggregation switch 1206 maps/aggregates connections 1208A-E to calls 1210A-B and switches the call working and protecting flows (1212A-B, 1214A-B) to optical circuits 1216A-C in the same manner as in FIG. 12A.

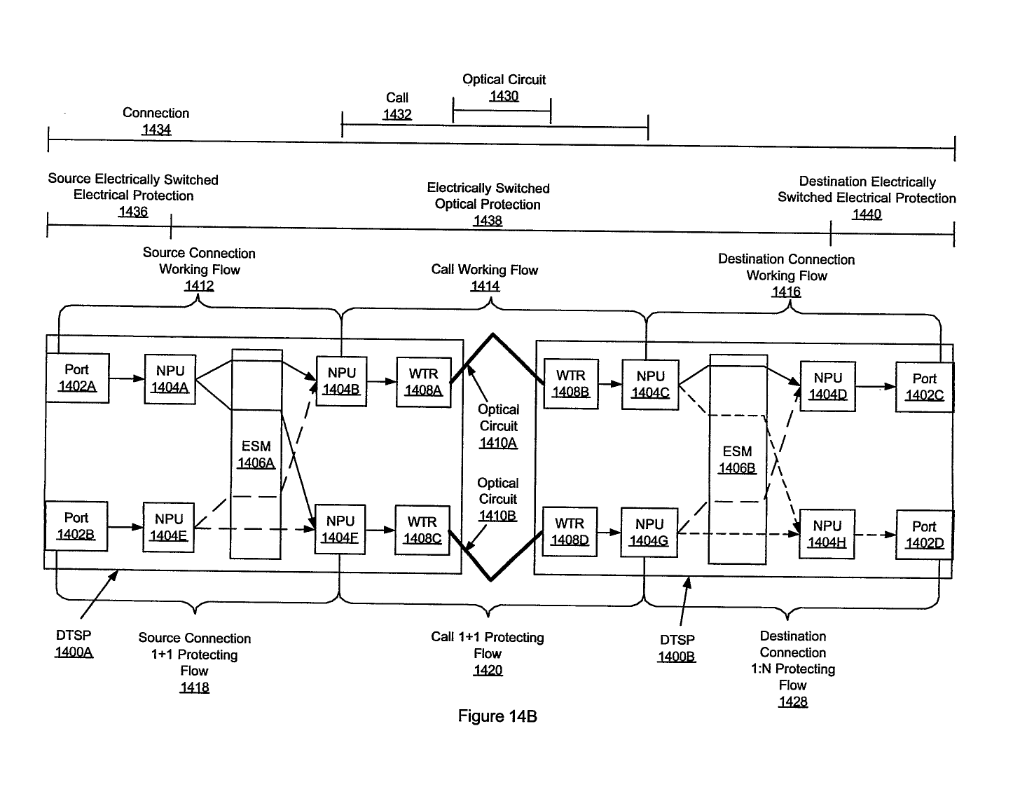

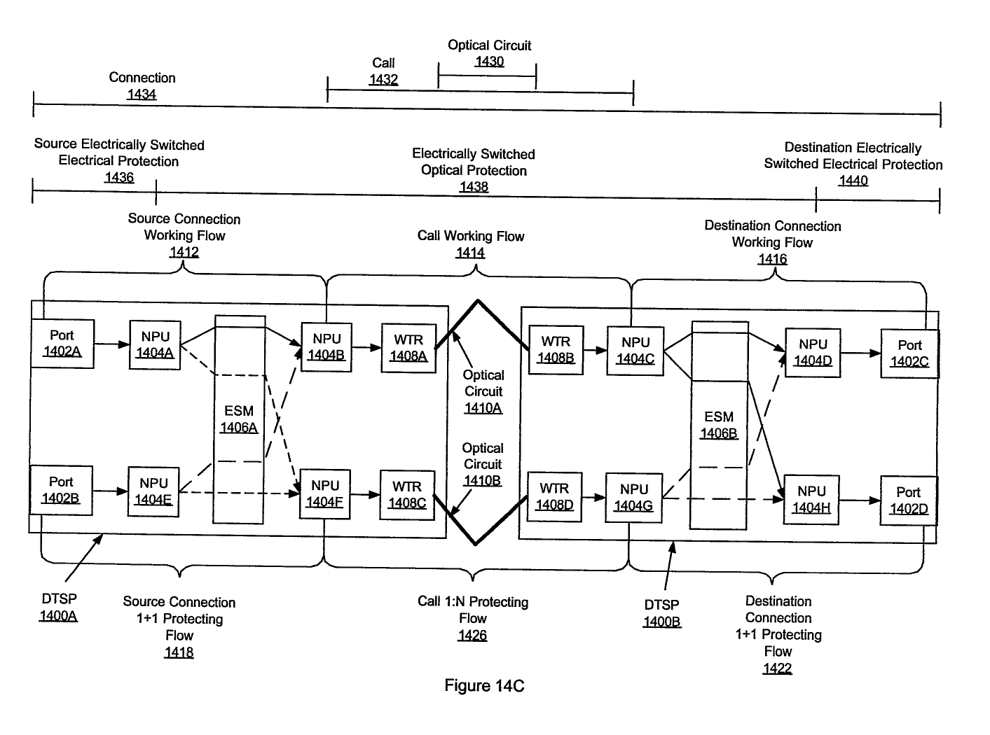

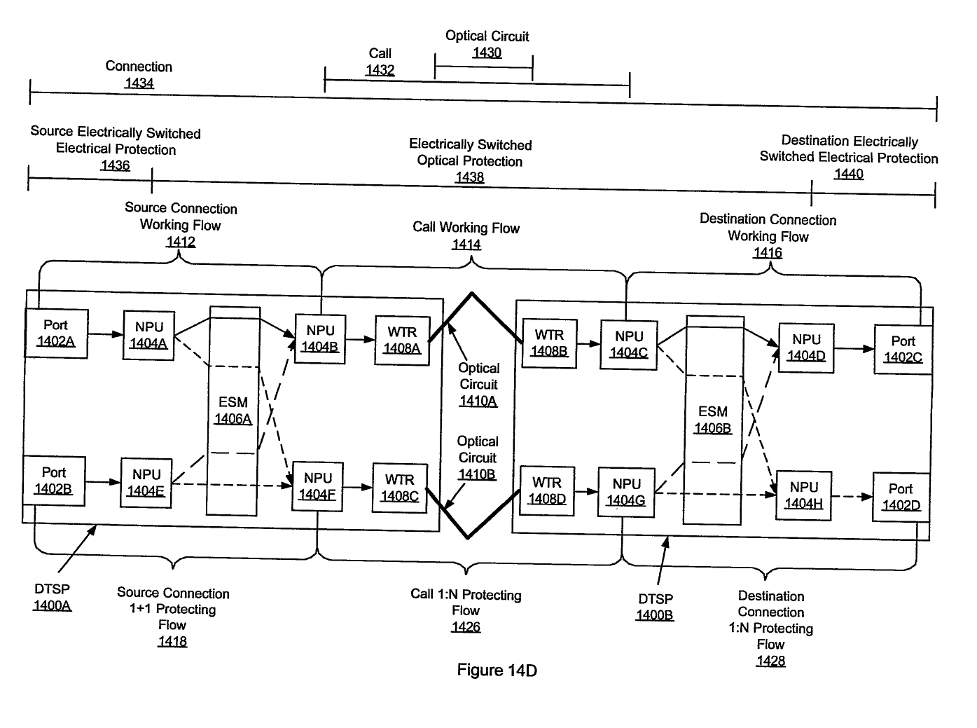

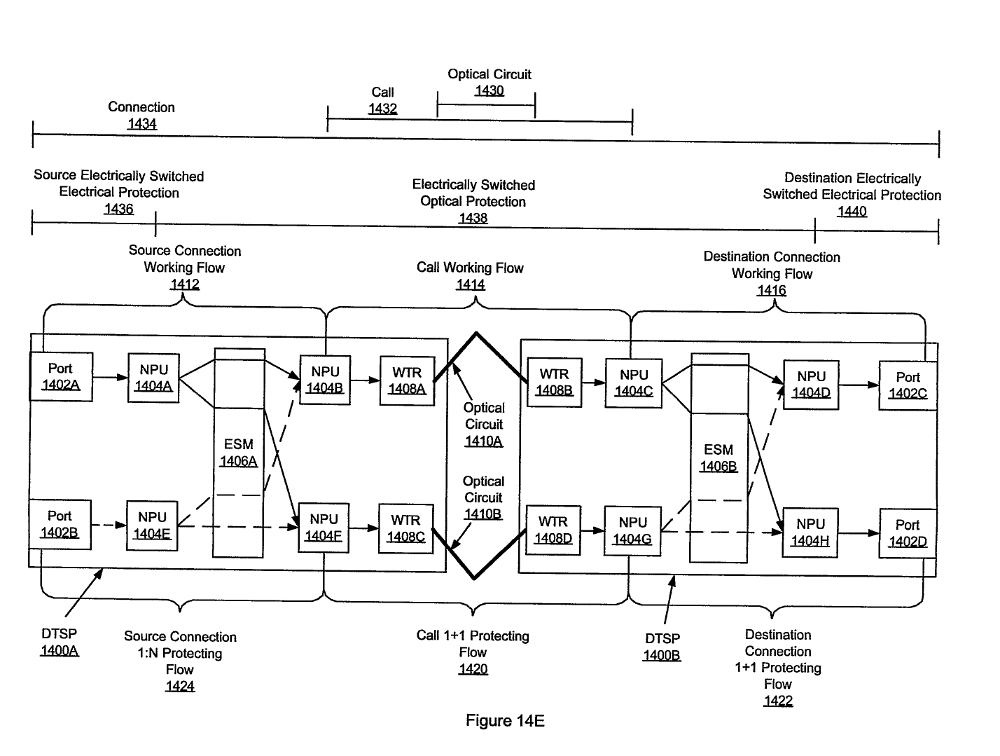

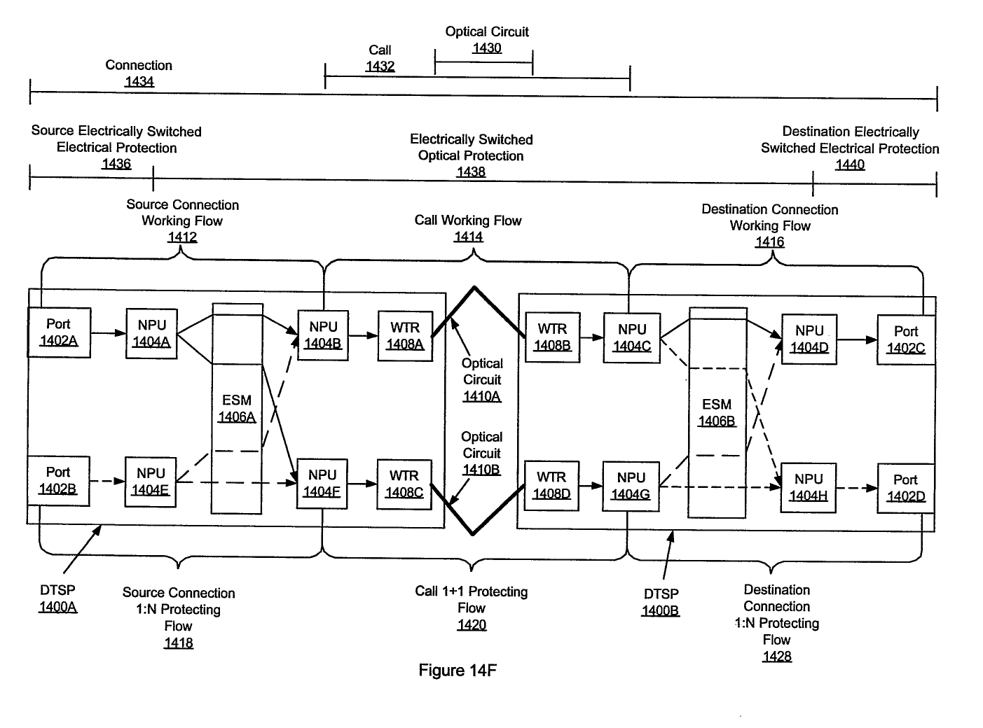

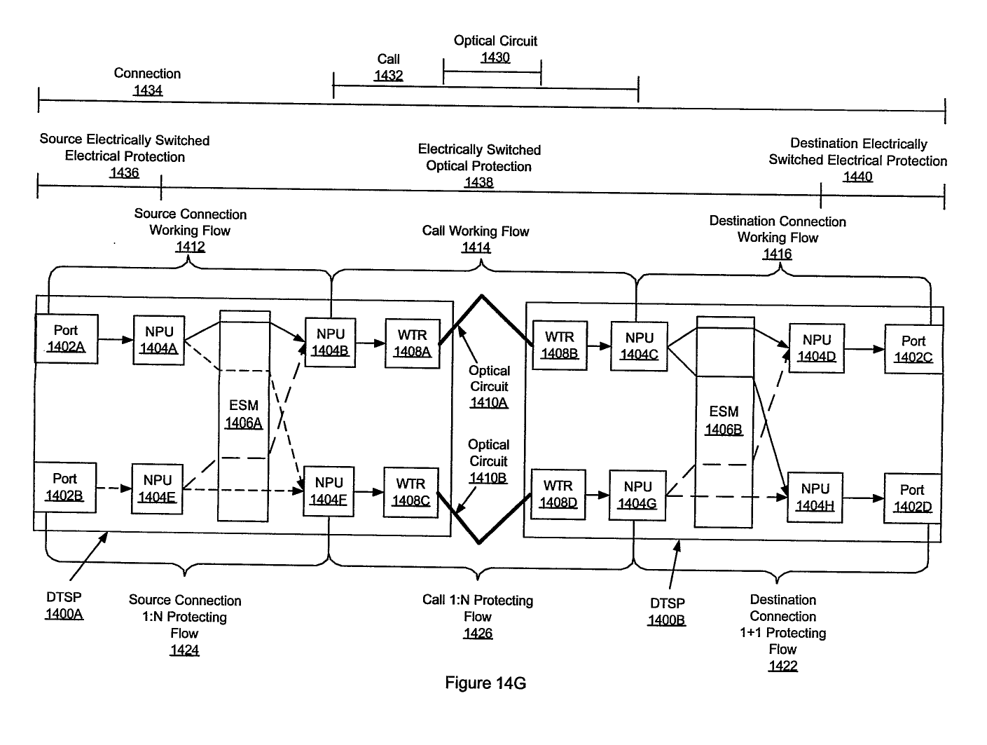

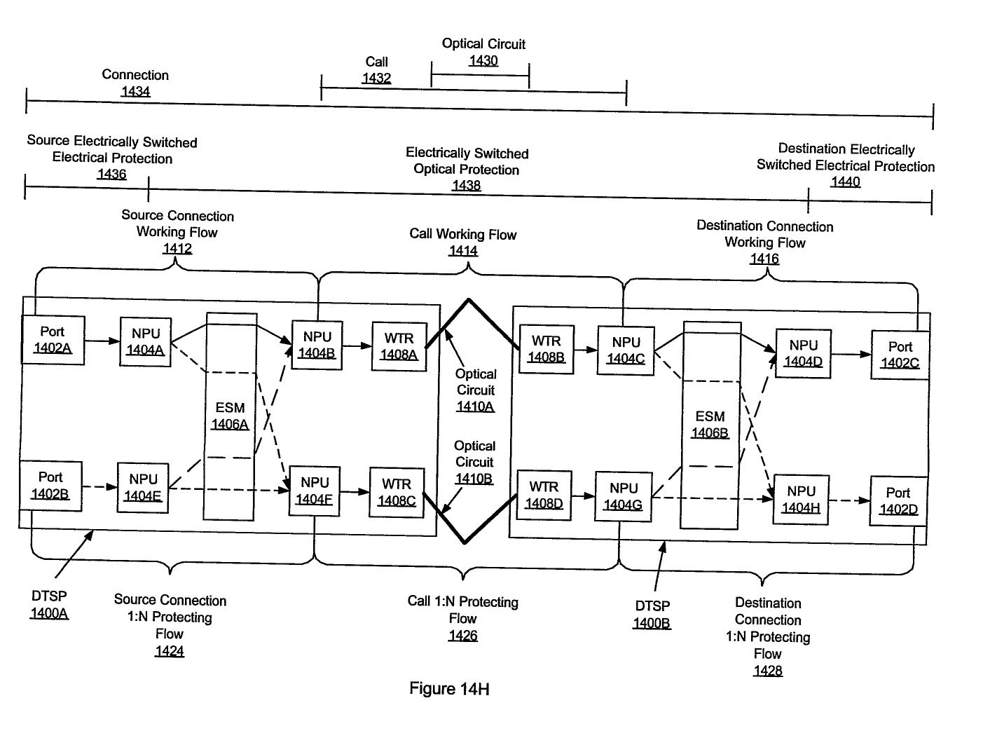

However, FIG. 12B further illustrates optically aware aggregation switch 1230 receiving the call working and protected flows (1232A-B, 1234A) transmitted on optical circuits 1216A-C. In FIG. 12B, optically aware aggregation switch 1230 receives flows associated with call 1210A (call working flow 1212A and call protecting flow 1212B) and flow associated with call 1210B (working call 1214A). In particular, optically aware aggregation switch 1230 receives two identical transmissions of the flow associated with call 1210A because optically aware aggregation switch 1206 protects call 1210A with 1+1 protection. However, only one transmission of call 1210B is forwarded. Thus, optically aware aggregation switch 1230 drops call protecting flow 1214B and forwards call working flow 1214A. Processing of protecting streams of packets (e.g. protecting flows, calls, etc.) is further described in FIGS. 14A-H. Optically aware aggregation switch 1230 separates the flows contained in received calls 1210A-B to connections 1208A-D. While in one embodiment the connections and calls are the same at source 1206 and destination optically aware aggregation switch 1230, alternate embodiments may have the different connections and/or calls at source 1206 and destination optically aware aggregation switch 1230.

In this embodiment, optically aware aggregation switch 1206 provides protection at the call level, not the connection level. This provides an extra level of flexibility because groups of connections (such as traffic flows) may be protected under one scheme by mapping groups of connections to one call. Alternatively, optically aware aggregation switch 1206 may protect a connection separately by mapping that connection to a unique call.

While embodiments are described illustrating exemplary ways of organizing the mapping of traffic flows onto optical circuits and providing traffic flow protection (e.g., traffic flows are mapped into connections, connections mapped into calls, calls mapped into optical circuits, and protection is at the call level), alternative embodiments may handle them differently (mapping traffic flows into calls and/or optical circuits, protecting at the connection level, protecting the optical circuits, etc.).

### Packet Marking

As mentioned above, DTSPs add and remove node internal and traffic flow marks to packets processed by the DTSP in certain embodiments of the invention. FIG. 13 is a block diagram illustrating the marks added to the data packets as the data packets traverse each DTSP node 1300A-B according to one embodiment of the invention. It is worth noting that FIG. 13 is a conceptual illustration of DTSPs and shows traffic flowing in a single direction to simplify explanation of the marks added and removed in one embodiment of the invention. Alternate embodiments may have traffic flowing in the opposite and/or different directions with the adding and/or removing of marks being performed in an analogous fashion. DTSP 1300A comprises NPU(s) 1302A-B, electrical switch module (ESM) 1304A, and WTR 1306A; while DTSP 1300B comprises NPU(s) 1302C-D, ESM 1304B, and WTR 1306B. NPU(s) 1302A-D couple to packet ports that face the electrically switched networks, whereas NPUs 1302B-C couple to WTRs 1306A-B, respectively. Furthermore, ESM 1304A and 1304B are coupled to NPU(s) 1302A-B and NPU(s) 1302C-D, respectively. In addition, WTR 1306A-B transmit/receive wavelength used by optical circuit 1306. ESMs 1304A-B switch packet processed by NPUs 1302A-D.

In FIG. 13, NPU(s) 1302A receives traffic flow(s) from the electrically switched network and adds marks 1310A to each packet in the traffic flow(s). Marks 1310A comprise a traffic flow mark 1312, node internal mark 1316A and other parameters 1314A. While in one embodiment, the node internal mark 1316A added by NPU(s) 1302A is a hardware dependent C6 mark used by ESM 1304A to switch packets received from NPU(s) 1302A, other embodiments may employ different or existing node internal marks (e.g., a node internal mark 1316A known in the art and/or developed in the future that signals ESM 1304A how to switch the packet, ESM using existing packet characteristics to appropriately switch the received packets, etc.).

In addition to the node internal mark 1316A, NPU(s) 1302A adds traffic flow mark 1312 to each received packet destined for optical circuit 1308. The traffic flow mark 1312 uniquely identifies each packet as part of a particular traffic flow (or equivalently, belonging to a connection in embodiments described) in the optically switched network. While in one embodiment NPU(s) 1302A adds a GMPLS label to each packet (with the GMPLS label corresponding to the traffic flow associated with the packet), alternate embodiments, may employ different marks (e.g. address associated with NPU(s) 1302D, IP address associated DTSP 1300B, client interface module (CIM) IP address, etc.) and/or combinations thereof.

Furthermore, NPU(s) 1302A adds additional parameters 1314A to each packet destined for optical circuit 1308. Examples of the parameters added by NPU(s) 1302A are, but not limited to, working egress client interface module port, working ingress WTR port, protect egress client interface, other control parameters as required, etc. These parameters are added so that when the traffic flows into WTR 1306B, the packet is marked with the proper destination CIM port(s).

ESM switches each packet based on node internal mark(s) 1316A, and NPU(s) 1302B removes node internal mark 1316A. Thus, node internal mark 1316A exists on the packet between NPUs 1302A and 1302B in timeline 1322A. Traffic flow mark 1312 remains on the packet. In addition, NPU(s) 1306B marks the packet with destination WTR 1318A. In this case, the mark added is associated with WTR 1306B. WTR 1306A transmits the packet with marks 1310B on optical circuit 1308 with WTR 1306B receiving this packet.

NPU(s) 1302C adds node internal mark(s) 1316B to packets received from WTR 1306B. Similar to above, node internal mark(s) can be, but not limited to, a hardware dependent C6 mark or some alternate mark used by ESM 1304B to properly switch the packets. Although in one embodiment ingress/egress ESM port addresses, the CIM address and WTR address are part of the node internal mark, alternate embodiments may have more, less and/or different marks (e.g. any additional control parameters) In addition, NPU(s) 1302C removes destination WTR mark 1318A from the packets. Finally, NPU(s) 1302D removes node internal mark(s) 1316B and traffic flow mark 1312. Thus, traffic flow mark 1312 exists on the packet between NPUs 1302A and 1302D as illustrated in timeline 1320; while node internal mark 1316B exists on the packet between NPUs 1302C and 1302D as illustrated in timeline 1322B. Although in one embodiment, NPU(s) 1302D adds parameters 1314B such as, but not limited to, CIM port, alternate embodiments have NPU(s) 1302D performing more, less and/or different operation (e.g., not adding the additional parameters, converting the traffic flow mark to an MPLS label, etc.). Conversely, node internal and traffic flow marks are added/removed in a similar fashion for packets traveling from NPU(s) 1302D to NPU(s) 1302A.

While embodiments are described in which packets in traffic flows are marked with node internal and traffic flow marks, alternative embodiments may mark packets in traffic flows differently (e.g., use traffic flow mark, but not node internal mark; use existing packet marks, etc.).

### Traffic Flow Protection

FIGS. 14A-H are block diagrams illustrating call and connection protection processing schemes for traffic flows performed by NPUs in an exemplary node architecture according to one embodiment of the invention. Specifically, FIGS. 14A-H illustrates different protection schemes that can be employed for one traffic flow in one connection transmitted between a source DTSP 1400A and destination DTSP 1400B. Again, it is worth noting that FIGS. 14A-H are conceptual illustrations of DTSPs and shows traffic flow in one direction to simply explanation of the exemplary protection processing schemes. In addition, FIGS. 14A-H illustrate not only electrically switched optical protection, but also protection toward the electrically switched network, as well as the interaction thereof between for different exemplary types of protection. DTSP 1400A comprise ports 1402A-B coupled to NPU 1404A and 1404E, respectively; with NPUs 1404A, 1404E coupled to ESM 1406A; ESM 1406A further couples to NPUs 1404B, 1404F, with NPUs 1404B, 1404F coupled to WTRs 1408A, 1408C, respectively. Furthermore, WTRs 1408A-B couple to optical circuit 1410A and WTRs 1408C-D couple to optical circuit 1410B. DTSP 1400B comprises WTR 1408B, 1408D coupled to NPUs 104C, 1404G, respectively; with NPUs 104C, 1404G coupled to ESM 1406B; ESM 1406B couples to NPUs 1404D, 1404H which in turn couple to ports 1402C-D.

A source external to DTSP 1400A transmits a traffic flow to a destination external to DTSP 1400B over optical circuits 1410A and 1410B (if necessary) between DTSPs 1400A-B. FIGS. 14A-H illustrate different protection schemes employed between: 1) the source and DTSP 1400A (1+1 in FIGS. 14A-D; 1:N in FIGS. 14E-H); 2) DTSP 1400A and DTSP 1400B (1+1 in FIGS. 14A, 14B, 14E, and 14F; 1:N in FIGS. 14C, 14D, 14G, and 14H); and 3) DTSP 1400B and the destination (1+1 in FIGS. 14A, 14C, 14E, and 14G; 1:N in FIGS. 14B, 14D, 14F, and 14H). The traffic flows to the source DTSP 1400A and destination DTSP 1400B are referred to as the source connection working flow, source connection protecting flow, destination connection working flow, and destination connection protecting flow.

In FIGS. 14A-H, connection 1434 is configured end-to-end between DTSP 1400A and 1400B. DTSPs 1400A-B organize connection 1434 (and possibly other connections) into call 1432. A call is an organizational mechanism to group like protected connections. Alternate embodiments may be utilized to not use calls, but provide electrically switched optical protection by mapping connections to optical circuits directly. Call 1432 exists between the NPUs adjacent to the WTR (i.e. NPUs 1404B-C and 1404F-G) and utilizes the optical circuits 1410A-B. WTR pairs 1408A-B and 1404C-D terminate optical circuits 1410A-B, respectively (as further illustrated by the optical circuit timeline 1430). Optical circuits 1410A-B represent the all-optical connection between DTSPs 1400A-B. Not shown in FIGS. 14A-H is the detail of the all-optical network that includes, but not limited to, optical switches, optical light paths, optical amplifiers, etc. Also not shown in FIGS. 14A-H is the optical switch part of DTSPs 1400A-B as illustrated in FIGS. 8A-C.

DTSPs 1400A-B offer three basic realms of protections for traffic flows: electrically switched electrical protection, electrically switched optical protection, and optically switched optical protection. Electrically switched electrical protections protects traffic flows in the electrically switched domain using connection working and protecting flows at source and destination DTSPs 1400A-B, respectively. As shown below, electrically switched electrical protection may employ the same or different protection schemes at the source and destination DTSPs 1400A-B (i.e., 1+1 protection scheme at both DTSP 1400A-B; 1:N protection scheme at both DTSP 1400A-B; 1+1 protection scheme at source DTSP 1400A, 1:N protection scheme at DTSP 1400B, or visa versa; etc.). Electrically switched electrical protection runs between the ports receiving/transmitting the traffic flows and the NPUs adjacent to the ports (e.g. source electrically switched electrically protection 1436 is between ports 1402A-B and NPUs 1404A, 1404E, while destination electrically switched electrically protection 1440 is between ports 1402A-B and NPUs 1404D, 1404H).

Electrically switched optical protection protects traffic flows on working optical circuits in the optical domain by electrically switching the traffic flows to different protecting optical circuits. Electrically switched optical protection runs between the NPUs in the source/destination DTSP 1400A-B that are adjacent to the ports. For example, electrically switched optical protection 1438 runs between NPU pairs 1404A, 1404E and 1404D, 1404H. Electrically switched optical protection may employ one of the know protection schemes in the art (e.g., 1+1, 1:1, 1:N, optical re-routable, unprotected, etc.). While in one embodiment, DTSPs 1400A-B protect traffic flows using electrically switched optical protection by organizing connections into calls and protecting at the call level, alternate embodiments may protect traffic flows with different granularity (e.g. protect at the connection level, optical circuit level, etc.).

Not shown in FIGS. 14A-H is optically switched optically protection. This protects optical circuits by optically switching traffic to be carried on working optical circuits to protecting optical circuits if the working optical circuits are unavailable. Optically switched optically protection is further described in U.S. patent application Ser. No. 11/060,562, entitled “Method and Apparatuses for Handling Multiple Failures in an Optical Network”. In one embodiment, DTSPs 1400A-B use optically switched optical for alien wavelength. An alien wavelength is a DWDM wavelength that enters the DTSP 1400A-C from a L2/L3 device from an electrically switched network (e.g., see L2/L3 Device 302C in FIG. 3A, above).

Source connection working flow 1412 comprises the traffic flow received on port 1402A. NPU 1404A processes source connection working flow 1412 and ESM 1406A switches source connection working flow 1412 to NPU 1404B. NPU 1404B maps source connection working flow 1412 to call working flow 1414. WTR 1408A transmits call working flow 1414 on optical circuit 1410A, which is received by WTR 1408B. NPU 1404C processes the traffic flow in call working flow 1414 and ESM 1406B switches the traffic flow to NPU 1404D. NPU 1404D separates destination connection working flow 1416 from call working flow 1414 and forwards destination connection working flow 1416 to port 1402C.

In FIG. 14A, DTSPs 1400A-B protects source connection working flow 1412, call working flow 1414 and destination connection working flow 1416 using 1+1 protection. For example and by way of illustration, DTSP 1400A protects source connection working flow 1412 with source connection 1+1 protecting flow 1418. Source connection 1+1 protecting flow 1418 enters on port 1402B. If working source connection working flow 1412 is available, NPU 1404E drops source connection 1+1 protecting flow 1418, because NPU 1404A forwards source connection working flow 1412 to both NPU 1404B and 1404F; and the second connection is not required past NPU 1404E. On the other hand, if source connection working flow 1412 is unavailable, NPU 1404E forwards source connection 1+1 protecting flow 1418 to both NPU 1404B and NPU 1404F.

In addition, DTSPs 1400A-B protects call working flow 1414 with call 1+1 protecting flow 1420. Through receipt of either source connection working flow 1412 or source connection 1+1 protection flow 1418 by NPU 1404F, WTR 1408C transmits call 1+1 protecting flow 1420 over optical circuit 1410B to WTR 1408D. NPU 1404G receives the flow in call 1+1 protecting flow 1420 and either drops the duplicated flow or forwards the flow to NPU 1404D and 1404A via ESM 1406B. The decision to drop or forward the duplicated flow depends on the availability of call working flow 1414. If call working flow 1414 is available, NPU 1404G drops the duplicated flow. However, if call working flow 1414 is unavailable, NPU 1404G forwards the duplicated flow via ESM 1406B to NPU 1404D.

Furthermore, system 1400 protects working destination connection working flow 1416 with destination connection 1+1 protecting flow 1422. With this scheme, if call working flow 1414 is available, NPU 1404C duplicates the traffic flow in call working flow 1414, where ESM 1406B switches the duplicated flow to NPU 1404H. If call working flow 1414 is not available, NPU 1404G duplicates the traffic flow in call 1+1 protecting flow 1420, where ESM 1406 switches the duplicated traffic flow to both NPU 1404D and 1404H; NPU 1404D and 1404H forward the duplicated flow in destination connection 1+1 protecting flow to ports 1402C and 1402D, respectively. In either case, NPU 1404D and 1404H forwards the received flows in destination connection 1+1 protecting flow 1422 to ports 1404C and 1402D, respectively.

In FIG. 14B, system 1400 protects source connection working flow 1412 and call working flow 1414 using 1+1 protection as in FIG. 14A. However, system 1400 protects working destination connection working flow 1416 using 1:N protection with destination connection 1:N protecting flow 1428. In this scheme, NPU 1404C directs the traffic flow in working destination connection working flow 1416 to destination connection 1:N protecting flow 1428 (via NPU 1404H and port 1402D) if working destination connection working flow 1416 is unavailable.

In FIG. 14C, system 1400 protects source connection working flow 1412 and destination connection working flow 1416 with 1+1 protection as illustrated in FIG. 14A. In addition, system 1400 protects call working flow 1414 using 1:N protection with call 1:N protecting flow 1426. In this scheme, NPU 1404A directs the traffic flow in call working flow 1414 to WTR1408C/optical circuit 1410B (via ESM 1406A and NPU 1404F) if working call is unavailable. Otherwise, NPU 1404A directs the traffic flow in call working flow 1414 to WTR1408B/optical circuit 1410A.

In FIG. 14D, system 1400 protects source connection working flow 1412 using 1+1 protection as in FIG. 14A while protecting call working flow 1414 and working destination connection working flow 1416 using 1:N protection as in FIG. 14C and FIG. 14B, respectively.

In FIG. 14E, system protects call working flow 1414 and working destination connection working flow 1416 as in FIG. 14A, but protects working source connection working flow 1412 using 1:N protection. In this scheme, source connection 1:N protecting flow 1424 enters on port 1402B. However, if working source connection working flow 1412 is available, NPU 1404E drops source connection 1:N protecting flow 1424, because the second connection is not required past NPU 1404E. On the other hand, if working source connection working flow 1412 is unavailable, NPU 1404E forwards source 1:N protection connection 1418 to NPU 1404B.

In FIG. 14F, system 1400 protects working source connection working flow 1412 and working destination connection working flow 1416 using 1:N protection as in FIGS. 14E and 14B, respectively. Furthermore, system 1400 protects call working flow 1414 using 1+1 protection as in FIG. 14A.

In FIG. 14G, system 1400 protects working source connection working flow 1412 and call working flow 1414 using 1:N protection as in FIGS. 14E and 14C, respectively. Furthermore, system 1400 protects working destination connection working flow 1416 using 1+1 protection as in FIG. 14A.

In FIG. 14H, system 1400 protects working source connection working flow 1412, call working flow 1414, and working destination connection working flow 1416 using 1:N protection as in FIG. 14E, 14C, and 14B, respectively.

While embodiments are described illustrating connections and calls protected with l+1/1:N protection schemes, alternative embodiments may offer connections/calls different, some and/or no protection (e.g., offer connections/calls different protection schemes, protecting the call but not the connections, protecting the connections but not the call, protecting one or none of the connections, etc.).

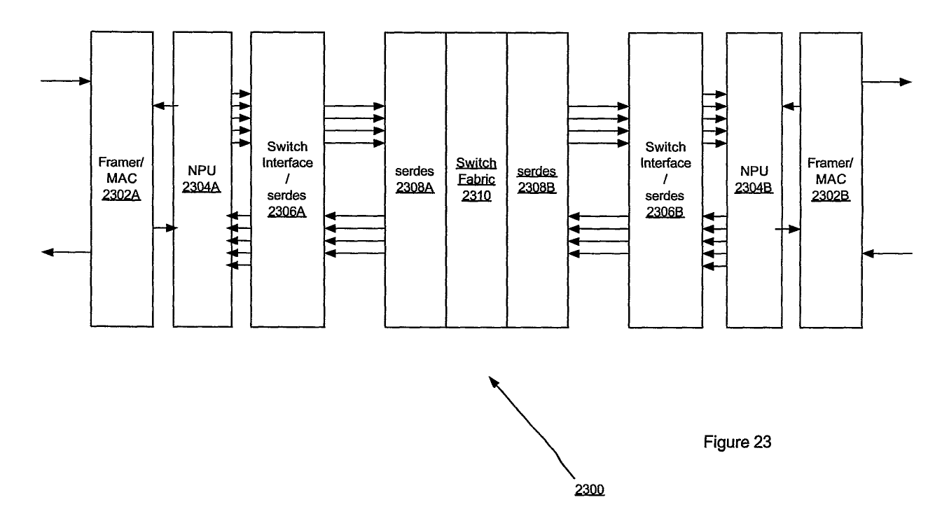

FIGS. 23A-H are exemplary tables of protection schemes according to one embodiment of the invention.

### Configuration Data

FIGS. 15A-D are exemplary tables of configuration data used to configure DTSP that support connections, calls and optical service levels according to one embodiment of the invention. DTSPs use the configuration data to configure connections, calls, optical circuits and optical service levels as illustrated in previous Figures. In FIGS. 15A-B, configuration data for connections 1500 and calls 1520 are illustrated, respectively, according to one embodiment. Connection configuration table 1500 comprises a connection ID 1502, call ID 1504, profile ID 1506, service type 1508, service parameters 1510, CIM working/protection parameters 1512 and traffic flow mark 1514. Connection ID 1502 is a optically switched network-wide unique ID assigned to each connection. Thus, a given traffic flow has the same connection ID on both the source and destination DTSP nodes. Each source and destination node DTSP processing the connection maps the connection to the call identified in Call ID 1504. Call ID 1504 refers to an entry in Call configure table 1520, indexed by Call ID 1548. As mentioned below, Call ID 1504 is a network-wide unique ID assigned to each call. Similar to connection ID, a call has the same ID on the end nodes and intermediate nodes terminating/switching the optical circuit associated with the call.

Profile ID 1506 is the traffic shaping parameters associated with the connection. In an exemplary embodiment, profile ID identifies traffic policing parameters that are well known in the art and/or developed in the future. Referring back to FIG. 10, queues 1008A-L use traffic policing parameters to mark packets that are out of profile for later dropping. Examples of traffic policing parameters are, but not limited to: the CIR (committed information rate), PIR (peak information rate), constant burst rate (CBR), PBR (peak burst rate), etc. While in one embodiment, the CIR is the connection maximum bandwidth, in alternate embodiments the connection maximum bandwidth is another parameters (e.g., PIR, etc.). Alternatively, the profile ID parameters are rate limiting parameters. In this embodiment, the profile ID parameters uses the same parameters as the traffic policing parameters, but a DTSP node drops packets that are out of profile instead of marking the packets. In addition, while in one embodiment, the profile ID is an index to table of traffic shaping/policing settings, other embodiments may have different types of profile IDs (e.g., traffic shaping/policing parameters as the profile ID value, etc.).

Returning back to FIG. 15A, service type 1508 and service parameters 1510 are parameters that identify packet characteristics of the packets contained in the traffic flow. Service type 1508 identifies the type of packet in the connection. Examples of service type are, but not limited to: IP, MPLS, VLAN, Ethernet, ATM, etc. In conjunction with service type, service parameters 1510 identify the service type 1508 characteristics of the packets in the connection. For examples, service characteristics 1510 can be, but not limited to, IP source/destination (with or without a netmask), IP source port, IP destination port, MPLS tag, VLAN tag, MAC source address, MAC destination address, DSCP bit, ATM virtual circuit information (VCI)/virtual path information (VPI), combinations thereof, etc.

CIM working and protection parameters 1512 identify the working/protecting source and destination client interface module (CIM). Each connection has a source and destination CIM on the corresponding source/destination DTSP. Furthermore, a connection may be protected at the source and/or destination DTSP using the appropriate CIM. For example and by the way of illustration, referring to FIG. 14A, source/destination CIM (as represented by NPU 1404E, 1404D, respectively) protect connection 1412/1416 using a 1+1 protection scheme. Alternate embodiments may use other protection scheme, such as, 1:N, optical reroutable, unprotected, etc.

Finally, traffic flow mark 1514 is the traffic flow mark added to each packet in the connection as illustrated in FIG. 13. As described above, the traffic flow mark 1514 can be, but not limited to, GMPLS label, shelf/row/slot/port of destination working CIM, or any equivalent network wide unique ID known in the art and/or developed in the future.

By way of example according to one embodiment, FIG. 15A illustrates, a sample connection configuration table entry 1516 having a connection D equal to 101, call ID equal to 1 and profile ID of 2. The connection comprises IP packets (i.e., service type IP) having source IP address from the network 192.168.10.0/24 (i.e., service parameter “source IP, 192.168.10.0/24”). Referring to FIG. 14A, the CIM working/protection parameters are (with the NPUs 1404A, 1404D, 1404E and 1404H representing the CIMs): (1) source working CIM 1404A, (2) source protecting CIM 1404E, (3) destination working CIM 1404D and (4) destination protecting CIM 1404H.

FIG. 15B illustrates one embodiment of call configuration table 1520. Call configuration table 1520 comprises call ID 1522, source node 1524, destination node 1526, optical service level 1526, source CIM 1528, destination CIM 1530, maximum call bandwidth 1532, utilized bandwidth 1534, optical circuit 1536, protecting optical circuit 1538, source working VWTR 1540, source protecting WTR 1542, destination working WTR 1544, and destination protecting WTR 1546.

Call ID 1502 is a network-wide unique ID assigned to each call, where the ID is unique throughout the optically switched network. Thus, a call has the same call ID on both the source 1524 and destination 1526 DTSP nodes. Within each source 1524 and destination 1526 DTSP node, a call is mapped to a source 1528 and destination 1530 CIM, respectively. In addition, a call is assigned to a source 1540 and destination 1544 working WTRs, where the source 1540 and destination 1544 working WTRs terminate the optical circuit the call uses for the call working flow. Similarly, if the call is protected, the call is associated with a source 1542 and destination 1546 protecting WTR terminate the optical circuit the call uses for the call protecting flow.

As mentioned above, each call is associated with a working optical circuit, and possibly, a protecting optical circuit. These optical circuits are identified in the call configuration table with working optical circuit ID 1536 and protecting circuit ID 1538. Furthermore, each call is associated to an optical service level 1526. While in one embodiment, the optical service level contains the minimum bit error rate and bit rate desired for the call, alternate embodiments may have additional, less and/or different optical service level parameters. In addition, for example and by way of illustration, two calls sharing the same optical circuit have the same optical service level. Furthermore, each call has a maximum bandwidth 1532. The call's maximum bandwidth 1532 represents the maximum amount of connection bandwidth that can be allocated from the call. The maximum bandwidth 1532 is allocated from each optical circuit (working and protecting) as illustrated in FIG. 12. From the maximum bandwidth, the call utilizes bandwidth 1534 for the connections mapped onto the call. The utilized bandwidth 1534 is typically less than or equal to the maximum bandwidth 1532.

By way of example and according to one embodiment, FIG. 15B illustrates a sample a call configuration table entry 1548. Using entities from FIG. 14A as a reference network, call configuration table entry 1548 has call ID 1, with source DTSP node 1400A and destination DTSP node 1400B. Within source DTSP node 1400A, call entry 1548 uses source CIM 1404A, source working WTR 1408A and source protecting WTR 1408C. From destination DTSP 1400B, call entry 1548 uses destination CIM 1404C, destination working WTR 1408B and destination protecting WTR 1408D. Between source DTSP 1400A and destination DTSP 1400B, the call is mapped onto working optical circuit 1410A and protecting optical circuit 1410B. From each of the optical circuits, the call is allocated a maximum bandwidth of one gigabit per second of traffic (Gbps). The call utilizes half of the maximum allocated bandwidth (500 megabits per second (Mbps)). In addition, the call has optical service level 1.

FIGS. 15C-D are exemplary tables of optical circuit configuration data according to one embodiment of the invention. In FIGS. 15C-D, configuration data for optical circuit bandwidth 1550 and optical service levels 1570 is illustrated, respectively, according to one embodiment. Optical circuit bandwidth table 1550 comprises circuit ID 1552, maximum bandwidth 1554, bandwidth allocated 1556 and bandwidth available 1558. Optical circuit ID 1552 is an optically switched network-wide unique ID assigned for each optical circuit. Each optical circuit has a maximum bandwidth 1556. One optical circuit occupies one wavelength on each fiber of the path. While in one embodiment an optical circuit may be 2.5 Gbps or 10.0 Gbps, other embodiments may support more, less, and/or different bandwidths. Alternatively, the optical circuit can have some other bandwidth. Furthermore, each optical circuit has an allocated bandwidth 1556 and available bandwidth 1558. Allocated bandwidth 1556 is the amount of bandwidth allocated to calls maps to the optical circuit. Conversely, available bandwidth 1558 is the amount bandwidth available on the optical circuit. As an example, for the two optical circuits illustrated 1408A-B in call configuration table 1520, each optical circuit 1408A-B may have entry 1562A-B, respectively, in table 1520 where the optical circuit bandwidth is ten Gbps, an allocated bandwidth of one Gbps and an available bandwidth of nine Gbps.

Finally, FIG. 15D illustrates one embodiment of optical service level 1570. Optical service level table 1570 comprises optical service level ID 1572, bit rate error (BER)—optical path grade 1574, optical bit rate 1576, and optical protection type 1578. Optical service level ID 1572 is the optically switched network-wide unique ID for the optical service level. BER-optical path grade 1574 differentiate between various optical path qualities. Optical bit rate 1576 is the bit rate of the optical circuit (in the above discussed embodiment, 2.5 or 10.0 Gbps). The combination of BER 1574 and optical bit rate determines the maximum allowable noise on each optical circuit. Finally, optical protection type 1578 is the optically switched optical scheme for the optical circuit. The optical protection scheme differs from the electrically switch optical protection scheme in that the optically switched optical protection protects optical circuits and is a slower fail over protection scheme. Examples of optically switched optical protection schemes are, but not limited to, 1+1, 1:1, 1: N, fast reroutable, unprotected, etc. While in one embodiment uses BER, optical bit rate, and optical protection, alternate embodiments may use more, less, or different requirements (e.g., signal distortion, no optical protection, etc.).

While embodiments are described in which configuration data is organized in a particular arrangement of tables, alternative embodiments may organize the same or different configuration data in the same or different tables (e.g., organized service name and parameters into a separate table, organize profile ID parameters into a separate table, etc.).

### Provisioning

FIG. 16 is an exemplary flow diagram for provisioning traffic flow according to one embodiment of the invention. In FIG. 16, at block 1602, method 1600 receives a request for a traffic flow. The traffic flow request comprises packet classification characteristics, client, destination, service level and bandwidth. Packet classification characteristics are the type of packets comprising the traffic flows. Examples of packet classification characteristics are, but not limited to, IP source, IP destination, IP source port, IP destination port, MPLS tag, VLAN tag, MAC source address, MAC destination address, DSCP bit, ATM virtual circuit information (VCI)/virtual path information (VPI), combinations thereof, etc. The client is the person, business, service provider, etc., that originates the traffic flow and the entities requesting allocation of network resources for the traffic flow. Destination is the ultimate destination of the traffic flow. While in one embodiment, an IP address is the destination, other embodiments may express destination as destination DTSP node, MPLS tag, etc. Optical service level is one of the optical service levels supported by the optically switched network as illustrated in FIG. 15B. Finally, bandwidth is the to be allocated for the traffic flow.

At block 1604, method 1600 determines if one or more of the existing calls has the same destination as the requested traffic flow. If there are existing calls that have the same destination, at block 1606, method determines if one or more of these calls can support the characteristics of the requested traffic flow. For example and by way of illustration, does the call have enough bandwidth for the traffic flow, the correct protection type, and/or use an optical circuit with the correct optical service level? If so, method 1600 selects one of these calls for the traffic flow at block 1608 and control passes to block 1610. If not, control passes from block 1606 to block 1616.

Returning to block 1604, if there is not a call having the same destination as the traffic flow, at block 1616, method 1600 determines is there are one or more optical circuits having the same destination as the traffic flow. If so, at block 1626, method 1600 determines if one or more of the optical circuits having the same destination have enough bandwidth to support the traffic flow. If there are optical circuit(s) with enough bandwidth to support the traffic flow, at block 1622, method 1600 sets up a call on the selected optical circuit(s) for the traffic flow on the source and destination DTSP nodes. Method 1600 sets up the call by adding an entry in table 1520 as illustrated in FIG. 15, based on the traffic flow requested and the selected optical circuit(s). For example, referring to FIG. 15A by way of illustration, method 1600 adds entries for the source 1524 and destination 1526 DTSP nodes; optical service level reference 1528; source CIM 1528; destination CIM 1530; working optical circuit ID 1536; protecting optical circuit ID 1538 (if needed); source working WTR 1540; destination working WTR 1544; source protection WTR 1542 (if needed) and destination protecting WTR 1546 (if needed) from the corresponding selected optical circuit(s). Furthermore, method 1600 assigns a call ID 1522 to the newly setup call. While in one embodiment method 1600 setups a call that matches the traffic flow bandwidth, in other embodiments method 1600 allocates the call with bandwidth greater than required for the traffic flow (e.g., allocate a percentage greater to accommodate this and possible future traffic flows in the same call, etc.). For example and by way of illustration, if method 1600 provisions a new call for a traffic flow requiring a bandwidth of one Gbps on an optical circuit with nine Gbps available bandwidth, method 1600 may allocate between one and nine Gbps for the new call. At block 1624, method 1600 determines whether the call setup succeeded. If so, control passes to block 1610. If the provisioning did not succeed, method 1600 takes alternate action at block 1628.

Returning to block 1616, if there are no optical circuits with the same destination as the traffic flow, at block 1618, method 1600 provisions optical circuit(s) for the traffic flow. While in one embodiment provisioning an optical circuit adds an entry in table 1550 as illustrated in FIG. 15 in each DTSP node associated with the optical circuit, other embodiment may provision optical circuits using different schemes (e.g., see U.S. patent application Ser. No. 10/754,931, entitled “Method and Apparatus for a Network Database in an Optical Network”, etc.). At block 1620, method 1600 determines if the optical circuit(s) provisioning succeeds. If so, at block 1622, method 1600 setups a call on the newly provisioned optical circuit(s) for the traffic flow on the source and destination DTSP nodes. At block 1624, method 1600 determines whether the call setup succeeded. If so, control passes to block 1610. If the provisioning did not succeed, method 1600 takes alternate action at block 1628.

At block 1610, method 1600 setups up the connections on the source and destination DTSP nodes. In one embodiment, method 1600 sets up the connection by adding an entry to table 1500 as illustrated in FIG. 15. For example and by way of illustration, method 1600 assigns the connection ID 1502, sets the call ID 1504 associated with the call that the connection maps to, sets the profile ID 1508, adds the service type 1508 and service parameters 1510 associated with the traffic flow, the CIM working/protecting parameters 1512 and appropriate traffic flow marks 1514. At block 1612, method 1600 determines whether the connection setup succeeded. If so, at block 1614, method 1600 commits the bandwidth of the calls. In one embodiment, method 1600 updates the utilized bandwidth 1534 for the call in table 1520. If the connection did not succeed, at block 1628, method 1600 takes alternate action.

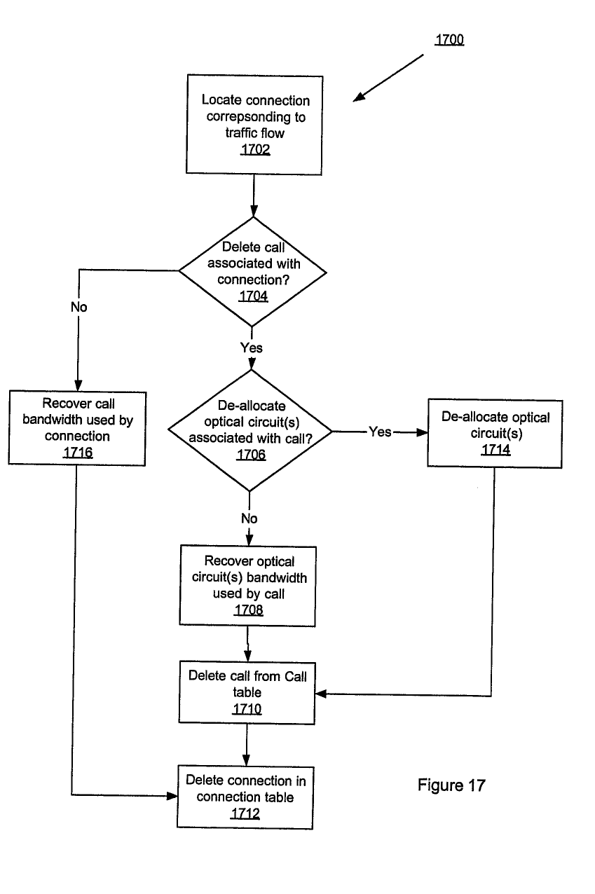

FIG. 17 is an exemplary flow diagram for de-provisioning traffic flow(s) according to one embodiment of the invention. At block 1702, method 1700 locates the connection corresponding to the traffic flow. For example and by way of illustration, method 1700 locates the connection entry in table 1500 corresponding to the traffic flow. At block 1704, method 1700 determines whether the call associated with the connection should be deleted. For example and by way of illustration, method 1700 may delete the call if the connection deleted was the last remaining connection in the call. If so, at block 1706, method further determines if the optical circuit(s) associated with the deleted call, should be de-allocated as well. For example and by way of illustration, method 1700 may delete the optical circuit(s) if the call deleted was the last remaining call using the optical circuit(s). If so, at block 1714, method 1700 de-allocates the optical circuit(s). For example and by way of illustration, method 1700 deletes the optical circuit(s) as described in U.S. patent application Ser. No. 10/754,931, entitled “Method and Apparatus for a Network Database in an Optical Network”. Control passes to block 1710.

Returning to block 1706, if method 1700 does not delete the optical circuit(s) associated with the call (e.g., there are one or more calls mapped to the optical circuit(s), etc.), method 1700 recovers the optical circuit(s) bandwidth used by the call. For example and by way of illustration, method 1700 updates table 1550 by subtracting the bandwidth allocated to the call (maximum bandwidth 1532) from the bandwidth allocated 1556 and adds call bandwidth allocated to optical circuit bandwidth availability 1558. At block 1710, method 1700 deletes the call from the call table. For example and by way of illustration, method 1700 deletes the corresponding entry from call table 1520. Control passes to block 1712.

Returning to block 1704, if method 1700 does not delete the call associated with the connection (e.g., there are one or more connections mapped to the call, etc.), method 1700 recovers the call bandwidth allocated to the connection. For example and by way of illustration, method 1700 updates table 1520 by decrementing the call utilized bandwidth 1534 by the connection bandwidth. Control passes to block 1712.

At block 1712, method 1700 deletes the connection from the connection table. For example and by way of illustration, method deletes the entry associated with the connection from the table 1500.

### Processing Traffic Flows

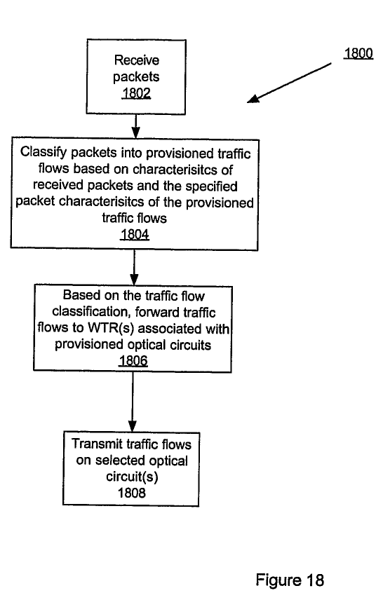

FIG. 18 is an exemplary flow diagram for processing data packets into traffic flows and switching the traffic flows to optical circuits according to one embodiment of the invention. At block 1802, method 1800 receives packets. While in one embodiment, method 1800 receives packets on one port of a line card of a source DTSP, other embodiments may receives packets on multiple ports in one or multiple line cards, etc. At block 1804, method 1800 classifies the received packets into provisioned traffic flows based on the characteristics of the received packets and the specified characteristics of the provisioned traffic flows. For example and by way of illustration, method 1800 classifies the packets into traffic flows as illustrated in FIGS. 9A-9C.

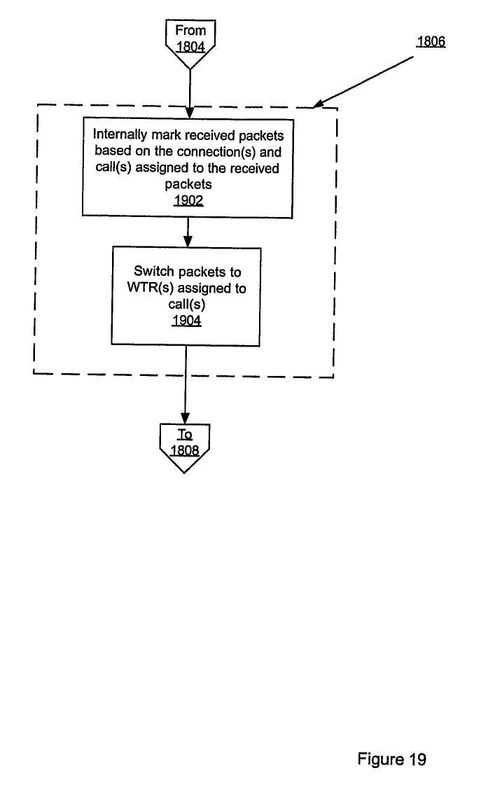

At block 1806, based on the traffic flow classification, method 1800 forwards the traffic flows to the selected WTR(s) of the provisioned optical circuit(s). Forwarding the traffic flows is further described in FIG. 19, below. Returning to FIG. 18, at block 1808, method 1800 transmits the traffic flows on the selected optical circuits. For example and by way of illustration, method 1800 transmits the traffic flows to the corresponding WTR(s) associated with the selected optical circuits as illustrated in FIGS. 9A-C.

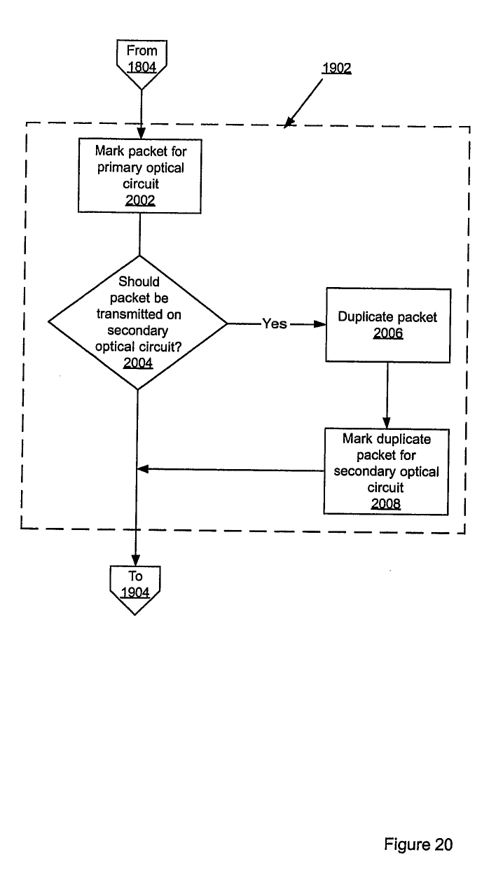

FIG. 19 is an exemplary flow diagram for internally marking data packets for traffic flows according to one embodiment of the invention. In particular, FIG. 19 represents a further description of block 1806. At block 1902, method 1800 internally marks received packets based on the connection(s) and call(s) assigned to the received packets. As described above, while in one embodiment, method 1800 adds node internal and traffic flow marks (as described in FIGS. 9A and 13), other embodiments may mark (or use existing) marks (e.g., GMPLS, MPLS tags, etc.). Marking by method 1800 is further described in FIG. 20, below. At block 1904, method 1800 switches the packets in the traffic flows to the WTR(s) associated with the call(s) for the traffic flows. For example and by way of illustration, method 1800 switches traffic flows to the appropriate WTR(s) as illustrated in FIG. 9A-C.

FIG. 20 is an exemplary flow diagram for marking data packets for working and/or protected optical circuits for the call associated with the data packets according to one embodiment of the invention. In particular, FIG. 20 describes how method 1800 marks a packet so that method 1800 forwards the packet to the appropriate WTR(s). At block 2002, method 1800 marks a packet for the primary optical circuit. While in one embodiment, the primary optical circuit is the working optical circuit associated with the packet, in other embodiments, the primary optical circuit is the protecting optical circuit because the working optical circuit is not available. At block 2004, method 1800 determines if a duplicate of the packet should be transmitted on a secondary circuit. For example and by way of illustration, the secondary circuit is a protecting circuit for a 1+1 protection scheme. If a duplicate packet is to be transmitted on a secondary circuit, at block 2006, method 1800 duplicates the packet. At block 2008, method 1800 marks the duplicate packet for the secondary optical circuit. Referring to FIGS. 9C, method 1800 marks the duplicate packet with a node internal mark and a traffic flow mark indicating the packet is to be transmitted along the 1+1 protecting optical circuit.

### Exemplary Architecture

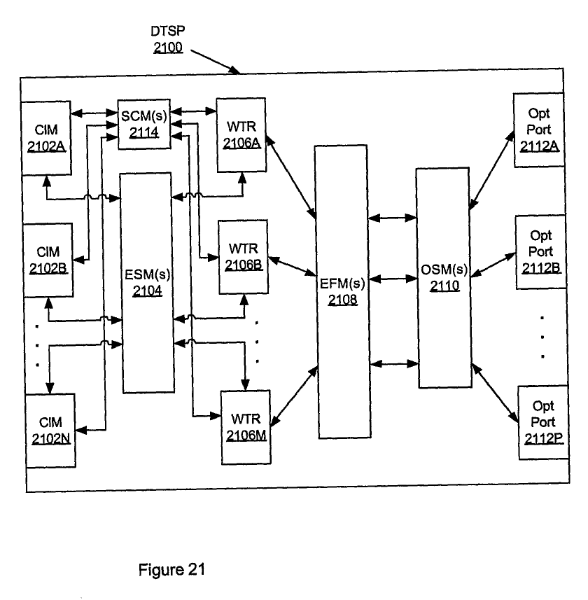

FIG. 21 is a block diagram illustrating an exemplary system architecture of the DTSP according to one embodiment of the invention. DTSP 2100 comprises CIM 2102A-N, electronic switch module (ESM) 2104, shelf control module (SCM(s)) 2114, WTR 2106A-M, extended fiber module (EFM(s)) 2108, optical switch module (OSM) 2110 and optical ports 2112A-P. Each CIM 2102A-N couples to ESM(s) 2104 and SCM(s) 2114. SCM(s) 2114 and ESM(s) 2104 further couple WTR 2106A-M. Furthermore, WTR 2106A-M couple to EFM(s) 2108, where in addition, EFM(s) 2108 couples to OSM 2110. OSM couples to optical ports 2112A-P.

In FIG. 21, CIM 2102A-N couple to the electronically switched network and transmitlreceive packets to/from L2/L3 devices (not shown) in the electronically switched network. In addition, CIM 2102A-N process packets for switching by ESM(s) 2104 by classifying the packets into know traffic flows and marking the packets accordingly. While in one embodiment, CIM 2102A-N comprises one NPU and multiple ports facing the electrically switched network (e.g., GigE, 10 GigE, Fiber Channel, SONET OC-48, SONET OC-192, and/or combinations thereof, etc.), other embodiments of CIM 2102A-N may comprise different combinations of NPUs and ports (e.g. one NPU with one port, multiple NPUs for one port, multiple NPUs for multiple ports, etc.). In one exemplary embodiments, CIM 2102A-N process packets as illustrated in FIGS. 9A-C (where each CIM 2102A-N comprises packet ports 910A-B and NPU(s) 912A) and FIGS. 14A-H (where each CIM 2102A-N comprises a NPU/Port pair such as Port 1402A/NPU 1404A, etc.).

In one direction ESM(s) 2104 switches packets from CIM 2102A-N to WTR 2106A-M based on the packet markings added by CIM 2102A-N, while in the other direction ESM(s) 2104 switches packets from WTR 2106A-M to CIM 2102A-N.

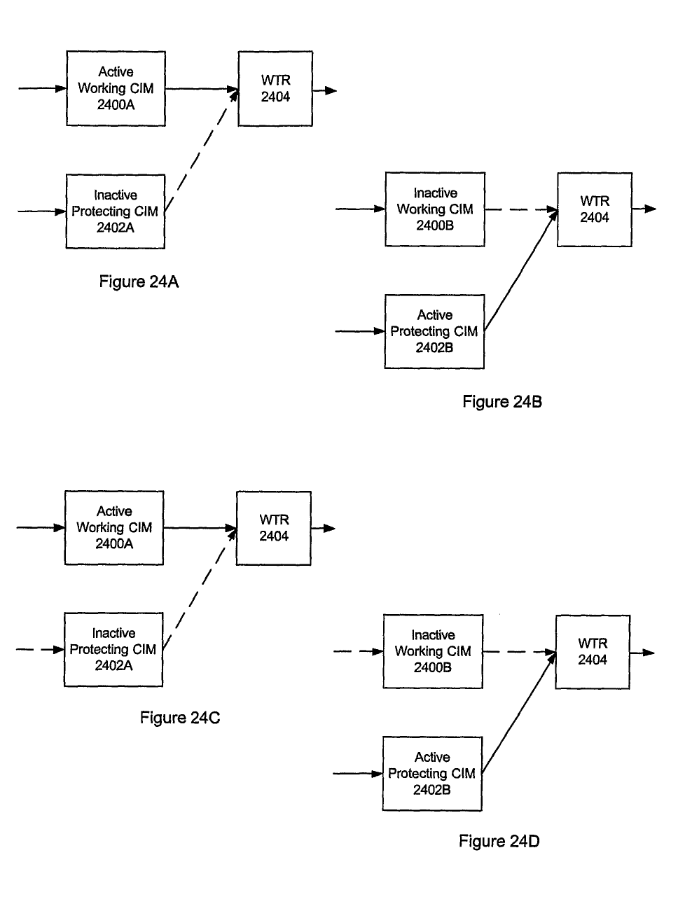

SCM(s) 2114 configures and updates CIM 2102A-N and VVR 2106A-M by forwarding configuration information and status events to CIM 2102A-N and WTR 2106A-M. While in one embodiment, SCM(s) 2114 forwards status events such as, but not limited to, CIM Up/Down and WTR Up/Down events to CIM 2102A-N and WTR 2106A-M, other embodiments may send more, less and/or different events to CIM 2102A-N and WTR 2106A-M. Based on the events received by the CIM 2102A-N, CIM 2102A-N programs NPU(s) associated with CIM 2102A-N. Similarly, WTR 2106A-M programs NPU(s) on WTR 2106A-M based on the events received by WTR 2106A-M. CIM 2102A-N and WTR 2106A-M NPU(s) programming is further described in FIGS. 24-29.

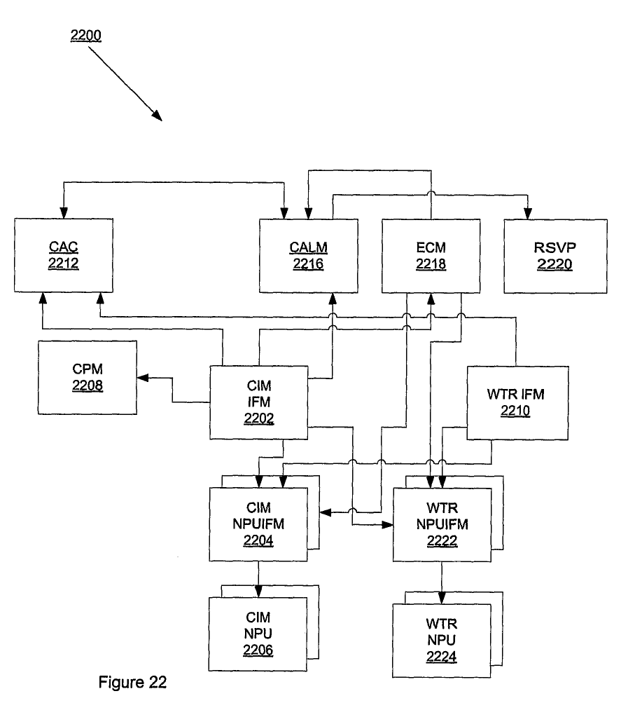

In addition, in FIG. 22, EFM is the fiber backplane coupling WTR 2106A-M to OSM(s) 2110. OSM 2110(s) switch the wavelength generated by WTR 2106A-M to optical ports 2112A-P.

FIG. 22 is a block diagram illustrating the control plane architecture 2200 of the Aggregation Transport System (ATS) according to one embodiment of the invention. Control plane architecture 2200 comprises CIM interface manager (IFM) 2202 CIM NPUIFM 2204, CIM NPU 2206, WTR IFM 2210, WTR NPUIFM 2222, WTR NPU 2224, client protection manager (CPM) 2208, electronic connection manager (ECM) 2218, Call Admission and Control (CAC) 2212, Resource Reservation Protocol Module 2220, and Call Manager (CALM 2216).

CIM IFM 2202 couples to CIM NPUIFM 2204, CPM 2208, CAC 2212, CALM 2216, WTR NPUIFM 2222, and ECM 2218. CIM NPUIFM further couples to the respective CIM NPU 2206, WTR IFM 2210, and ECM 2218. In addition, WTR IFM 2210 further couples to WTR NPUIFM 2222 and CAC 2212. WTR NPUIFM couples to ECM 2218 and the respective WTR NPU 2224. Furthermore, CALM 2216 couples to CAC 2212, ECM 2218, and RSVP 2220.

In the control plane architecture 2200, CIM NPUIFM 2204 and WTR NPUIFM 2222 which both manage the NPUs on the respective cards. CIM IFM 2202 receives status of WTR ports involved in the connection from WTR IFM 2210 and status of CIM ports involved in the connection from CPM 2208. For example and by way of illustration, the various managers signal status of the ports involved/participating in the connection. As an additional example and by way of illustration, the status of the optical circuit can be determined by the status of the WTR operational state. An up/down WTR participating as optical circuit endpoints maps to an up/down optical circuit. If a fiber is cut, the receive end of WTR detects a loss of signal (LOS), will go operationally down and WTR IFM receives this operational down message. In addition, ECM 2218 sends/reports NPU configuration information to CIM NPUIFM 2204, such as, but not limited to, traffic flow configuration (i.e. traffic flow comprised of particular packet characteristics, bandwidth, etc.), connection/call configuration (e.g. configurations as illustrated in FIG. 15A), traffic flow to connection mapping, connection to call mapping, call to optical circuit mapping, etc. Based on the statuses and configuration received, CIM NPUIFM 2204 programs NPU(s) 2206 in the CIMs to mark the traffic flow(s) accordingly. While in one embodiment, NPU interface manager(s) maintain tables as illustrated in tables 3-12 and uses these tables to program NPU(s) 2206, in alternate embodiments NPUIFMs 2204 and 2222 may maintain tables that contain the same, different, more, and/or less information that is used to program the respective NPU(s). For example and by way of illustration, if CIM NPUIFM 2004 is informed that a working optical circuit for a call that is protected by a 1:1 protection scheme is down (e.g., because CIM NPUIFM 2204 receives WTR IFM event that a WTR port is up/down, etc.), CIM NPUIFM 2204 programs NPU(s) 2206 to process and mark packets of traffic flow(s) in the call for the protecting optical circuit. When CIM NPUIFM 2204 receive status that the working optical circuit for the call is up again, CIM NPUIFM 2204 re-programs NPU(s) 2206 to process and mark packets of traffic flow(s) in the call for the working optical circuit. In one embodiment, NPU(s) 2206 process and mark the packets as described above (e.g., processing and marking the packets as illustrated by NPU(s) 912A in FIGS. 9A-C). CIM NPU programming is further described in FIGS. 24-29 below.

WTR NPUIFM 2222 functions in a similar way as CIM NPUIFM 2204. WTR NPUIFM receives call configuration information from ECM 2218 and WTR status information from WTR IFM 2210. For example, and by way of illustration, ECM 2218 sends/reports NPU status information, such as, but not limited to, traffic flow configuration (i.e. traffic flow comprised of particular packet characteristics, bandwidth, etc.), connection/call configuration (e.g. configurations as illustrated in FIG. 15A), traffic flow to connection mapping, connection to call mapping, call to optical circuit mapping, etc. Based on the statuses and configuration received, WTR NPUIFM 2222 programs NPU(s) 2224 in the WTRs to mark the traffic flow(s) accordingly. In one embodiment, NPU(s) 2224 process and mark packets as described above (e.g., processing and marking the packets as illustrated by NPU(s) 912B in FIGS. 9A-C). WTR NPU programming is further described in FIGS. 24-29 below.

CAC 2212 maintains the bandwidth information for the CIM and WTR ports. It monitors the bandwidth utilization on the CIM/WTR ports. CAC 2212 acts as a gatekeeper for reserving and committing bandwidth. CALM 2216 makes a request to CAC 2212 for bandwidth before creating any call at the source and destination nodes of the call. If there is bandwidth available, CAC 2212 gives a go ahead to CALM 2216 to create a call and updates the port bandwidth information.

CPM 2208 maintains user provided protection information for the CIM ports and provides the port-based protection to the CIM(s). Port-based protection enables the user to designate which port on one CIM protects which other port on another CIM. CPM 2208 maintains the co-relation and the type of protection. CIM IFM 2202 reports any port specific events (e.g., port up/down) to CPM 2208. CPM 2208 signals CIM events such as, but not limited to, working CIM up, working CIM down, protecting CIM up, protecting CIM down, etc., to CIM NPUFIM 2204 and/or WTR NPUIFM 2224.

CALM 2216 is a call manager for alien and non-alien calls and is responsible for creation, updates and deletion of both types of calls. While in one embodiment, an alien call is used to carry an alien wavelength and a non-alien calls carries non-alien wavelength, other embodiments may have different organization of alien/non-alien calls (e.g., non-alien calls carried on alien wavelength, etc.). For example and by way of illustration, a non-alien call is a call as illustrated in FIGS. 12AB and 15A. Alien calls create call records on the source and destination nodes. RSVP 2220 creates optical connections for alien connection requests. RSVP is a GMPLS recommended signaling protocol. RSVP 2220 assists in physically creating optical connections from source to destination. On the other hand, non-alien calls create and/or trigger optical connections and as well as creating call records at the source and destinations nodes. For a non-alien call, CALM 2216 triggers RSVP 2220 to create optical cross-connects from source to destination.

While in one embodiment, CIM IFM 2202, WTR IFM 2210, CPM 2208, CAC 2212, CALM 2216, ECM 2218, and RSVP 2220 reside on the SCM(s) 2114, while CIM NPU(s) 2206 and CIM NPUIFM 2204 on CIM 2102A-N and WTR NPU(s) 2222 and WTR NPUIFM 2224 on WTR 2102A-M, alternate embodiment may have different arrangement of components (e.g., CIM NPUIFM 2204 on SCM(s) 2114, WTR NPUIFM 2222 on SCM(s) 2114, CIM IFM 2202 on CIM 2102A-N, etc.) or other embodiments may be described in which the functionality of control plane architecture 2200 is present.

FIG. 23 is a block diagram illustrating the architecture of the ESM and NPU(s) 2300 according to one embodiment of the invention. ESM-NPU(s) 2300 interfaces a DTSP node with the electrically switched network. For example, referring to FIG. 14A, ESM-NPU(s) 2300 represented one embodiment of NPUs 1404A-B and 1404E-F as well as ESM 1406A. ESM-NPU(s) 2300 comprises a switch fabric 2310 coupled to serializer/deserializers 2308A-B. Each serializer/deserializers 2308A-B is further coupled to switch interfaces 2306A-B, where each switch interface 2306A-B comprises its own serializer/deserializer. In addition, each switch interface 2306A-B couples to NPU 2304A-B, with each NPU 2304A-B coupling to a frame/MAC 2302A-B.

One end of ESM-NPU(s) 2300 interfaces the DTSP node with the electrically switched network (e.g., end designated by framer/MAC 2302A), while the other end of ESM-NPU(s) 2300 interfaces with WTR(s) (not shown). Framer/MAC 2302A receives the framed packets from the electronically switched networks, collects traffic flow(s) statistics and separates the packets into traffic flow(s). NPU 2304A processes the traffic flow(s) by adding marks to each packet in the traffic flow(s) (e.g. adding the node internal and traffic flow marks as illustrated in FIG. 13) and forwarding the traffic flow(s) to the appropriate WTR(s) via switch interface 2306A. In addition, NPU may also manage the traffic flow(s) (e.g. rate limit the traffic flows as illustrated in FIG. 10). Switch interface 2306A-B forwards the packets to serializer/deserializer 2308A. Serializer/Deserializer 2308A is a physical bus that supports serial data Switch interface 2306A-B performs the job of serializing and deserializing. Switch interface 2306A-B converts massively parallel data stream into serial stream and dumps it onto the serializer/deserializer 2308A during serialization vice versa during deserialization. For example and by way of illustration, c6 interface is massively parallel interface coming into the switch interface. Switch interface 2306A-B converts this massively parallel interface and packs it into the serial interface bus going out.

Switch fabric 2310 switches the traffic flow(s) based on the packets characteristics. While in one embodiment switch fabric 2310 switches the traffic flow(s) based on the hardware dependent C6 node internal mark contained in the packets of the traffic flow(s), other embodiments may switch the traffic flow(s) based on other marks or packet characteristics (e.g., another node internal mark known in the art and/or developed in the future, etc.). Switch fabric 2310 switches the traffic flow to the appropriate destination via serializer/deserializer 2306B and switch interface 2306B. NPU 2304B aggregates the received traffic flow(s) and forwards the received traffic flow(s) to the WTR corresponding to NPU 2304B. In addition, if the packets in the traffic flow(s) processed by NPU 2304B contained a node internal mark, NPU 2304B removes the node internal marks. NPU 2304B forwards the aggregated traffic flows to framer/MAC 2302B, where WTR transmits the traffic flow(s) to the optically switched network. In addition, framer/MAC 2302B collects statistics on the traffic flow(s).

The above description illustrates processing by ESM-NPU(s) 2300 of packets received from the electrically switched network to transmission of traffic flow(s) to the optically switched network. In a reciprocal fashion, aggregated traffic flow(s) coming from optically switched network enter ESM-NPU(s) 2300 via framer/MAC 2302B. Framer/MAC 2302B collects statistics, separates the aggregated traffic flow(s) into separate traffic flow(s) and forwards the aggregated traffic flow(s) to NPU 2304B. NPU 2304B marks the packets in the traffic flow(s) with a node internal mark (as illustrated in FIG. 13) based on the outgoing electrically switched DTSP port and the type of connection protection for the traffic flow(s). NPU 2304B forwards the traffic flow(s) to switch fabric 2310 via switch interface 2306B and serializer/deserailizer 2308B.

Switch fabric 2310 switches the traffic flow(s) to the appropriate electrically switch packet port based on the packets characteristics. While in one embodiment switch fabric 2310 switches the traffic flow(s) based on the hardware dependent C6 node internal mark contained in the packets of the traffic flow(s), other embodiments may switch the traffic flow(s) based on other marks or packet characteristics (e.g., another node internal mark known in the art and/or developed in the future, etc.). Switch fabric 2310 switches the traffic flow to the appropriate destination via serializer/deserializer 2306A and switch interface 2306A.

NPU 2304A removes the node internal mark (if used) and optionally removes the traffic flow mark. Furthermore, NPU 2304A forwards the traffic flow(s) to the appropriate electrically switched packet port via framer/MAC 2302A. In addition, framer/MAC 2302A collects statistics on the traffic flow(s).

While in one embodiment, ESM-NPU(s) 2300 architecture are as illustrated, alternate embodiments may be described in which the functionality of ESM-NPU(s) 2300 architecture is present (e.g., multicasting via Switch fabric 2310 instead of using NPU 2304A-B, etc.).

### Exemplary CMI/WTR Protection Architecture

FIGS. 24-29 illustrate CIM and WTR protection architectures for one traffic flow according to one embodiment of the invention. The protection schemes illustrated are 1+1 and 1:1. In a 1+1 protection scheme, two copies of the traffic flow are received and/or transmitted to the appropriate working and protecting CIM/WTR. Conversely, in a 1:1 protection scheme, the CIM/WTR forwards one copy of the traffic flow. Nevertheless, for either protection scheme, which CIM WTR forwarding the traffic flow(s) depends on the CIM/WTR status. While in one embodiment, CIM/WTR change status based on events relating to the physical condition of CIM(s) and/or WTR(s), in alternate embodiments the CIM WTR may change status based on more, less and/or different events (e.g., fiber cut/restored, link between customer equipment and CIM up/down etc.).

FIGS. 24A-D are block diagrams illustrating ingress path CIM protection schemes according to one embodiment of the invention. In FIGS. 24A-D, working CIM 2400A-B represents a working CIM with active or inactive states. In the active state, working CIM 2400A forwards the traffic flow. Conversely, in the inactive state, working CIM 2400B does not forward the traffic flow. Similarly, protecting CIM 2400A forwards or does not forward the traffic flow depending whether protecting CIM is active (2402A) or inactive (2402B). In either 1+1 or 1:1 CIM protection, the active CIM forwards the traffic flow. WTR 2404 forwards the received traffic flow onto the optically switched network.

FIGS. 24A-B illustrates 1+1 protection CIM protection for a traffic flow according to one embodiment of the invention. In FIG. 24A, both active working CIM 2400A and inactive protecting CIM 2402A receive the traffic flow. However, only active working CIM 2400A forwards the traffic flow because protecting CIM 2402A is inactive for this traffic flow. Consequently, WTR 2404 receives the traffic flow from CIM 2400A. If CIM 2400A-B and CIM 2402A-B receive the “CIM Working Down; CIM Protecting Up” event from CPM 2208, CIM 2400A-B & CIM 2402A-B change there state to reflect FIG. 24B. In FIG. 24B, working CIM 2400B is inactive and does not forward the traffic flow to WTR 2404. Instead, protecting CIM 2402B is active and forwards the traffic flow to WTR 2404.

FIGS. 24C-D illustrates 1:1 protection CIM protection for a traffic flow according to one embodiment of the invention. In FIG. 24C, active working CIM 2400A forwards the traffic flow to WTR 2404. Because FIG. 24C illustrates 1:1 CIM protection, protecting CIM 2402A is inactive and does not receive the traffic flow. If CIM 2400A-B & CIM 2402A-B receive the “CIM Working Down; CIM Protecting Up” event from CPM 2208, CIM 2400A-B and CIM 2402A-B change there state to reflect FIG. 24D. In FIG. 24D, working CIM 2400B is inactive and does not receive nor forward the traffic flow to WTR 2404. Instead, protecting CIM 2402B is active, receives and forwards the traffic flow to WTR 2404.

FIGS. 24A-D illustrates events from CPM 2208 changing the states of working CIM 2400A-B and protecting CIM 2402A-B. This represents some of the states changes possible due to events forwarded by CPM 2208. Table 3 illustrates additional ingress CIM states changes due to CPM events.

TABLE 3
CPM Events Affecting Working and Protecting CIM (Ingress Only)

| | Current Ingress State | Event from CPM | New Ingress State |
|---|---|---|---|
| 1 | CIM Working - Active | CIM Working - Up | CIM Working - Active |
| | CIM Protecting - Inactive | CIM Protecting - Up | CIM Protecting - Inactive |
| 2 | CIM Working - Active | CIM Working - Up | CIM Working - Active |
| | CIM Protecting - Inactive | CIM Protecting - Down | CIM Protecting - Inactive |
| 3 | CIM Working - Active | CIM Working - Down | CIM Working - Inactive |
| | CIM Protecting - Inactive | CIM Protecting - Up | CIM Protecting - Active |
| 4 | CIM Working - Active | CIM Working - Down | CIM Working - Inactive |
| | CIM Protecting - Inactive | CIM Protecting - Down | CIM Protecting - Inactive |
| 5 | CIM Working - Inactive | CIM Working - Up | CIM Working - Active |
| | CIM Protecting - Active | CIM Protecting - Up | CIM Protecting - Inactive |
| 6 | CIM Working - Inactive | CIM Working - Up | CIM Working - Active |
| | CIM Protecting - Active | CIM Protecting - Down | CIM Protecting - Inactive |
| 7 | CIM Working - Inactive | CIM Working - Down | CIM Working - Inactive |
| | CIM Protecting - Active | CIM Protecting - Up | CIM Protecting - Active |
| 8 | CIM Working - Inactive | CIM Working - Down | CIM Working - Inactive |
| | CIM Protecting - Active | CIM Protecting - Down | CIM Protecting - Inactive |
| 9 | CIM Working - Inactive | CIM Working - Up | CIM Working - Active |
| | CIM Protecting - Inactive | CIM Protecting - Up | CIM Protecting - Inactive |
| 10 | CIM Working - Inactive | CIM Working - Up | CIM Working - Active |
| | CIM Protecting - Inactive | CIM Protecting - Down | CIM Protecting - Inactive |
| 11 | CIM Working - Inactive | CIM Working - Down | CIM Working - Inactive |
| | CIM Protecting - Inactive | CIM Protecting - Up | CIM Protecting - Active |
| 12 | CIM Working - Inactive | CIM Working - Down | CIM Working - Inactive |
| | CIM Protecting - Inactive | CIM Protecting - Down | CIM Protecting - Inactive |

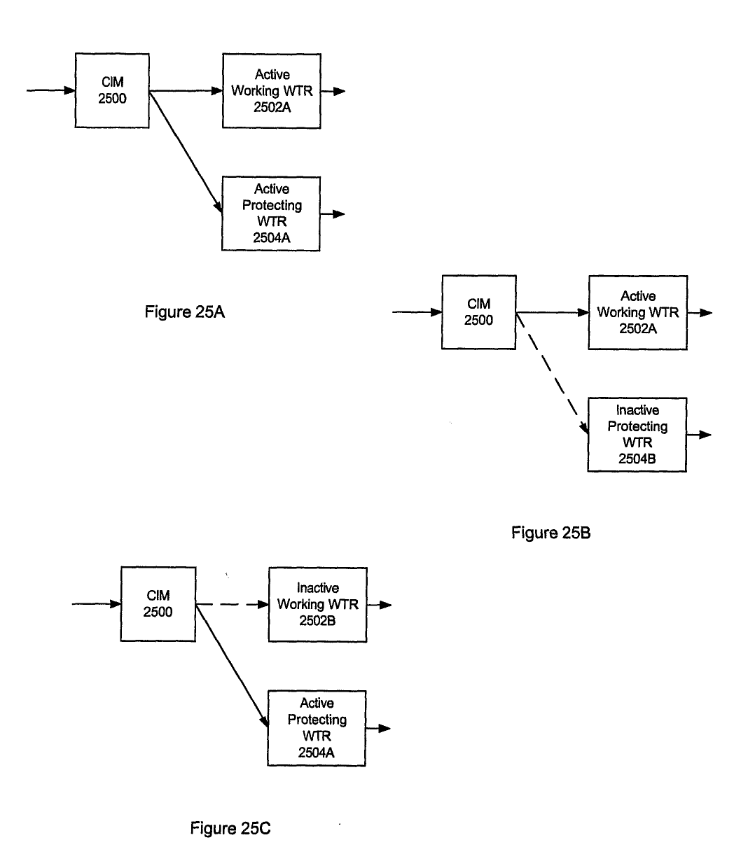

FIGS. 25A-C are block diagrams illustrating ingress path WTR protection schemes according to one embodiment of the invention. In FIGS. 25A-C, CIM 2500 may forward one or two copies of one traffic flow working WTR 2502A-B and/or protecting WTM 2504A-B, depending on the protection scheme. In FIG. 25A, CIM 2500 forwards two copies of the same traffic flow to active working WTR 2502A and protecting WTM 2504A because the ingress path WTR protection scheme is 1+1.

In FIGS. 25B-C, the ingress path WTR protection scheme is 1:1, in which CIM 2500 forwards the traffic flow to either working WTR 2502A or protecting WTR 2502B. In FIG. 25B, CIM 2500 forwards the traffic flow to active working WTR 2502A, and does not forward the traffic flow to inactive protecting WTR 2504B. If WTh 2502A-B and WTR 2504A-B receive the “WTR Working Down; WTR

Protecting Up” event from WTR IFM 2210, WTR 2502A-B & WTR 2504A-B change there state to reflect FIG. 24C. In FIG. 25C, working WTR 2502B in inactive and protecting WTR 2504A is active. Consequently, CIM 2500 forwards the traffic flow to active protecting WTR 2504A. In addition, CIM 2500 receives the same types of WTR events from WTR IFM 2210 (via CIM NPUIFM 2204) and CIM 2500 changes the forwarding of the received traffic flow accordingly. While in one embodiment, CIM follows the rules for events as illustrated in Table 7, alternate embodiments may have CIM 2500 respond to more, less and/or different events.

FIGS. 25A-C illustrates events from WTR IFM 2210 changing the states of working WTR 2502A-B and protecting WTR 2504A-B. This represents some of the states changes possible due to events forwarded by WTR IFM 2210. Table 4 illustrates additional ingress WTR state changes due to WTR IFM events.

TABLE 4
WTR IFM Events Affecting Working and Protecting DTR

| | Current Ingress State | Event from IFM | New Ingress State |
|---|---|---|---|
| 1 | WTR Working - Active | WTR Working - Up | WTR Working - Active |
| | WTR Protecting - Inactive | WTR Protecting - Up | WTR Protecting - Inactive |
| 2 | WTR Working - Active | WTR Working - Up | WTR Working - Active |
| | WTR Protecting - Inactive | WTR Protecting - Down | WTR Protecting - Inactive |
| 3 | WTR Working - Active | WTR Working - Down | WTR Working - Inactive |
| | WTR Protecting - Inactive | WTR Protecting - Up | WTR Protecting - Active |
| 4 | WTR Working - Active | WTR Working - Down | WTR Working - Inactive |
| | WTR Protecting - Inactive | WTR Protecting - Down | WTR Protecting - Inactive |
| 5 | WTR Working - Inactive | WTR Working - Up | WTR Working - Active |
| | WTR Protecting - Active | WTR Protecting - Up | WTR Protecting - Inactive |
| 6 | WTR Working - Inactive | WTR Working - Up | WTR Working - Active |
| | WTR Protecting - Active | WTR Protecting - Down | WTR Protecting - Inactive |
| 7 | WTR Working - Inactive | WTR Working - Down | WTR Working - Inactive |
| | WTR Protecting - Active | WTR Protecting - Up | WTR Protecting - Active |
| 8 | WTR Working - Inactive | WTR Working - Down | WTR Working - Inactive |
| | WTR Protecting - Active | WTR Protecting - Down | WTR Protecting - Inactive |
| 9 | WTR Working - Active | WTR Working - Up | WTR Working - Active |
| | WTR Protecting - Active | WTR Protecting - Up | WTR Protecting - Active |
| 10 | WTR Working - Active | WTR Working - Up | WTR Working - Active |
| | WTR Protecting - Active | WTR Protecting - Down | WTR Protecting - Inactive |
| 11 | WTR Working - Active | WTR Working - Down | WTR Working - Inactive |
| | WTR Protecting - Active | WTR Protecting - Up | WTR Protecting - Active |
| 12 | WTR Working - Active | WTR Working - Down | WTR Working - Inactive |
| | WTR Protecting - Active | WTR Protecting - Down | WTR Protecting - Inactive |

Table 5 lists the possible events, WTR types, working WTR status, CIM types, CIM modes, CIM status and NPU modes according to one embodiment of the invention. Possible events listed in Table 5 include events from CPM 2208: CPM Working CIM Up; CPM Protecting CIM Up; CPM Working CIM Down; and CPM Protecting CIM Down. These events signal that the working/protecting CIM is up or down. Furthermore, Table includes events from WTR IFM 2210: IPM Working CIM Up; IFM Protecting CIM Up; IFM Working CIM Down; and IFM Protecting CIM Down. The WTR IFM 2210 events signal that the working/protecting WTR is up or down. Alternate embodiments may list more, less or different events.

In addition, Table 5 lists the WTR and CIM protection types. While in one embodiment, WTR/CIM protection types are None (unprotected), 1+1, 1:1, and 1:N, alternate embodiments may have more, less and/or different protection schemes (e.g., fast reroutable, etc.). Furthermore, Table 5 illustrates the WTR and CIM modes can either be working or protecting, with each mode being active or inactive.

As listed in Table 5, the NPU modes for each traffic flow are: normal, protect, multicast, and discard according to one embodiment of the invention. An NPU in normal mode forwards the traffic flow to the working CIM WTR, while an NPU in the protect mode forwards the traffic flow to the protecting CIM/WTR. If a CIM/WTR needs to forwards two copies of the same traffic flow to a working and protecting WTR/CIM, a multicast NPU mode is used. Lastly, an NPU can discard packets in the traffic flow (discard mode). In alternate embodiments, the NPU mode can have more, less and/or different modes (e.g., mark and forward, etc.).

TABLE 5
Type of Entries for Events, WTR Type, WTR Status, CIM Type, CIM Mode,
CIM Status, and NPU Mode.

| | | | Working | | | | |
|---|---|---|---|---|---|---|---|
| | WTR | WTR | WTR | CIM | CIM | CIM | NPU |
| Event | Type | Mode | Status | Type | Mode | Status | Mode |
| CPM W/P CIM Up | None | Working | Active | None | Working | Active | Normal |
| CPM W/P CIM Down | 1 + 1 | Protect | Inactive | 1 + 1 | Protect | Inactive | Protect |
| IFM W/P WTR Up | 1:1 | | | 1:1 | | | Multicast |
| IFM W/P WTR Down | 1:N | | | 1:N | | | Discard |

Table 6 lists the status of a CIM WTR with a corresponding CPM/WTR IFM event for a working CIM according to one embodiment of the invention.

TABLE 6
Status Changes Caused by Events for Working CIM NPUIFM.

| | WTR | WTR | Working | | CIM | CIM | NPU |
|---|---|---|---|---|---|---|---|
| Event | Type | Mode | WTR Status | CIM Type | Mode | Status | Mode |
| CPM Working CIM Up | | | | | | Active | |
| CPM Protect CIM Up | | | | | | No | |
| | | | | | | change | |
| CPM Working CIM | | | | | | Inactive | |
| Down | | | | | | | |
| CPM Protect CIM Down | | | | | | Active | |
| IFM Working WTR Up | | | Active | | | | |
| IFM Protect WTR Up | | | No change | | | | |
| IFM Working WTR | | | Inactive | | | | |
| Down | | | | | | | |
| IFM Protect WTR Down | | | Active | | | | |

Table 7 lists CIM modes, NPU modes for Working CIM NPUIFM for different CIM and/or WTfR protection schemes according to one embodiment of the invention. For example and by way of illustration, if the CIM or WTR has no protection scheme, a CPM Working CIM Up/Down event leaves the NPU mode for the working CIM as normal. As another example, for a WTR 1:1 protection scheme, an IFM Working WTR Down event causes the CIM working NPU mode to be in protect mode, as the CIM forwards the traffic flow the protecting WTR. An IFM Working WTR Up event causes the CIM working NPU mode to be in normal mode, with the CIM forwarding the traffic flow to the working WTR.

In addition, Table 7 lists scenarios when the working CIM participates in both CIM and WTR protection schemes. For example, and by way of illustration, if the working CIM participates in both a CIM 1+1 and WTR 1+1 protection scheme, a CPM

Working CIM Up event causes the CIM Working NPU mode to be multicast, because the working CIM forwards the traffic flow to the working and protecting WTR. Conversely, a Working CIM Down event puts the CIM Working NPU mode into the discard state.

Although only a few protection schemes are described above, Table 7 lists additional CIM and/or WTR protection schemes and the affect on the CIM mode, status and CIM NPU mode. Alternate embodiments may have more, less and/or different table entries.

TABLE 7
NPU Modes for Working CIM NPUIFM

| | | | | | | | |
|---|---|---|---|---|---|---|---|
| | | | Working | | | | |
| | WTR | WTR | WTR | CIM | CIM | CIM | |
| Event | Type | Mode | Status | Type | Mode | Status | NPU Mode |

No CIM or WTR protection:

| | | | | | | | |
|---|---|---|---|---|---|---|---|
| CPM -> Working CIM Up | None | N/A | N/A | None | N/A | N/A | Normal |
| CPM -> Working CIM | None | N/A | N/A | None | N/A | N/A | Normal |
| Down | | | | | | | |

CIM 1 + 1 protection only:

| | | | | | | | |
|---|---|---|---|---|---|---|---|
| CPM -> Working CIM Up | None | N/A | N/A | 1 + 1 | Working | Active | Normal |
| CPM -> Working CIM | None | N/A | N/A | 1 + 1 | Working | Inactive | Discard |
| Down | | | | | | | |

CIM 1:1 protection only:

| | | | | | | | |
|---|---|---|---|---|---|---|---|
| CPM -> Working CIM Up | None | N/A | N/A | 1:1 | Working | Active | Normal |
| CPM -> Working CIM | None | N/A | N/A | 1:1 | Working | Inactive | Discard |
| Down | | | | | | | |

WTR 1 + 1 protection only (IFM does not need to send anything to CIM)

| | | | | | | | |
|---|---|---|---|---|---|---|---|
| N/A | 1 + 1 | N/A | N/A | None | N/A | No | No change |
| | | | | | | change | |

WTR 1:1 protection only:

| | | | | | | | |
|---|---|---|---|---|---|---|---|
| IFM -> Working WTR Up | 1:1 | N/A | Active | None | N/A | Active | Normal |
| (if revertive then switch | | | | | | | |
| back to working WTR | | | | | | | |
| otherwise ignore) | | | | | | | |
| IFM -> Working WTR | 1:1 | N/A | Inactive | None | N/A | Active | Protect |
| Down | | | | | | | |
| IFM -> Protect WTR Up | 1:1 | N/A | Active | None | N/A | Active | Normal |
| IFM -> Protect WTR | 1:1 | N/A | Active | None | N/A | Active | Normal |
| Down (need to check | | | | | | | |
| whether working WTR is | | | | | | | |
| up before switching. If | | | | | | | |
| already using working | | | | | | | |
| WTR then ignore | | | | | | | |
| message) | | | | | | | |

CIM 1 + 1 and WTR 1 + 1 protection:

| | | | | | | | |
|---|---|---|---|---|---|---|---|
| CPM -> Working CIM Up | 1 + 1 | N/A | N/A | 1 + 1 | Working | Active | Multicast |
| CPM -> Working CIM | 1 + 1 | N/A | N/A | 1 + 1 | Working | Inactive | Discard |
| Down | | | | | | | |

CIM 1:1 and WTR 1 + 1 protection:

| | | | | | | | |
|---|---|---|---|---|---|---|---|
| CPM -> Working CIM Up | 1 + 1 | N/A | N/A | 1:1 | Working | Active | Multicast |
| CPM -> Working CIM | 1 + 1 | N/A | N/A | 1:1 | Working | Inactive | Discard |
| Down | | | | | | | |

CIM 1 + 1 and WTR 1:1 protection:

| | | | | | | | |
|---|---|---|---|---|---|---|---|
| CPM -> Working CIM Up | 1:1 | N/A | Active | 1 + 1 | Working | Active | Normal |
| (if working WTR is active) | | | | | | | |
| CPM -> Working CIM Up | 1:1 | N/A | Inactive | 1 + 1 | Working | Active | Protect |
| (if protecting WTR is | | | | | | | |
| active) | | | | | | | |
| CPM -> Working CIM | 1:1 | N/A | Active | 1 + 1 | Working | Inactive | Discard |
| Down (if working WTR is | | | | | | | |
| active) | | | | | | | |
| CPM -> Working CIM | 1:1 | N/A | Inactive | 1 + 1 | Working | Inactive | Discard |
| Down if protecting WTR | | | | | | | |
| is active) | | | | | | | |
| IFM -> Working WTR Up | | | | | | | |
| (TBD) | | | | | | | |
| IFM -> Working WTR | | | | | | | |
| Down (TBD) | | | | | | | |
| IFM -> Protect WTR Up | | | | | | | |
| (TBD) | | | | | | | |
| IFM -> Protect WTR | | | | | | | |
| Down (TBD) | | | | | | | |
| CPM -> Working CIM Up | 1:1 | N/A | Active | 1 + 1 | Working | Active | Normal |
| CPM -> Working CIM Up | 1:1 | N/A | Inactive | 1 + 1 | Working | Active | Protect |
| CPM -> Working CIM | 1:1 | N/A | Active | 1 + 1 | Working | Inactive | Discard |
| Down | | | | | | | |
| CPM -> Working CIM | 1:1 | N/A | Inactive | 1 + 1 | Working | Inactive | Discard |
| Down | | | | | | | |

Table 8 lists the WTR involved in a 1:1 protection scheme according to one embodiment of the invention. If the WTR is active, the CIM status is active with the CIM NPU mode as normal. On the other hand, if the WTR status is inactive, the CIM status can be either active (with the NPU mode protecting) or inactive (with the NPU mode of discard).

TABLE 8
NPU Modes for WTR 1:1

| WTR Status | CIM Status | NPU Mode |
|---|---|---|
| Active | Active | Normal |
| Inactive | Active | Protect |
| — | Inactive | Discard |

Table 9 lists the status of a CIM WTR with a corresponding CPM/WTR IFM event for a protecting CIM according to one embodiment of the invention.

TABLE 9
Status Changes Caused by Events for Protecting CIM NPUIFM.

| | WTR | WTR | Working | CIM | CIM | | NPU |
|---|---|---|---|---|---|---|---|
| Event | Type | Mode | WTR Status | Type | Mode | CIM Stat | Mode |
| CPM -> Working CIM Up | | | | | | Inactive | |
| CPM -> Protect CIM Up | | | | | | No change | |
| CPM -> Working CIM | | | | | | Active | |
| Down | | | | | | | |
| CPM -> Protect CIM | | | | | | Inactive | |
| Down | | | | | | | |
| IFM -> Working WTR Up | | | Active | | | | |
| IFM -> Protect WTR Up | | | No change | | | | |
| IFM -> Working WTR | | | Inactive | | | | |
| Down | | | | | | | |
| IFM -> Protect WTR | | | Active | | | | |
| Down | | | | | | | |

Table 10 lists CIM modes, NPU modes for the protecting CIM NPUIFM for different CIM and/or WTR protection schemes according to one embodiment of the invention. For example and by way of illustration, in a CIM 1+1 protection scheme, a CPM event of working CIM Up causes the protecting CIM mode to be protect, with a CIM status of inactive and NPU mode of discard. This is because the protecting CIM does not forwards the traffic flow as illustrated in FIG. 24A. However, if the CPM sends an event of working CIM down, the protecting CIM status is active, with an NPU mode of normal, because the protecting CIM forwards the traffic flow as illustrated in FIG. 24B. As another example, if the protecting CIM participates in both a CIM 1+1 and WTR 1+1 protection scheme, a CPM Protecting CIM Up event causes the protecting CIM to be active with an NPU mode of multicast. This is because when both the CIM and WTR are in a 1+1 protection scheme, the protecting CIM forwards the traffic flow to both the working and protecting WTR.

Although only a few protection schemes are described above, Table 10 lists additional CIM and/or WTR protection schemes and the affect on the CIM mode, status and CIM NPU mode. Alternate embodiments may have more, less and/or different table entries.

TABLE 10
NPU Modes for Protecting CIM NPUIFM

| | | | | | | | |
|---|---|---|---|---|---|---|---|
| | | | Working | | | | |
| | WTR | WTR | WTR | CIM | CIM | CIM | NPU |
| Event | Type | Mode | Status | Type | Mode | Status | Mode |

No CIM or WTR protection:

| | | | | | | | |
|---|---|---|---|---|---|---|---|
| CPM -> Protect CIM Up | None | N/A | N/A | None | N/A | N/A | N/A |
| CPM -> Protect CIM | None | N/A | N/A | None | N/A | N/A | N/A |
| Down | | | | | | | |

CIM 1 + 1 protection only:

| | | | | | | | |
|---|---|---|---|---|---|---|---|
| CPM -> Working CIM Up | None | N/A | N/A | 1 + 1 | Protect | Inactive | Discard |
| CPM -> Working CIM | None | N/A | N/A | 1 + 1 | Protect | Active | Normal |
| Down | | | | | | | |
| CPM -> Protect CIM Up | N/A | N/A | N/A | N/A | N/A | N/A | N/A |
| CPM -> Protect CIM | None | N/A | N/A | 1 + 1 | Protect | Inactive | Discard |
| Down | | | | | | | |

CIM 1:1 protection only:

| | | | | | | | |
|---|---|---|---|---|---|---|---|
| CPM -> Working CIM Up | None | N/A | N/A | 1:1 | Protect | Inactive | Discard |
| CPM -> Working CIM | None | N/A | N/A | 1:1 | Protect | Active | Normal |
| Down | | | | | | | |
| CPM -> Protect CIM Up | N/A | N/A | N/A | N/A | N/A | N/A | N/A |
| CPM -> Protect CIM | None | N/A | N/A | 1:1 | Protect | Inactive | Discard |
| Down | | | | | | | |

WTR 1 + 1 protection only: (IFM does not need to send anything to CIM)

| | | | | | | | |
|---|---|---|---|---|---|---|---|
| N/A | 1 + 1 | N/A | N/A | None | N/A | No | No |
| | | | | | | change | change |

CIM 1 + 1 and WTR 1 + 1 protection:

| | | | | | | | |
|---|---|---|---|---|---|---|---|
| CPM -> Working CIM Up | N/A | N/A | N/A | N/A | N/A | N/A | N/A |
| CPM -> Working CIM | 1 + 1 | N/A | N/A | 1:1 | Protect | Active | Multicast |
| Down | | | | | | | |
| CPM -> Protect CIM Up | N/A | N/A | N/A | N/A | N/A | N/A | N/A |
| CPM -> Protect CIM | 1 + 1 | N/A | N/A | 1 + 1 | Protect | Inactive | Discard |
| Down | | | | | | | |

CIM 1:1 and WTR 1 + 1 protection:

| | | | | | | | |
|---|---|---|---|---|---|---|---|
| CPM -> Protect CIM Up | 1 + 1 | N/A | N/A | 1:1 | Protect | Active | Multicast |
| CPM -> Protect CIM | 1 + 1 | N/A | N/A | 1:1 | Protect | Inactive | Discard |
| Down | | | | | | | |

CIM 1 + 1 and WTR 1:1 protection:

| | | | | | | | |
|---|---|---|---|---|---|---|---|
| CPM -> Protect CIM Up | 1:1 | N/A | Active | 1 + 1 | Protect | Active | Normal |
| CPM -> Protect CIM Up | 1:1 | N/A | Inactive | 1 + 1 | Protect | Active | Protect |
| CPM -> Protect CIM | 1:1 | N/A | Active | 1 + 1 | Protect | Inactive | Discard |
| Down | | | | | | | |
| CPM -> Protect CIM | 1:1 | N/A | Inactive | 1 + 1 | Protect | Inactive | Discard |
| Down | | | | | | | |

CIM 1:1 and WTR 1:1 protection:

| | | | | | | | |
|---|---|---|---|---|---|---|---|
| CPM -> Protect CIM Up | 1:1 | N/A | Active | 1 + 1 | Protect | Active | Normal |
| CPM -> Protect CIM Up | 1:1 | N/A | Inactive | 1 + 1 | Protect | Active | Protect |
| CPM -> Protect CIM | 1:1 | N/A | Active | 1 + 1 | Protect | Inactive | Discard |
| Down | | | | | | | |
| CPM -> Protect CIM | 1:1 | N/A | Inactive | 1 + 1 | Protect | Inactive | Discard |
| Down | | | | | | | |

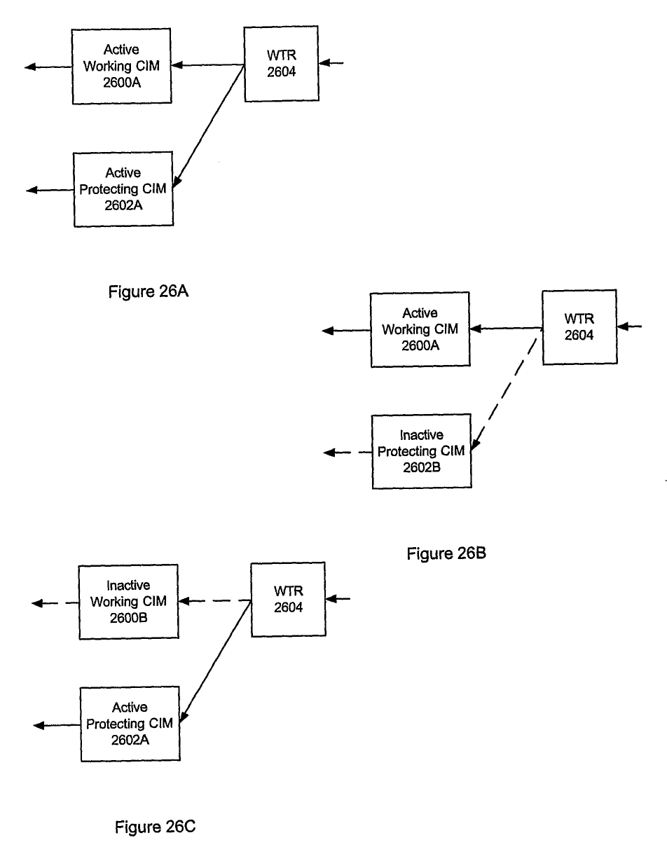

Table 11 lists WTR modes, NPU modes for the working WTR NPUIFM for different CIM and/or WTR protection schemes according to one embodiment of the invention. For example and by way of illustration, in a CIM 1+1 protection scheme, a CPM event of protecting CIM Up causes the working WTR to be active with the NPU in multicast mode, because the WTR forwards the traffic flow to both the working and protecting CIM (as illustrated in FIG. 26A, described below). The working WTR has the same status and NPU mode for a CPM protecting CIM down event as the working WTR still forwards traffic flows to both the working and protecting CIMs.

As in the preceding tables, the working WTR can participate in both CIM and WTR protection schemes. For example, and by way of illustration, for a working WTR involved in both a CIM 1:1 and WTR 1+1 protection schemes, an IFM working WTR

Up event causes the working WTR to be active with the corresponding NPU to be normal. Conversely, an IFM working WTR Down event causes the working WTR to be inactive with the NPU in the discard mode.

Although only a few protection schemes are described above, Table 10 lists additional CIM and/or WTR protection schemes and the affect on the WTR mode, status and WTR NPU mode. Alternate embodiments may have more, less and/or different table entries.

TABLE 11
NPU Modes for Working WTR NPUIFM

| | | | | | | | |
|---|---|---|---|---|---|---|---|
| | | | | | | Working | |
| | WTR | WTR | WTR | CIM | CIM | CIM | NPU |
| Event | Type | Mode | Status | Type | Mode | Status | Mode |

No CIM or WTR protection:

| | | | | | | | |
|---|---|---|---|---|---|---|---|
| N/A | None | N/A | N/A | None | N/A | N/A | N/A |

CIM 1 + 1 protection only:

| CPM -> Protect CIM Up | None | Working | Active | 1 + 1 | N/A | Active | Multicast |
|---|---|---|---|---|---|---|---|
| CPM -> Protect CIM | None | Working | Active | 1 + 1 | N/A | Active | Multicast |
| Down | | | | | | | |
| CIM 1:1 protection only: | Inactive | | | | | | |
| CPM -> Working CIM Up | None | Working | Active | 1:1 | N/A | Active | Normal |
| CPM -> Working CIM | None | Working | Active | 1:1 | N/A | Inactive | Protect |
| Down | | | | | | | |
| CPM -> Protect CIM Up | None | Working | Active | 1:1 | N/A | No change | No change |
| CPM -> Protect CIM | None | Working | Active | 1:1 | N/A | Active | Normal |
| Down | | | | | | | |

WTR 1 + 1 protection only:

| | | | | | | | |
|---|---|---|---|---|---|---|---|
| IFM -> Working WTR Up | 1 + 1 | Working | Active | None | N/A | Active | Normal |
| IFM -> Working WTR | 1 + 1 | Working | Inactive | None | N/A | Active | Discard |
| Down | | | | | | | |
| IFM -> Protect WTR Up | 1 + 1 | Working | No | None | N/A | Active | No change |
| | | | change | | | | |
| IFM -> Protect WTR | 1 + 1 | Working | Active | None | N/A | Active | Normal |
| Down | | | | | | | |

CIM 1 + 1 and WTR 1 + 1 protection:

| | | | | | | | |
|---|---|---|---|---|---|---|---|
| IFM -> Working WTR Up | 1 + 1 | Working | Active | 1 + 1 | N/A | Active | Multicast |
| IFM -> Working WTR | 1 + 1 | Working | Inactive | 1 + 1 | N/A | Inactive | Discard |
| Down | | | | | | | |
| IFM -> Protect WTR Up | 1 + 1 | Working | No | 1 + 1 | N/A | Active | No change |
| | | | change | | | | |
| IFM -> Protect WTR | 1 + 1 | Working | Active | 1 + 1 | N/A | Active | Multicast |
| Down | | | | | | | |

CIM 1:1 and WTR 1 + 1 protection:

| | | | | | | | |
|---|---|---|---|---|---|---|---|
| IFM -> Working WTR Up | 1 + 1 | Working | Active | 1:1 | N/A | Active | Normal |
| | | | | | | Inactive | Protect |
| IFM -> Working WTR | 1 + 1 | Working | Inactive | 1:1 | N/A | Inactive | Discard |
| Down | | | | | | | |
| IFM -> Protect WTR Up | 1 + 1 | Working | No | 1:1 | N/A | Active | No change |
| | | | change | | | | |
| IFM -> Protect WTR | 1 + 1 | Working | Active | 1:1 | N/A | Active | Normal |
| Down | | | | | | Inactive | Protect |
| CPM -> Working CIM Up | 1 + 1 | Working | Active | 1:1 | N/A | Active | Normal |
| | | Working | N/A | 1:1 | | | |
| CPM -> Working CIM | 1 + 1 | Working | N/A | 1:1 | N/A | Inactive | Discard |
| Down | | | | | | | |
| CPM -> Protect CIM Up | 1 + 1 | Working | N/A | 1:1 | N/A | Active | Multicast |
| CPM -> Protect CIM | 1 + 1 | Working | N/A | 1:1 | N/A | Inactive | Discard |
| Down | | | | | | | |

CIM 1 + 1 and WTR 1:1 protection:

| | | | | | | | |
|---|---|---|---|---|---|---|---|
| CPM -> Protect CIM Up | 1:1 | Working | Active | 1 + 1 | Protect | Active | Normal |
| CPM -> Protect CIM Up | 1:1 | Working | Inactive | 1 + 1 | Protect | Active | Protect |
| CPM -> Protect CIM | 1:1 | Working | Active | 1 + 1 | Protect | Inactive | Discard |
| Down | | | | | | | |
| CPM -> Protect CIM | 1:1 | Working | Inactive | 1 + 1 | Protect | Inactive | Discard |
| Down | | | | | | | |

CIM 1:1 and WTR 1:1 protection:

| | | | | | | | |
|---|---|---|---|---|---|---|---|
| CPM -> Protect CIM Up | 1:1 | Working | Active | 1 + 1 | Protect | Active | Normal |
| CPM -> Protect CIM Up | 1:1 | Working | Inactive | 1 + 1 | Protect | Active | Protect |
| CPM -> Protect CIM | 1:1 | Working | Active | 1 + 1 | Protect | Inactive | Discard |
| Down | | | | | | | |
| CPM -> Protect CIM | 1:1 | Working | Inactive | 1 + 1 | Protect | Inactive | Discard |
| Down | | | | | | | |

FIGS. 26A-C are block diagrams illustrating egress path CIM protection schemes according to one embodiment of the invention. Egress path protection protects the traffic flows exiting the CIM to the electrically switched network. In FIGS. 26A-C, WIR 2604 may transmit one or two copies of the traffic flow to working CIM 2600A-B and protecting CIM 2602A-B depending on the protection scheme. In the two protection schemes illustrated in FIGS. 26A-C, CIM 2600A-B and 2602A-B forward two traffic flows to the electrically switched network (in a 1+1 protection scheme) or one traffic flow (for a 1:1 protection scheme).

In FIG. 26A, CIM 2600 forwards two copies of the same traffic flow to active working CIM 2600A and protecting CIM 2602A because the egress path CIM protection scheme is 1+1. In turn, CIM 2600A and 2602A forward the two traffic flows to the electrically switched network.

In FIG. 26B-C, the egress path CIM protection scheme is 1:1, in which WTR 2604 forwards the traffic flow to either working CIM 2600A-B or protecting CIM 2602A-B. In FIG. 26B, WTR 2604 forwards the traffic flow to active working CIM 2602A, and does not forward the traffic flow to inactive protecting CIM 2604B. If CIM 2600A-B and CIM 2602A-B receive the “CIM Working Down; CIM Protecting Up” event from CPM Manager 2210, CIM 2600A-B & CIM 2602A-B change there state to reflect FIG. 24C. In FIG. 26C, working CIM 2600B in inactive and protecting CIM 2602 is active. In addition, WTR 2604 receives the same types of CIM events from CIM IFM 2202 (via WTR IFM 2202) and WTR 2604 changes the forwarding of the received traffic flow accordingly. While in one embodiment, CIM follows the rules for events as illustrated in Table 12, alternate embodiments may have WTR 2604 respond to more, less and/or different events. Consequently, WTR 2604 forwards the traffic flow to active protecting CIM 2602A.

FIGS. 26A-C illustrates events from CPM Manager 2210 changing the states of working CIM 2602A-B and protecting CIM 2604A-B. This represents some of the states changes possible due to events forwarded by CPM Manager 2210. Table 12 illustrates additional egress CIM state changes due to CPM Manager events.

TABLE 12
CPM Events Affecting Working and
Protecting CIM (Egress Only)

| | Current Egress State | Event from CPM | New Egress State |
|---|---|---|---|
| 1 | CIM W - Active | CIM W - Up | CIM W - Active |
| | CIM P - Inactive | CIM P - Up | CIM P - Inactive |
| 2 | CIM W - Active | CIM W - Up | CIM W - Active |
| | CIM P - Inactive | CIM P - Down | CIM P - Inactive |
| 3 | CIM W - Active | CIM W - Down | CIM W - Inactive |
| | CIM P - Inactive | CIM P - Up | CIM P - Active |
| 4 | CIM W - Active | CIM W - Down | CIM W - Inactive |
| | CIM P - Inactive | CIM P - Down | CIM P - Inactive |
| 5 | CIM W - Inactive | CIM W - Up | CIM W - Active |
| | CIM P - Active | CIM P - Up | CIM P - Inactive |
| 6 | CIM W - Inactive | CIM W - Up | CIM W - Active |
| | CIM P - Active | CIM P - Down | CIM P - Inactive |
| 7 | CIM W - Inactive | CIM W - Down | CIM W - Inactive |
| | CIM P - Active | CIM P - Up | CIM P - Active |
| 8 | CIM W - Inactive | CIM W - Down | CIM W - Inactive |
| | CIM P - Active | CIM P - Down | CIM P - Inactive |
| 9 | CIM W - Active | CIM W - Up | CIM W - Active |
| | CIM P - Active | CIM P - Up | CIM P - Active |
| 10 | CIM W - Active | CIM W - Up | CIM W - Active |
| | CIM P - Active | CIM P - Down | CIM P - Active |
| 11 | CIM W - Active | CIM W - Down | CIM W - Active |
| | CIM P - Active | CIM P - Up | CIM P - Active |
| 12 | CIM W - Active | CIM W - Down | CIM W - Active |
| | CIM P - Active | CIM P - Down | CIM P - Active |

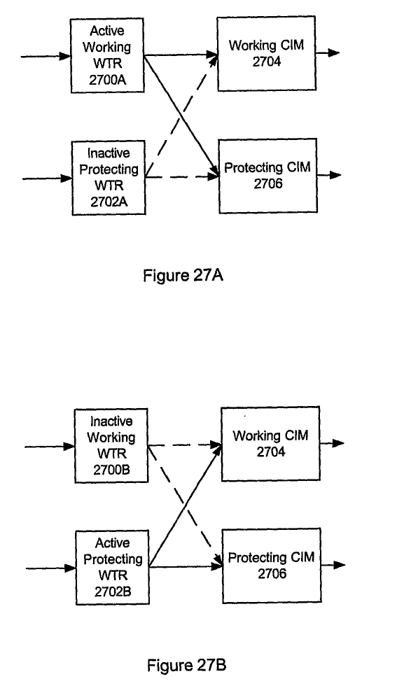

FIGS. 27A-B are block diagrams illustrating CIM 1+1 and DTM 1+1 protection schemes according to one embodiment of the invention. In FIGS. 27A-B, working CIM 2704 and protecting CIM 2706 each receive a traffic flow from either working WTR 2700A-B or protecting WTR 2702A-B, depending on which WTR is active. For example, and by way of illustration, in FIG. 27A, working WTR 2700A is active and forwards the traffic flow to both the working CIM 2704 and protecting CIM 2706. Although protecting WTR 2702A receives the traffic flow, protecting WTR 2702A is inactive and does not forward the traffic flow. Conversely, in FIG. 27B, protecting WTR 2702B is active, while working WTR 2700B is inactive. Thus, protecting WTR 2702B forwards the traffic flow to both the working CIM 2704 and protecting CIM 2706. Furthermore, working WTR 2700B is inactive and does not forward the traffic flow.

Working WTR 2702A-B and protecting WTR 2702A-B change between the active and inactive based on events from WTR IFM 2210. While in one embodiment, working WTR 2700A-B receives events listed in Table 11 (under the sub-heading “CIM 1+1 and DTM 1+1 protection”), other embodiments may have more, less, and/or different events that change the active/inactive state of working WTR 2700A-B and protecting WTR 2702A-B.

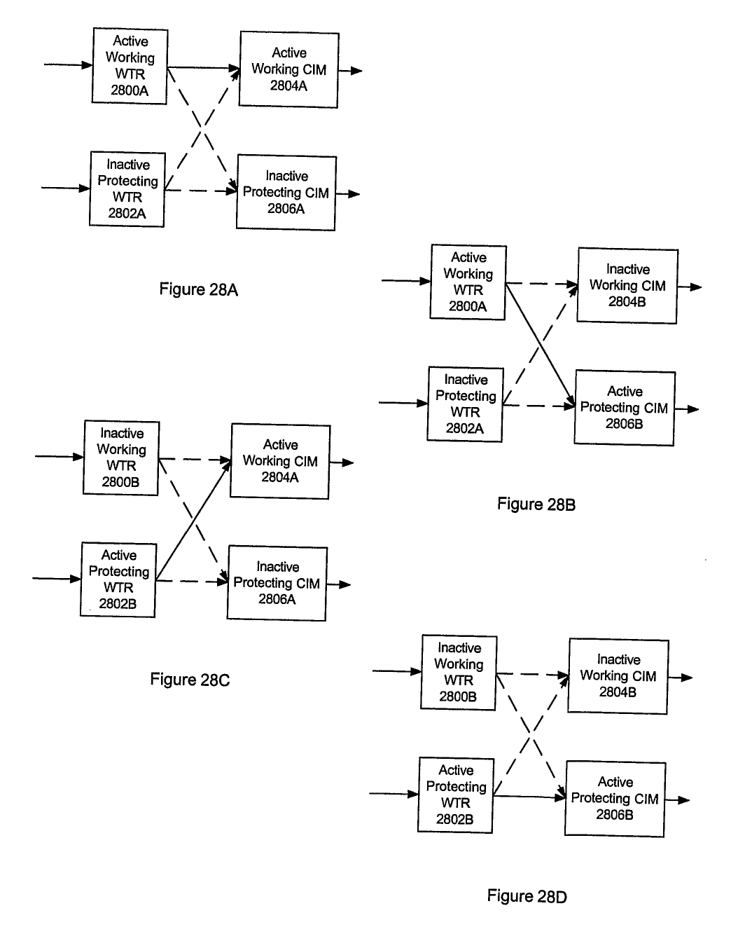

FIGS. 28A-D are block diagrams illustrating CIM 1:1 and DTM 1+1 protection schemes according to one embodiment of the invention. In FIGS. 28A-D, working WTR 2800A-B and protecting 2802A-B each receive the traffic flow. However, either working WTR 2800A-B or protecting WTR 2802A-B forwards the traffic flow to either working CIM 2804A-B or protecting CIM 2806A-B, depending on which WTR and CIM are active. The active CIM forwards the traffic flow to electrically switched network.

In FIG. 28A, active working WTR 2800A forwards the traffic flow to active working CIM 2804A. Working CIM 2804A forwards this traffic flow to the electrically switched network. However, active working WTR 2800A does not forward the traffic flow to protecting CIM 2806A because protecting CIM 2806A is inactive. In addition, because protecting WTR 2802A is inactive, protecting WTR 2802A does not forward to the received traffic flow to either working CIM 2804A or protecting CIM 2806A.

In FIG. 28B, active working WTR 2800A forwards the traffic flow to active protecting CIM 2806B. Protecting CIM 2804B forwards this traffic flow to the electrically switched network. However, active working WTR 2800A does not forward the traffic flow to working CIM 2804B because working CIM 2804B is inactive. In addition, because protecting WTR 2802A is inactive, protecting WTR 2802A does not forward to the received traffic flow to either working CIM 2804B or protecting CIM 2806B.

In FIG. 28C, active protecting WTR 2802B forwards the traffic flow to active working CIM 2804A. Working CIM 2804A forwards this traffic flow to the electrically switched network. However, active protecting WTR 2802B does not forward the traffic flow to protecting CIM 2806A because protecting CIM 2806A is inactive. In addition, because working WTR 2800B is inactive, working WTR 2800B does not forward to the received traffic flow to either working CIM 2804A or protecting CIM 2806A.

In FIG. 28D, active protecting WTR 2802B forwards the traffic flow to active protecting CIM 2806B. Protecting CIM 2806B forwards this traffic flow to the electrically switched network. However, active protecting WTR 2802B does not forward the traffic flow to working CIM 2804B because working CIM 2804B is inactive. In addition, because working WTR 2800B is inactive, working WTR 2800B does not forward to the received traffic flow to either working CIM 2804B or protecting CIM 2806B.

Working WTR 2800A-B, protecting WTR 2802A-B, working CIM 2804A-B, and protecting CIM 2806A-B change between the active and inactive based on events from WTR IFM 2210 and CPM manager 2208. While in one embodiment, working CIM 2804A-B receives events listed in Table 9, protecting CIM 2806A-B receives events listed in Table 10, and working WTR 2800A-B receives events listed in Table 11 (each events listed in the tables under the sub-heading “CIM 1+1 and DTM 1+1 protection”), other embodiments may have more, less, and/or different events that change the active/inactive state of working WTR 2800A-B, protecting WTR 2802A-B, working CIM 2804A-B, and/or protecting CIM 2806A-B.

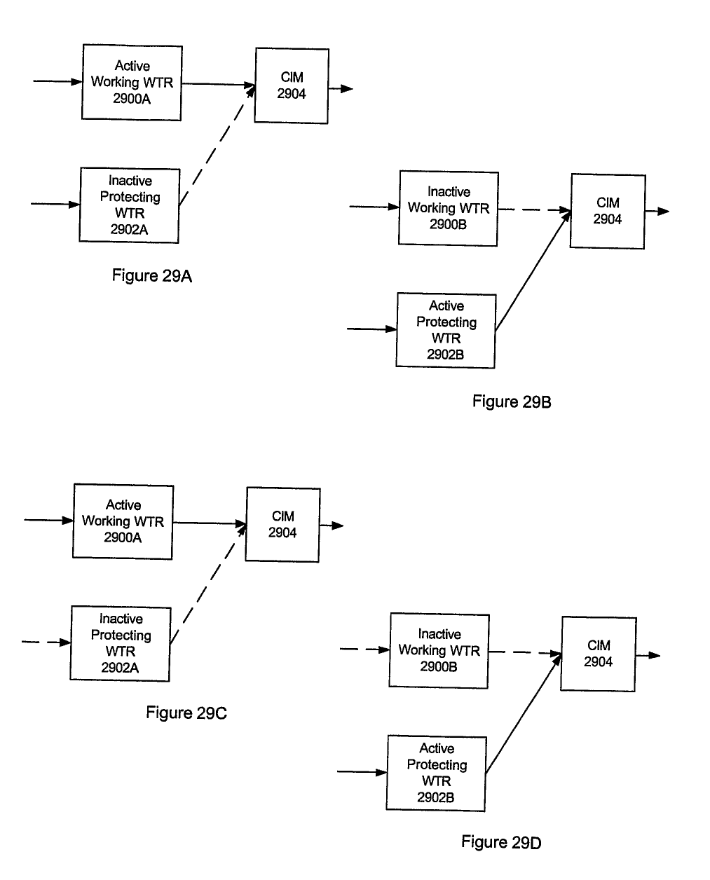

FIGS. 29A-D are block diagrams illustrating egress path DTM protection schemes according to one embodiment of the invention. Egress path protection protects the traffic flows exiting the WTR to the CIM. In FIG. 29A-B, working WTR 2900A-B and protecting WTR 2902A-B receive the same traffic flow. However, which WTR forwards the flow depends on which WTR is active. For example, and by way of illustration, in FIG. 29A, working WTR 2900A is active and forwards the traffic flow to CIM 2904. CIM 2904 transmits the traffic flow to the electrically switched network. Because protecting WTR 2902A is inactive, protecting WTR 2902A does not forward the traffic flow to CIM 2904. On the other hand, in FIG. 29B, protecting WTR 2902B is active and forwards the traffic flow to CIM 2904. As in FIG. 29A, CIM 2904 transmits the traffic flow to the electrically switched network. Because working WTR 2900B is inactive, active WTR 2900B does not forward the traffic flow to the CIM.

In FIGS. 29C-D, working WTR 2900A-B or protecting WTR 2902A-B receive the traffic flow, depending on which WTR is active. For example, and by way of illustration, in FIG. 29C, working WTR 2900A is active and receives/forwards the traffic flow to CIM 2904. CIM 2904 transmits the traffic flow to the electrically switched network. Because protecting WTR 2902A is inactive, protecting WTR 2902A neither receives nor forwards the traffic flow to the CIM. On the other hand, in FIG. 29B, protecting WTR 2902B is active and receives/forwards the traffic flow to CIM 2904. As in FIG. 29A, CIM 2904 transmits the traffic flow to the electrically switched network. Because working WTR 2900B is inactive, active WTR 2900B neither receives nor forwards the traffic flow to the CIM.

Working WTR 2900A-B and protecting WTR 2902A-B change between the active and inactive based on events from WTR IFM 2210. While in one embodiment, working WTR 2900A-B receives events listed in Table 11 (under the sub-headings “WTR 1+1 protection only”, “CIM 1:1 and WTR 1:1 protecting”, and “CIM 1+1 and WTR 1:1 protecting”), other embodiments may have more, less, and/or different events that change the active/inactive state of working WTR 2900A-B and protecting WTR 2902A-B.

### Alternative Embodiments

While various embodiments of the invention have been described, alternative embodiments of the invention can operate differently. For instance, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
establishing optical circuits between different ones of a plurality of optically aware electrically switching network devices acting as access nodes of an optically switched wavelength division multiplexing network;
communicating different add/drop traffic flows between externally facing ports of different ones of the plurality of network devices by transmitting over the optical circuits;
within each of the plurality of network device,
optically switching those of the optical circuits for which the network device is an intermediate node, and
electrically switching packets between different ones of the network devices, externally facing ports and those of the optical circuits for which the network device is at an end node.

2. An optically aware electrically switching network device, to be coupled to an optically switched network and a set of one or more electrically switched networks, comprising:
a plurality of ports to be coupled to the set of electrically switch networks facing externally to the optically switched network to communicate packets belonging to different traffic flows;
an optical switch part, having ports to be coupled to the optically switched network, to demultiplex, add/drop, multiplex and switch wavelengths;
a plurality of wavelength division multiplexing transmit/receive units coupled to the optical switch part for add/drop wavelengths; and
an optically aware electrical packet switch, coupled between the first plurality of ports and the plurality of wavelength multiplexing transmit/receive units, to switch the different traffic flows between the plurality of wavelength division multiplexing transmit/receive units and the plurality of ports.

3. A method comprising:
receiving packets from a set of one or more external sources to an optically aware electrically switching network device that is an access node of an optically switched wavelength division multiplexing network;
internally electrically switching the packets based on the characteristics of the packets to different ones of a plurality of wavelength division multiplexing transmit/receive units that are end points of optical circuits;
internally optically switching wavelengths generated by the plurality of wavelength division multiplexing transmit/receive units; and
internally multiplexing the wavelengths onto a set of one or more fibers exiting the optically aware electrically switching network device.

4. A method comprising:
provisioning different add/drop traffic flows over the optical circuits, wherein provisioning each traffic flow comprises,
establishing a set of packet characteristics for the traffic flow;
associating the traffic flow with an optical circuit; and
allocating bandwidth for the traffic flow from the optical circuit.

5. A method comprising:
establishing pairs optical circuits between different ones of a plurality of electrically switched of optically protecting network devices acting as access nodes of an optically switched wavelength division multiplexing network;
communicating different add/drop traffic flows between externally facing ports of different ones of the plurality of network devices by transmitting over the optical circuits;
within each of the plurality of network device,
optically switching those of the optical circuits for which the network device is an intermediate node, and
electrically switching packets between different ones of the network device's externally facing ports and those of the optical circuits for which the network device is an end node; and
protecting the communication of the traffic flows across the optical network through controlling of the electrical switching of the packets to the pairs of optical circuit.

6. An electrically switched optically protecting network device, to be coupled to an optically switched network, comprising:
a plurality of ports facing externally to the optically switched network to communicate packets belonging to different traffic flows;
an optical switch part, having ports to be coupled to the optically switched network, to demultiplex, add/drop, and multiplex wavelengths;
a plurality of wavelength division multiplexing transmitlreceive units coupled to the optical switch part to add/drop wavelengths;
an optically aware electrical switch, coupled between the plurality of ports and the plurality of wavelength multiplexing transmit/receive units, to electrically switch the packets between the plurality of ports and the plurality wavelength and multiplexing transmit/receive units; and
a protection unit coupled to the optically aware electrical switch to control the optically aware electrical switch and to provide optical protection through different optical circuits to the same end points.

7. A method comprising:
receiving packets from a set of one or more external sources to an electrically switched optically protecting network device that is an access node of an optically switched wavelength division multiplexing network;
internally classifying packets as being part of different ones of a plurality of provisioned traffic flows based on characteristics in each of the packets, wherein each of the plurality of provisioned traffic flows has been associated with a pair of optical circuits of which one is working and one is protecting;
internally electrically switching the packets based on said classifying and said associations to different ones of a plurality of wavelength division multiplexing transmit/receive units that are endpoints of the optical circuits; and
internally optically switching wavelengths generated by the plurality of wavelength division multiplexing transmit/receive units; and
internally multiplexing the wavelengths onto a set of one or more fibers exiting the electrically switched optically protecting network device.

8. The method of claim 7, wherein the internally electrically switching includes internally electrically switching those of the packets classified as being part of a first of the plurality of provisioned traffic flows to both of those of the plurality of wavelength division multiplexing transmit/receive units that are the end points of the pair of optical circuits associated with that first provisioned traffic flow to provide 1+1 protection.

9. The method of claim 7, wherein the internally electrically switching includes internally electrically switching those of the packets classified as being part of a first of the plurality of provisioned traffic flows to only one of those of the plurality of wavelength division multiplexing transmit/receive units that are the end points of the pair of optical circuits associated with that first provisioned traffic flow based on the status of the working one to provide 1:N protection.

10. A method comprising:
provisioning different add/drop traffic flows over optical circuits, wherein provisioning each traffic flow comprises,
establishing a set of packet characteristics for the traffic flow;
associating the traffic flow with a working optical circuit and a protection optical circuit; and
allocating bandwidth for the traffic flow from protection optical circuit the working optical circuit working and protecting the optical circuits.

11. A method comprising:
establishing optical circuits between different ones of a plurality of optically aware electrically switching network devices acting as access nodes of an optically switched wavelength division multiplexing network;
communicating different add/drop traffic flows between externally facing ports of different ones of the plurality of network devices by transmitting over the optical circuits;
within each of the plurality of network devices; and
optically switching those of the optical circuits for which the network device is an intermediate node, and
electrically switching to aggregate traffic flows received on the network devices externally facing ports onto different ones of the optical circuits for which the network device is an end node, electrically switching to separate aggregated traffic flows received on those of the optical circuits for which the network device is an end node.

12. A method comprising:
establishing optical circuits between different ones of a plurality of optically aware electrically switching network devices acting as access nodes of an optically switched wavelength division multiplexing network with an electrically switched network;
communicating different add/drop traffic flows between externally facing ports of different ones of the plurality of network devices by transmitting over the optical circuits; and
within each of the plurality of network device,
optically switching those of the optical circuits for which the network device is an intermediate node, and
electrically separating the traffic flows from different ones of wavelengths received on the optical circuits, the traffic flows to be transmitted by the externally facing ports to the electrically switched network.

13. An optically aware electrically switching network device, to be coupled to an optically switched network and a set of one or more electrically switched network, comprising:
a first plurality of ports to be coupled to the set of electrically switched network to communicate packets belonging to different traffic flows;
an optical switch part, having ports to be coupled to the optically switched network, to demultiplex, add/drop, multiplex and switch wavelengths;
a plurality of wavelength division multiplexing transmit/receive units coupled to the optical switch part for add/drop wavelengths; and
an optically aware electrical packet switch coupled between the plurality of ports and the plurality of wavelength multiplexing transmit/receive units, to aggregate the different traffic flows to the plurality of wavelength division multiplexing transmit/receive units.

14. An optically aware electrically switching network device, to be coupled to an optically switched network and an electrically switched network, comprising:
a first plurality of ports facing externally to the optically switched network to communicate packets belonging to different traffic flows;
an optical switch part having ports facing the optically switched network to demultiplex, add/drop, multiplex and switch wavelengths;
a plurality of wavelength division multiplexing transmit/receive units coupled to the optical switch part for add/drop wavelengths; and
an optically aware electrical packet switch coupled between the plurality of ports and the plurality of wavelength multiplexing transmit/receive units, wherein the optically aware electrical packet switch separates the different traffic flows from the plurality of wavelength division multiplexing transmit/receive units.

15. A method comprising:
receiving packets from a set of one or more electrically switched external sources to an electrically switched optical aware network element that is an access node of an optically switched wavelength division multiplexing network;
internally classifying the packets as being part of different ones of a plurality of provisioned traffic flows based on characteristics in each of the packets;
internally aggregating different ones the plurality of provisioned traffic flows onto different ones of a plurality of wavelength division multiplexing transmit/receive units; and
internally optically switching wavelengths generated by the plurality of wavelength division multiplexing transmit/receive units; and
internally multiplexing wavelengths onto a set of one or more fibers exiting the electrically switched optically aware network element.

16. A method comprising:
demultiplexing multiplexed wavelengths received or a set of more or more fibers coupled to an electrically switched optically aware network element;
internally optically switching the demultiplexed wavelengths to different one of a plurality of wavelength division multiplexing transmit/receive units, when at least one of the demultiplexed wavelengths carries packets from multiple traffic flows internally classifying the packets into the respective traffic flows, wherein the different traffic flows are electrically switched to plurality of external facing ports based on the protection schemes.

17. A method comprising:
provisioning different add/drop traffic flows in an optically aware electrically switched network element by,
defining characteristics to distinguish a first and second traffic flow to be communicated over two different ports of the optically aware electrically switched network element,
allocating bandwidth for the first and second traffic flow on an optical circuit whose path is through an optically switched optical network, for which the optically aware electrically switched network element in an end node, and that originates/terminates at a wavelength division multiplexing transmit/receive unit in the optically aware electrically switched network element;
configuring an optically aware aggregation switch of the optically aware electrically switched network element to classify and switch packets belonging to the first and second traffic flows between the wavelength division multiplexing transmit/receive unit and their respective ports.

18. A system comprising:
an optically switched network comprising,
a plurality of access nodes between an optically switched wavelength division multiplexing network and an electrically switched network, and
a plurality of optical circuits coupled between different pairs of access node, the plurality of access nodes are endpoints for the associated optical circuit from; and
a plurality of electrical switch devices coupled to the plurality of access nodes, wherein the plurality of optical circuits between access nodes endpoint is stored in the plurality of electrical switch devices as a single hop between the access node endpoints.

19. An optically aware electrically switching network device, to be coupled to an optically switched network and a set of one or more electrically switched networks, comprising:
a plurality of ports to be coupled to the set of electrically switch networks facing externally to the optically switched network to communicate packets belonging to different traffic flows;
an optical switch part, having ports to be coupled to the optically switched network, to demultiplex, add/drop, multiplex and switch wavelengths;
a plurality of wavelength division multiplexing transmit/receive units coupled to the optical switch part for add/drop wavelengths, the plurality of wavelength division multiplexing transmit/receive units are coupled to a plurality access nodes via optical circuits; and
an optically aware electrical packet switch, coupled between the first plurality of ports and the plurality of wavelength multiplexing transmit/receive units, to switch the different traffic flows between the plurality of wavelength division multiplexing transmit/receive units and the plurality of ports, wherein each of the optical circuits are represented as a single hop in a forwarding database of an electrically switched device in each of the set of electrically switch networks.

20. A method comprising:
representing optical circuits between different pairs of a plurality of optically aware electrically switched network devices as a single hop in a forwarding database of an electrically switched device, wherein each network acts as an access node of an optically switched wavelength division multiplexing network with an electrically switched network.
